(19) United States
(12) Patent Application Publication
(10) Pub. No.: US 2008/0088361 A1
(43) Pub. Date: Apr. 17, 2008

(54) Reference voltage generating circuit

(75) Inventor: Katsuji Kimura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/907,577

(22) Filed: Oct. 15, 2007

(30) Foreign Application Priority Data
Oct. 16, 2006 (JP) 2006-281619
May 1, 2007 (JP) 2007-121032

(51) Int. Cl. G05F 3/02

(52) U.S. Cl. 327/541

(57) ABSTRACT

Disclosed is a reference voltage generating circuit including first to third current-to-voltage converter circuits, a control circuit for exercising control so that the terminal voltage of the first current-to-voltage converter circuit is made equal to that of the second current-to-voltage converter circuit, and current mirror circuits for driving the first to third current-to-voltage converter circuits. A preset voltage of the third current-to-voltage converter circuit is used as a reference voltage. The first current-to-voltage converter circuit is composed of a diode. The second current-to-voltage converter circuit includes a plurality of parallel connected diodes, a resistor connected in parallel with the plural parallel connected diodes and a resistor connected in series with the parallel-connected diodes and the resistor. The third current-to-voltage converter circuit is composed of a resistor.

### RELATED APPLICATION

This application is based upon and claims the benefit of the priorities of Japanese patent application No. 2006-281619, filed on Oct. 16, 2006 and Japanese patent application No. 2007-121032, filed on May 1, 2007, the disclosure of which is incorporated herein in its entirety by reference thereto.

### FIELD OF THE INVENTION

This invention relates to a reference voltage generating circuit, more specifically, a reference voltage generating circuit that outputs a controlled voltage as an output voltage or a reference voltage generating circuit that outputs a low voltage. More particularly, this invention relates to a CMOS reference voltage generating circuit that delivers a reference voltage of 1.2 V or less having a small temperature characteristic. The CMOS reference voltage generating circuit is formed on a semiconductor integrated circuit, has a small chip area and may operate from a low voltage.

### BACKGROUND OF THE INVENTION

[Patent Document 1] JP Patent No. 3586073
[Patent Document 2] U.S. Pat. No. 3,617,859 (Nov. 21, 1971)
[Patent Document 3] U.S. Pat. No. 7,009,374 B2 (Mar. 7, 2006)
[Patent Document 4] U.S. Pat. No. 6,788,041 (Sep. 7, 2004)
[Patent Document 5] U.S. Pat. No. 6,531,857 B2 (Mar. 11, 2003)
[Patent Document 6] U.S. Pat. No. 6,930,538 B2 (Aug. 16, 2005)
[Patent Document 7] U.S. Pat. No. 7,113,025 B2 (Sep. 26, 2006)
[Patent Document 8] U.S. Pat. No. 6,531,857 B2 (Mar. 11, 2003)
[Patent Document 9] U.S. Pat. No. 6,677,808 B1 (Jan. 13, 2004)
[Patent Document 10] US 2005/0285666 A1 (Dec. 29, 2005)
[Patent Document 11] U.S. Pat. No. 7,005,839 B2 (Feb. 28, 2006)
[Patent Document 12] US 2005/0194957 A1 (Sep. 8, 2005)
[Patent Document 13] Japanese Patent Kokai Publication No. JP-P2006-209212A
[Non-Patent Document 1] Robert J. Widlar, “New Developments in IC Voltage Regulators, IEEE Journal of Solid-State Circuits, Vol. SC-6, No. 1, pp. 2-7, February 1971
[Non-Patent Document 2] Paul R. Gray and Robert G. Meyer, Analysis and Design of Analog Integrated Circuits, New York; John Wiley & Sons Inc. 1977
[Non-Patent Document 3] K. E. Kuijk, “A Precision Reference Voltage Source”, IEEE Journal of Solid-State Circuits, Vol. SC-8, No. 3, pp. 222-226, June 1973
[Non-Patent Document 4] A. Paul Brokaw, “A simple Three-Terminal IC Bandgap Reference”, IEEE Journal of Solid-State Circuits, Vol. SC-9, No. 6, pp. 388-393, Dec. 19, 1974
[Non-Patent Document 5] Robert J. Widlar, “A new breed of linear ICs runs at 1-Volt levels”, pp. 115-119, Electronics/Mar. 29, 1979
[Non-Patent Document 6] Eric A. Vittos, “MOS Transistors Operated in the Lateral Bipolar Mode and Their Application in CMOS Technology”, IEEE Journal of Solid-State Circuits, Vol. SC-18, No. 3, pp. 273-279, June 1983
[Non-Patent Document 7] Katsuji KIMURA, “Analog Circuit Design Technology for CMOS-Implementation of Wireless Mobile Terminal”, Triceps Co. Ltd. 1999
[Non-Patent Document 8] H. Bamba et al., “A CMOS Bandgap Reference Circuit with Sub-1-V Operation”, IEEE Journal of Solid-State Circuits, Vol. 34, No. 5, May 1999
[Non-Patent Document 9] Lizhong et al., “A 1.0V GHz Range 0.13 μm CMOS Frequency Synthesizer”, IEEE CICC 2001, pp. 327-330, May 2001
[Non-Patent Document 10] H. Neuteboom et al., “A DSP-Based Hearing Instrument IC” IEEE Journal of Solid-State Circuits, Vol. 32, No. 11 pp. 1790-1806, November 1997
[Non-Patent Document 11] P. Malcovati et al., “Curvature-Compensated BiCMOS Bandgap with 1-V Supply Voltage”, IEEE Journal of Solid-State Circuits, Vol. 36, No. 7, July 2001.

FIG. 1 shows an illustrative constitution of a conventional reference voltage generating circuit which is described in U.S. Pat. No. 3,617,859 (Robert C. Dobkin and Robert J. Widlar, “Electrical Regulator Apparatus Including a Zero Temperature Coefficient Voltage Reference Circuit”, Nov. 2, 1971), filed on Mar. 23, 1970. The head inventor is Robert C. Dobkin.

However, this reference voltage generating circuit was disclosed in a treatise (Robert J. Widlar, “New developments in IC Voltage regulators”, IEEE Journal of Solid-State Circuits, Vol. SC-6 No. 1 pp. 2-7 February 1971) with Robert J. Widlar as a sole author. Later on, the circuit shown in FIG. 2 appeared as “Widlar band-gap reference” in Paul R. Gray and Robert G. Meyer, “Analysis and Design of Analog Integrated Circuits” New York: John Wiley & sons, Inc. 1977.

As from publication of this text of Gray & Meyer, that is, since 1977, this circuit bears the name of R. J. Widlar (second co-inventor), an unintelligible phenomenon.

However, more unintelligible to the experts in the technical field is that, in the circuit analysis of the reference voltage generating circuit in Dobkin et al. (U.S. Pat. No. 3,617,859) or in Widlar (JSSC), it is not VBE1 and ΔVBE, obtained from the first transistor Q1 or the second transistor Q2, but VBE2 of a control transistor Q3 and VBE3 of a second transistor Q2, controlling the circuit, that afford the reference voltage VREF.

Such being the case, it is difficult for experts in the relevant technical field to evaluate the results of the circuit analysis. Hence, unlike the U.S. Pat. No. 3,617,859 by Dobkin et al. or the reference voltage generating circuit by Widlar (JSSC), a transistor Q4 is added for control, in place of a constant current source 1, in the circuit of the “Widlar band-gap reference” introduced in the Gray & Meyer's text. The transistor Q3, used so far, is now driven by the constant current source I which has been moved to between the power supply and the base of the transistor Q4, by way of modification.

This has made circuit analysis possible. That is, the operation of the reference voltage generating circuit has been clarified by Gray & Meyer, and the Gray & Meyer's circuit, which is not relevant to Dobkin or to Widlar, has now been named the “Widlar band-gap reference”.

In actuality, the reference voltage generating circuit by the Gray & Meyer's text has been put to use as a resistor is used in place of the constant current source I.

The crucial point in the Gray & Meyer's text is that it has clearly demonstrated the operating principle of the reference voltage generating circuit that a thermal voltage V_{T} proportional to absolute temperature (PTAT voltage), as a voltage having a positive temperature coefficient, and VBE complementarily proportional to absolute temperature (CTAT voltage), are summed together with weights to cancel out the temperature characteristic, as shown in FIG. 3. Simply the voltage at this time happens to be on the order of 1.2V, whilst there has not been implemented a circuit for deriving a band gap voltage (1.205V) at 0° Kelvin.

Hence, the present inventor is not fully satisfied with the nomination ‘Widlar band-gap reference’ by Gray & Meyer, as to “Widlar” or “band-gap”, and feels that the circuit may as well be nominated ‘voltage reference’.

Subsequently, in 1972, a reference voltage generating circuit (FIG. 4), employing a diode and an OP amp, was disclosed by Kujik (K. E. Kujik, “A Precision Reference Voltage Source”, IEEE Journal of Solid-State Circuits, Vol. SC-8, No. 3, pp. 222-226, June 1973).

In the Gray & Meyer's text, this circuit is stated as an “improved band-gap reference” (improved band-gap reference voltage generating circuit).

At present, the technology has shifted from bipolar to CMOS. Since bipolar transistors are difficult to fabricate on an LSI, a parasitic bipolar transistor formed is used as a diode.

Hence, the control transistor Q3 was replaced by an OP amp only recently. This has enabled the understanding of the reference voltage generating circuit and an intrinsic state has been reached in which the output voltage is determined by two bipolar transistors and two diodes controlled by a control transistor Q3 and an OP amp, both of which have been omitted.

The Gray & Meyer's text appeared later. The circuit shown in the Gray & Meyer's text was possibly modified so that the output voltage would be determined by two bipolar transistors controlled by the control transistor Q3.

In 1974, A. Paul Brokaw disclosed a self-biased reference voltage generating circuit (A. Paul Brokaw, ‘A Simple Three-Terminal IC Bandgap Reference’, IEEE Journal of Solid-State Circuits, Vol. SC-9, No. 6, pp. 388-393, December 1974).

Later on, in the aforementioned reference voltage generating circuit employing a diode and an OP amp, a self-biased circuit has become popular and has come to be used routinely frequently.

However, surprisingly, the emitter area ratio N of the first and second transistors Q1 and Q2 is not used even in the circuit analysis shown in this Brokaw's treatise. However, in U.S. Pat. No. 3,887,863 (Jun. 3, 1975), directed to the contents of this treatise, a mysterious result is reached that, despite the use of the emitter area ratio N of the emitter area of the first transistor Q1 to that of the first transistor Q2, there lacks N in the analytic equation.

Hence, the expression of ΔVBE with the emitter area ratio N of the first and second transistors Q1 and Q2 is not seen in the Gray & Meyer's text nor in the treatise extended in 1979 by Widlar (Robert J. Widlar, “A new breed of linear ICs runs at 1-Volt levels”, pp. 115-119, Electronics/Mar. 29, 1979, but only appears certainly after 1980.

For example, the description appears in 1983 (Eric A. Vittos, “MOS Transistor Operated in the Lateral Bipolar Mode and Their Application in CMOS Technology”, IEEE Journal of Solid-State Circuits, Vol. SC-18, No. 3, pp. 273-279, June 1983).

That is, despite the fact that the reference voltage generating circuit termed a so-called band-gap reference has come to be put to practical use and disclosed in many treatises, circuit analysis has come to be understood only after ten or more years by those having an ordinary knowledge in the relevant field. This would probably be felt by many as astonishing.

The above will account for the above-described unreasonable notion generally accepted in this sort of the reference voltage generating circuit disclosed so far since 1973.

It may be an indefatigable fact that the engineers in the relevant technical field is not that high in their technical level which may be rather low as compared to the technical level of the engineers of the other technical fields. In reality, this sort of the reference voltage generating circuit, currently most known in the technical field, is shown in FIG. 6. The inventor of this circuit (Bamba) is not specialized in this technical field but is an engineer in the field of memories. Ironically, his inventions, mainly treatises, are recited most often and hence Bamba has now been recognized as an authority in this field. Moreover, Bamba was only 26 years old, that is, was not a veteran but only a youngster engineer when an application for the Bamba's reference voltage generating circuit was filed on Jul. 29, 1997.

The reference voltage generating circuit, devised by Bamba, is described in detail in JP Patent Kokai Publication No. JP-A-11-45125 or in JP Patent No. 3586073.

It is quite natural that, in this reference voltage generating circuit, the reference voltage is obtained by current-to-voltage conversion, as in the same sort of the reference voltage generating circuit, devised earlier, in which temperature characteristic have been cancelled. However, in the reference voltage generating circuit, devised earlier, in which temperature characteristic have been cancelled, the reference current, having a positive temperature characteristic, is converted into a voltage by an output circuit made up of a resistor and a diode or a transistor connected as a diode. That is, a voltage component the voltage drop of which at a resistor has a positive temperature characteristic and a voltage component the forward voltage of which at the diode (or the transistor connected as diode) has a negative temperature characteristic is generated. These voltage components are summed together to generate a reference voltage of the order of 1.2V from which temperature characteristic have been cancelled.

On the other hand, in the reference voltage generating circuit, devised by Bamba, and which is described in JP Patent Kokai Publication No. JP-A-11-45125, a reference current exhibiting hardly any temperature characteristic is generated and converted into a voltage by an output circuit made up only of a resistor to generate a reference voltage of an optional voltage value.

Hence, the voltage of 1.2V, prescribed as an output voltage of this sort of the conventional reference voltage generating circuit, and from which temperature characteristic have been cancelled, is generated by conversion into the current value in the circuit, the reference voltage generating circuit may be said to be a high quality product in that it can be run at a power supply voltage not higher than 1.2V.

In a text “Analog Circuit Design Technology for CMOS-Implementation of Wireless Mobile Terminal”, Triceps Co. Ltd. 1999, written by the present inventor, the current was introduced as ‘current mode type reference voltage generating circuit’ with the detailed circuit analysis, in the same year as the year of the provisional publication. In texts issued as from this time, this Bamba's circuit appears almost without exceptions.

In this manner, it has now become well-known that the reference voltage generating circuit is modified into a current mode circuit to generate a voltage not higher than 1.2V such as to lower the power supply voltage. This circuit style (circuit topology) is shown herein in FIG. 7.

The source of the circuit topology, shown in FIG. 7, is not known. On the other hand, the reference voltage generating circuit, shown in FIG. 8, has long been used as a circuit derived from the reference voltage generating circuit employing an OP amp shown in FIG. 4.

By the way, simulated values of the conventional reference voltage generating circuit, shown in FIG. 8, are shown below. If, If, with VDD=1.8V, N, R1 and R2 are set so that N=4, R1=1.08 kΩ and R2=17.8 kΩ, the values of Vref are:

1.38827V at −53° C.,

1.39399V at 0° C.,

1.3946V at 27° C. and

1.3889V at 103° C.

so that an upside-down cup shaped characteristic has been obtained. The width of the temperature variations is 0.455%.

Thus, the circuit topology of the conventional reference voltage generating circuit for producing 1.2V is the same as that of the Bamba's reference voltage generating circuit for producing an optional reference voltage inclusive of the reference voltage not higher than 1.2V shown in FIG. 6. The reference voltage of 1.2V or an optional reference voltage is produced as three current-voltage (I-V) conversion circuits are made to differ from or to be the same as one another. It may be worthwhile to point this out here since it may give a hint in newly devising the same sort of the reference voltage generating circuit.

The circuit operation is now described in accordance with the contents described in JP Patent Kokai Publication No. JP-A-11-45125. It should be noted however that the startup circuit is omitted, that is, is not described.

In FIG. 6, the common gate voltage of transistors P1 and P2 is controlled by an op amp DA1 so that VA=VB.

Hence,

VA=VB (1)

and

I1=I2 (2)

The current I1 is divided into a current I1A flowing through a diode D1 and a current I1B flowing through a resistor R4. Similarly, the current I2 is divided into a current I2A flowing through a series connected resistor R1 and parallel-connected N diodes D2 and a current I2B flowing through a resistor R2.

If R2=R4 (3)

then

I1A=I2A (4)

and

I1B=I2B (5)

Also, VA and VB may be set so that

VA=VF1 (6)

and

VB=VF2+ΔVF (7)

so that

ΔVF=VF1−VF2 (8)

With the voltage drop at R1 equal to ΔVF, we have

I2A=ΔVF/R1 (9)

and

I1B=I2B=VF1/R2 (10)

Here,

ΔVF=V_{T}ln(N) (11)

where V_{T} is thermal voltage and expressed as

V_{T}=kT/q (12)

where T is the absolute temperature [K], k is a Bolzmann's constant and q is a unit electronic charge.

Hence, I3 (=I2) is converted by a resistor R3 into a voltage such that

$$\begin{matrix}Vref = R 3 \times I 3 \\ = R 3 \{ VF 1 / R 2 + ( {V}_{T} ln ( N ) ) / R 1 \} \\ = ( R 3 / R 2 ) \{ VF 1 + ( R 2 / R 1 ) ( {V}_{T} ln ( N ) ) \}\end{matrix} \qquad ( 13 )$$

{VF1+(R2/R1)(V_{T}ln(N))} is a voltage value of the order of 1.2V with the temperature characteristic cancelled. Specifically, VF1 has a negative temperature characteristic of approximately −1.9 mV/° C., while V_{T} has a positive temperature characteristic of 0.853 mV/° C.

In order for the temperature characteristic to be cancelled, the value of (R2/R1)ln(N) is 22.27.

Also, since V_{T} is 26 mV at ambient temperature, (R2/R1)V_{T}ln(N) is approximately 579 mV at ambient temperature.

Hence, if VF1 is 626 mV at ambient temperature, {VF1+(R2/R1)(V_{T}ln(N))} is approximately 1.205V.

The temperature characteristic is now discussed in some detail. Since a resistor R4 is connected in parallel with a diode D1, the current flowing through the resistor R4 tends to be reduced because of the non-linear temperature characteristic of the diode at lower temperatures. On the other hand, since a resistor R1 is connected in series with a diode D2, the voltage across the diode D2 and the resistor R1 becomes lower than that at the diode D1, in case the current flowing through the diode D2 has a positive temperature characteristic. Since the two voltages are controlled to be equal to each other, the two voltages tend to become equal to each other with increasing current at lower temperatures. The two voltages undergo transitions in the opposite direction at elevated temperatures.

That is, in the present circuit, the currents flowing through the diodes D1, D2 are set to temperature characteristic smaller than those prescribed by (V_{T}ln(N))/R1. The currents flowing through the resistors R2, R4 (VF1/R2, VF1/R4) are slightly increased at lower temperatures.

The driving currents, supplied from the transistors P1, P2 and P3 act for canceling out the non-linearity of temperature characteristic of the forward voltage of diodes, the temperature characteristic of the resulting reference voltage may be set to the characteristic close to a straight line suffering only small variations against temperature.

On the other hand, since the resistance ratio (R3/R2) has no temperature characteristic, the output reference voltage Vref has temperature characteristic cancelled.

It is noted that the resistor (R3/R2) may be set to an optional value. If setting is 1<(R3/R2), Vref becomes higher than 1.2V, whereas, if setting is 1>(R3/R2), Vref is lower than 1.205V.

The values of simulation result are shown below. If, with VDD=1.2V, N, R1, R2, R3 and R4 are set so that N=100, R1=309.4 kΩ, R2=R4=2063 kΩ and R3=844 kΩ, the values of Vref are:

595.12 mV at −53° C.,

596.18 mV at 0° C.,

596.32 mV at 27° C. and

595.04 mV at 103° C.

so that an upside-down cup shaped characteristic has been obtained. The width of the temperature variations is suppressed to a lower value of 0.22%. The number of the parallel-connected diodes does not affect the width of the temperature variations.

Meanwhile, if, with VDD=1.2V, N, R1, R2, R3 and R4 are set so that N=100, R1=0.5178 kΩ, R2=R4=19 kΩ and R3=5 kΩ, the values of Vref are:

367.858 mV at −53° C.

368.55 mV at 0° C.,

368.645 mV at 27° C. and

367.847 mV at 103° C.

so that upside-down cup shaped characteristic has been obtained. The width of the temperature variations is suppressed to a lower value of 0.217%.

This circuit by Bamba is nominated ‘current mode reference voltage generating circuit’ by the present inventor, as described above. The circuit shown in FIG. 9, which has afforded hint to introduction of the present circuit, was disclosed subsequently (Lizhong et al., “A 1.0V GHz Range 0.13 μm CMOS Frequency Synthesizer”, IEEE CICC 2001, pp. 327-330, May 2001). Since the inventor of this circuit is not an engineer specialized in this technical field, he was possibly not informed of this circuit. However, it would occur readily to an engineer specialized in this technical field that the two OP amps may be formed into a sole OP amp. That is, in this circuit, the second OP amp (A2) may be deleted if the resistor R2 is connected in parallel with the resistor R1, connected in series with the transistor Q2, and also in parallel with the transistor Q2.

FIG. 2 of the Bamba's specification shows the process for introduction to the ‘current mode reference voltage generating circuit’ shown in FIG. 5 herein. This FIG. 2 is coincident with FIG. 9. This process is equivalent to claim 1 of Bamba's Patent No. 3586073, shown in FIG. 1 herein. A similar circuit is shown in e.g. in Chatal's U.S. Pat. No. 6,930,538 B2.

A specified value 10 for N is shown in JP Patent Kokai Publication No. JP-A-11-45125. However, when the circuit was actually implemented (IEEE Symposium on VLSI Circuits 1998 May), N was set to 100 (N=100).

In the CMOS process, the MOS transistor has been reduced in size in keeping with device miniaturization. On the other hand, the size of a diode, converted from a parasitic bipolar device, is significantly larger than that of the MOS transistor.

Moreover, since the ratio of the sizes of the diodes D1 and D2 is made higher by one or two orders of magnitude, the size of the diodes on the chip would be considerable.

FIG. 6 of the JP Patent Kokai Publication No. JP-A-11-45125 shows a circuit, shown herein in FIG. 10, configured to lower the input voltage to an OP amp by voltage division by parallel-connected resistors.

This circuit, appearing often in treatises, originates from Bamba. That is, the circuit is stated in claim 4 of Bamba's Patent 3586073, shown herein in FIG. 7.

That is, in the Bamba's JP Patent Kokai Publication No. JP-A-11-45125, description has been made to permit the process of the invention to be traced definitely, thus in a manner distinct from that by engineers specialized in this technical field.

Hence, those specialized in the relevant technical field may learn how the ‘current-mode reference voltage generating circuit’ has been devised.

This also may account for the fact that the circuit has not been implemented by those specialized in the relevant technical field. That is, the honest process may be traced through step-by-step analysis of the circuit operation to arrive at an improved circuit. Those specialized in the relevant technical field may skip over the steps of the process to arrive at a conclusion.

It is also possible to implement a reference voltage generating circuit, shown herein in FIG. 11, in which the two parallel-connected resistors of this Bamba's reference voltage generating circuit is changed to T-resistors (resistors R2 to R4) (Neaves, U.S. Pat. No. 7,009,374 B2 (Mar. 7, 2006).

Simulated values of the reference voltage generating circuit of FIG. 11 are shown below. If, with VDD=1.3V, N, R1, R2, R3, R4 and R5 are set so that N=2, R1=0.519 kΩ and R2=R3=R4=6.34 kΩ, and R5=5 kΩ, the values of Vref are:

367.32 mV at −53° C.,

368.04 mV at 0° C.,

368.153 mV at 27° C. and

367.425 mV at 107° C.

so that upside-down cup shaped characteristic has been obtained. The width of the temperature variations is suppressed to a lower value of 0.23%.

In this type of the current mode reference voltage generating circuit, a reference voltage lower than 1.205V is obtained. There are four methods, or five methods if the current mode circuit is also included. These are:
(A) a method of generating a current having a positive temperature characteristic or an IPTAT current (Current Proportional to Absolute Temperature) and further connecting a resistor in parallel with a series connection of a resistor and a transistor connected as a diode to lower the reference voltage (H. Neuteboom et al. “A DSP-Based Hearing Instrument IC”, IEEE Journal of Solid-State Circuits, Vol. 32 No. 11, pp. 1790-1806, November 1997), herein shown in FIG. 12;
(B) a method of causing two IPTAT currents, having a positive temperature characteristic, to flow through a transistor connected as diode and through a resistor to cross-link the two by a resistor (U.S. Pat No. 6,788,041; Sep. 7, 2004);
(C) a method of U.S. Pat. No. 6.531,857 B2 (Mar. 11, 2003) by Peicheng, shown herein in FIG. 13, a method of Washburn's U.S. Pat. No. 7,113,025 B2 (Sep. 26, 2006), shown herein in FIG. 14, where a diode of an output circuit is also used as a diode of a control circuit being compared, or a method shown herein in FIG. 15 in which the forward voltage of the diode is divided to lower the VCTAT current having a negative temperature characteristic and to cause the IPTAT current having a positive temperature characteristic to flow into a voltage-dividing resistor to cancel out the temperature characteristic; and
(D) a method of subtracting the current having a negative temperature characteristic (ICTAT current) from the current having a positive temperature characteristic (IPTAT current) (IPTAT−ICTAT) to increase the positive temperature characteristic to decrease the VPTAT voltage, shown herein in FIG. 16. However, these methods are not as yet well-known by the engineers in this technical field.

It should be noted in connection with the Peicheng's circuit of (C) above that, in substituting FIG. 2 for a hand-written drawing at the filing time, the drawing of the related art was copied and the so copied drawing was lodged, so that an unneeded resistor was not erased but left in FIG. 2.

Of these, the reference voltage generating circuit shown herein in FIG. 12 was proposed at an earliest date, and is such a circuit that enables generation of a reference voltage not higher than 1.2V. However, mysteriously, this circuit was not known until only recently.

This circuit was known only in 2003 as the present inventor referred to this technique as the related art in U.S. Pat. No. 6,528,979 B2 (Mar. 4, 2003) or in JP Patent 3586073.

The reference voltage generating circuit, shown in FIG. 12, was stated in only one page in a long 17-page treatise of a technical field other than this technical field (H. Neuteboom B. M. J. Kup and M. Janssens, “A DSP-Based Hearing Instrument IC”, IEEE J. Solid-State Circuits, Vol. 32, No. 11, pp. 1790-1806, November 1997). This treatise was long neglected because of exchanges in the numbers of resistors entered in the drawings or the numbers of resistors in the equation of the reference voltage, and also because of marked difference in the values of the reference voltages actually obtained on substitution of constants proposed by the writers. Moreover, the circuit was not applied for patent and hence was not referred to as related art.

The circuit of FIG. 12 also has the circuit topology shown in FIG. 7 and is no other than the conventional reference voltage generating circuit shown in FIG. 8 in which an output I-V converter (I-V3) has been changed and a resistor has been added to a resistor+diode.

Hence, the circuit of FIG. 12 and the circuit of FIG. 8, if seen as reference current circuits, are both a PTAT reference current circuit having a positive temperature characteristic. However, this reference voltage generating circuit differs in its character from other reference voltage generating circuits, and hence is in need of circuit analysis.

$$\begin{matrix}In Fig . 12 , if we let {I}_{1} = {I}_{2} = {I}_{3} \\ {I}_{1} = {I}_{2} = {I}_{3} = Δ {V}_{F} / R 1 = {V}_{T} ln ( N ) / {R}_{1} & ( 14 ) \\ Hence , \\ {I}_{3} = \frac{{V}_{REF} - {V}_{F 3}}{{R}_{2}} + \frac{{V}_{REF}}{{R}_{3}} = \frac{{V}_{T} ln ( N )}{{R}_{1}} & ( 15 )\end{matrix}$$

and hence the resulting reference voltage V_{ref} may be expressed by

$${V}_{ref} = \frac{{R}_{3}}{{R}_{2} + {R}_{3}} ( {V}_{F 3} + {R}_{2} {I}_{3} ) = \frac{{R}_{3}}{{R}_{2} + {R}_{3}} \{ {V}_{F 3} + \frac{{R}_{2}}{{R}_{1}} {V}_{T} ln ( N ) \} \qquad ( 16 )$$

Since {V_{F3}+(R₂/R₁)V_{T}ln(N)} may be set to a voltage of approximately 1.2V, from which temperature characteristic is cancelled, a reference voltage of 1.2V or less may be obtained with the voltage dividing ratio R₃/(R₂+R₃) (<1).

It should be noted that the reference voltage cannot be set to be V_{F3} or lower. If V_{F3} is 600 mV at ambient temperature, it is approximately 752 mV at −53° C. Hence, the reference voltage value that can be set is 900 mV or higher. That is, the voltage can be lowered to approximately three-fourths (¾) of the reference voltage value.

The values of simulation result are shown below. If, with VDD=1.8V, N, R1, R2 and R3 are set so that N=4, R1=1.19 kΩ, R2=18 kΩ, and R3=36 kΩ, the values of Vref are:

879.82 mV at −53° C.,

886.68 mV at 0° C.,

886.7 mV at 27° C.

879.55 mV at 107° C.

so that upside-down cup shaped characteristic, somewhat smoothed at a high temperature side, has been obtained. The width of the temperature variations is suppressed to a lower value of 0.84%.

Only the circuit analysis of the Bamba's reference voltage generating circuit has been made in some detail, while the circuit analysis of conventional circuits, shown in FIGS. 13 to 16, is omitted. However, if it is understood that the method of canceling out temperature characteristic may be implemented by weighted summation of VPTAT and VCTAT or that of IPTAT and ICTAT, it will be readily understood that the conventional circuit shown in FIGS. 13 to 16 may be obtained by slightly modifying the weighting methods.

Moreover, the method of generating a reference current and driving an output circuit via a current mirror circuit is affected by channel length modulation, and hence the effect of the power supply voltage may present itself, because the output circuit is placed outside the control loop.

Or, the temperature non-linearity of a diode presents itself in the CTAT voltage. Since the PTAT voltage, obtained in the above-described conventional circuits, is superior in temperature linearity, the temperature non-linearity of a diode, unavoidably presents itself with the conventional methods in which the temperature characteristic is cancelled by the CTAT voltage and the PTAT voltage to generate a reference voltage. The temperature non-linearity may present itself more prominently with the conventional reference voltage generating circuit shown for example in FIG. 6. As a circuit for compensating the temperature non-linearity of a diode, there is a circuit shown herein in FIG. 17. This circuit is applied to the Bamba's reference voltage generating circuit shown herein in FIG. 6.

Although the circuit shown in FIG. 17 is difficult to analyze, the circuit analysis of the original reference voltage generating circuit by Bamba, shown in FIG. 6 herein, has been described above in detail.

In FIG. 17, a diode D3, driven by a current (I4) from a common current mirror circuit, is added. Since the current mirror circuit outputs equal currents,

I1=I2=I3=I4 (17)

In the first current-voltage converter circuit, a resistor R1 is connected in parallel with the diode R1. The driving current I1 is divided by the current I1A driving the diode D1 and the current I1B driving the resistor R1 and

I1B=VF1/R1 (18)

where I1B is a current containing a temperature non-linear component of a diode.

Moreover, since a low current IN flows from the diode D3 through resistor R5 to the first current-voltage converter circuit, having the diode D1,

I1B=I1−I1B+IN (19)

In similar manner, the current I4a flowing through the diode D3 is

$$\begin{matrix}I 4 a = I 4 - 2 IN = I 1 - 2 IN \\ Here & ( 20 ) \\ IN = ( VF 4 - VF 1 ) / R 5 \\ Hence , & ( 21 ) \\ \begin{matrix}VF 4 - VF 1 = {V}_{T} ln ( I 4 a / I 1 A ) \\ = {V}_{T} ln \{ ( I 1 - 2 IN ) / ( I 1 - I 1 B + 1 N ) \}\end{matrix} & ( 22 )\end{matrix}$$

in the denominator of within {} of ln, −I1B is included.

It is noted that IN<<I1B and VF4−VF1 contains the temperature non-linear component of a diode.

Hence, the non-linear component of a diode is contained in the current IN (={(VF4−VF1)/R5}) flowing through the resistor R5, and flows into the resistor R1 to take care of the temperature non-linear component of a diode, contained in the current I1B flowing in the resistor R1 (=VF1/R).

Hence, the temperature non-linear component of a diode, is scarcely contained in the current I1 (=I3) supplied from the current mirror circuit. That is, the current IN is the current that compensates for the temperature non-linear component of a diode.

Simulated values, obtained by the present inventor, are shown below. If, with VDD=1.3V, N and R0 to R5 are set so that N=24, R0=10.9 kΩ, R1=R2=80 kΩ, R3=35 kΩ, and R4=R5=8.0625 kΩ, the values of Vref are:

515.892 mV at −53° C.,

515.987 mV at 0° C.,

516.063 mV at 27° C.

515.89 mV at 107° C.

so that upside-down cup shaped characteristic, somewhat offset to a high temperature side, has been obtained.

The width of the temperature variations is suppressed to an extremely low value of 0.0382%.

According to SPICE simulation, conducted by the present inventor, when a constant power supply voltage is applied to the Bamba's reference voltage generating circuit, shown in FIG. 6, the characteristic curve is in an upside-down cup shape, within the temperature range of ±80° C. of from −53° C. to 107° C., with the width of the temperature variations of the order of 0.2% to 0.3%. On the other hand, if, with the reference voltage generating circuit of FIG. 17, compensated by the current supplied from the added diode, the constant power supply voltage is applied, the characteristic curve is of a wavy shape to an upside-down cup shape, for the temperature range of ±80° C. of from −53° C. to 107° C., with the width of the temperature variations being less than 0.1%.

Meanwhile, in the reference voltage generating circuit of FIG. 16, temperature non-linearity proper to diodes presents itself most outstandingly, such that, when a constant power supply voltage is applied, an upside down cup shaped characteristic will appear for the temperature range of ±80° C. of from −53° C. to 107° C., with the width of the temperature variations being 2 to 3%.

As the reference voltage generating circuit, with the circuit topology of FIG. 7, generating a reference voltage not higher than 1.2V, the following three circuits are now described. These are a reference voltage generating circuit by Wada, shown herein in FIG. 18 (M. Wada, “Reference Power Supply Circuit for Semiconductor Device”, U.S. Pat. No. 7,005,839 B2 (Feb. 28, 2006);

a reference voltage generating circuit by Brokaw, shown herein in FIG. 19 (A. P. Brokaw, “Curvature Corrected Bandgap Reference Circuit and Method” Pub. No. US 2005/0194957 A1 (Sep. 8, 2005)); and

a reference voltage generating circuit by Kimura, shown herein in FIG. 20 (“Reference Voltage Generating Circuit”, JP Patent Kokai Publication No. JP-P2006-209212A (Aug. 10, 2006).

The reference voltage generating circuit, shown in FIG. 18, is described in JP Patent Kokai Publication No. JP-P2005-173905A, which is already registered in US (U.S. Pat. No. 7,005,839 B2 (Feb. 28, 2006)). The same circuit is also seen in JP Patent Kokai Publication No. JP-P2006-133916A (FIG. 2) by the present inventor. The reference voltage generating circuit of FIG. 18 is a low voltage reference voltage generating circuit having outstanding diode non-linear characteristics. This circuit is again filed for patent with the inventor being an engineer of the field of memories and, in terms of circuit characteristics, is apparently a combination of the reference voltage generating circuit of FIG. 8 and the Bamba's reference voltage generating circuit, shown herein in FIG. 6. Stated briefly, the circuit is the current to voltage converter circuit (I-V1) of the Bamba's reference voltage generating circuit less a parallel-connected resistor.

In FIG. 18, since the OP amp exercises control so that VA=VB,

V_{A}=V_{F1}=V_{B} (24)

It is assumed that the current mirror ratio is equal and that output currents I1 to I3 are all equal to one another. The current I1 directly flows through a diode D1 constituting a first current-to-voltage converter circuit (I-V1) so as to be converted into voltage. Turning to the second current-to-voltage conversion circuit (I-V2), the current I2 is divided into a current flowing through resistor R1 into diodes D22 and a current flowing through resistor R2.

Hence,

$$\begin{matrix}{I}_{1} = {I}_{2} \\ = {I}_{3} \\ = ( {V}_{F 1} - {V}_{F 2} ) / {R}_{1} + {V}_{F 1} / {R}_{2} \\ = \{ ( {V}_{F 1} + ( {R}_{2} / {R}_{1} ) Δ {V}_{F} ) / {R}_{2}\end{matrix} \qquad ( 25 )$$

V_{F1} has a temperature characteristic of approximately −1.9 mV/° C., whereas V_{F2} also has a temperature characteristic of approximately −1.9 mV/° C.

If D1 is a unit diode and D2 is N times the unit diode,

ΔV_{F}=V_{T}ln[N{I₁/(I₂−V_{F1}R₂)}] (26)

Hence, we have

V_{REF}=R₃I₃=(R₃/R₂){V_{F1}+(R₂/R₁)ΔV_{F}} (27)

Since I₁=I₂,

I₁>(I₂−V_{F1}R₂)>1

I₁/(I₂−V_{F1}R₂)>1

holds.

It will be understood that the term In of the equation (26) is always positive (>0). That is, ΔV_{F} again has a positive temperature characteristic, in this circuit, in a well-known manner.

Hence, the temperature characteristic is approximately proportional to the thermal voltage V_{T} having temperature characteristic of 0.0853 mV/° C. That is, the temperature characteristic of the term of {V_{F1}+(R2/R1)ΔV_{F}} of the equation (27) can be substantially cancelled by summing V_{F1} having a negative temperature characteristic and ΔV_{F} having a positive temperature characteristic by setting the resistance ratio (R₂/R₁) and by carrying out the weighted summation.

More specifically, V_{F1} has a negative temperature characteristic of approximately −1.9 mV/° C., such that the current V_{F1}/R₂ has a negative temperature characteristic.

Hence, N{I₁/(I₂−V_{F1}/R₂)} has a negative temperature characteristic, whereas its log value, that is, ln[N{I₁/(I₂−V_{F1}R₂)}] has slightly negative temperature characteristic.

That is, in the equation (16), the term of V_{F1} has a negative temperature characteristic, whereas the term of ΔV_{F} has a positive temperature characteristic. The term of ΔV_{F} is expressed by the product of V_{T} having a positive temperature characteristic and ln[N{I₁/(I₂−V_{F1}R₂)}] having a negative temperature characteristic.

Noteworthy here is the current term (V_{F1}R₂). In this term, the non-linear temperature characteristic of V_{F} appearing in the term of V_{F1} having a negative temperature characteristic and the non-linear temperature characteristic of the term of V_{F1} having a positive temperature characteristic appear superposed together.

Hence, non-linear temperature characteristic of V_{F} appear more pronouncedly in the output voltage V_{REF} of this reference voltage generating circuit than in the Bamba's circuit described above in detail. Moreover, the effect can be variably set by the resistor R2.

Simulated values, obtained by the present inventor, are shown below. If, with VDD=1.3V, N and R1 to R3 are set so that N=2, R1=0.452 kΩ, R2=19 kΩ and R3=5 kΩ, the values of Vref are:

527.06 mV at −53° C.,

532.72 mV at 0° C.,

533.48 mV at 27° C.

527 mV at 107° C.

so that upside-down cup shaped characteristic has been obtained. The width of the temperature variations is large and amounts to 1.22%.

The reference voltage generating circuit, shown in FIG. 19, is a circuit applied for and provisionally published as US Patent. This reference voltage generating circuit is the current-to-voltage conversion circuit (I-V2) of the reference voltage generating circuit of FIG. 18 in which is inserted a series resistor R3. This reference voltage generating circuit allows for circuit analysis.

In FIG. 19, the OP amp exercises control to VA=VB, so that VA=VB=V_{F1} and

$${I}_{2} = \frac{{V}_{F 1} - {V}_{1}}{{R}_{1}} = \frac{{V}_{1} - {V}_{F 2}}{{R}_{2}} + \frac{{V}_{1}}{{R}_{3}} \qquad ( 28 )$$

From the equation (28), V1 is

$${V}_{1} = \frac{{R}_{2} {R}_{3} {V}_{F 1} + {R}_{3} {R}_{1} {V}_{F 2}}{{R}_{1} {R}_{2} + {R}_{2} {R}_{3} + {R}_{3} {R}_{1}} \qquad ( 29 )$$

and the equation (28) may be found from

$$\begin{matrix}{I}_{2} = \frac{( {R}_{2} + {R}_{3} ) {V}_{F 1} - {R}_{3} {V}_{F 2}}{{R}_{1} {R}_{2} + {R}_{2} {R}_{3} + {R}_{3} {R}_{1}} \\ = \frac{{R}_{2} {V}_{F 1} + {R}_{3} Δ {V}_{F}}{{R}_{1} {R}_{2} + {R}_{2} {R}_{3} + {R}_{3} {R}_{1}} \\ = \frac{{R}_{2}}{{R}_{1} {R}_{2} + {R}_{2} {R}_{3} + {R}_{3} {R}_{1}} ( {V}_{F 1} + \frac{{R}_{3}}{{R}_{2}} Δ {V}_{F} )\end{matrix} \qquad ( 30 )$$

Since the current I2A flowing through the diode D2 is

$$\begin{matrix}{I}_{2 A} = \frac{{V}_{1} - {V}_{F 2}}{{R}_{2}} \\ = \frac{{R}_{3} Δ {V}_{F} - {R}_{1} {V}_{F 2}}{{R}_{1} {R}_{2} + {R}_{2} {R}_{3} + {R}_{3} {R}_{1}}\end{matrix} \qquad ( 31 )$$

we have

$$Δ {V}_{F} = V - {V}_{F 2} = {V}_{T} ln ( \frac{N {I}_{1}}{{I}_{2 A}} ) = {V}_{T} ln \{ \frac{N ( 1 + \frac{{R}_{2}}{{R}_{3}} \frac{{V}_{F 1}}{Δ {V}_{F}} )}{1 - \frac{{R}_{1}}{{R}_{3}} \frac{{V}_{F 2}}{Δ {V}_{F}}} \} \qquad ( 32 )$$

Since R1 and R2<<R3,

ΔV_{F}≈V_{T}ln(N) (33)

Hence, if I1=I2=I3, the reference voltage obtained may be expressed as

$$\begin{matrix}{V}_{REF} = {R}_{4} {I}_{2} = \frac{{R}_{2} {R}_{4}}{{R}_{1} {R}_{2} + {R}_{2} {R}_{3} + {R}_{3} {R}_{1}} ( {V}_{F 1} + \frac{{R}_{3}}{{R}_{2}} Δ {V}_{F} ) \\ \approx \frac{{R}_{2} {R}_{4}}{{R}_{1} {R}_{2} + {R}_{2} {R}_{3} + {R}_{3} {R}_{1}} \{ {V}_{F 1} + \frac{{R}_{3}}{{R}_{2}} {V}_{T} ln ( N ) \}\end{matrix} \qquad ( 34 )$$

Since {V_{F1}+(R₂/R₁)ΔV_{F}} may be set to approximately 1.2V with the temperature characteristic cancelled. Hence, the reference voltage not higher than 1.2V may be obtained from the voltage dividing ratio of {R₂R₄/(R₁R₂+R₂R₃+R₃R₁)} (<1).

Simulated values, obtained by the present inventor, are shown below. If, with VDD=1.3V, N and R1 to R3 are set so that N=5, R1=1.8 kΩ, R2=0.502 kΩ, R3=27 kΩ, and R3=10 kΩ, the values of Vref are:

365.434 mV at −53° C.,

364.74 mV at −10° C.,

364.8 mV at 0° C.

365.08 mV at 27° C. and

365.183 mV at 107° C.

so that a wave shaped characteristic has been obtained. The width of the temperature variations is suppressed to 0.193%. This width of temperature variations is lower than 0.3% shown in the Patent Publication.

Clearly, this reference voltage generating circuit compensates temperature non-linearity of a diode.

That is, the function of compensating for the temperature non-linearity of a diode may be implemented by simply adding a sole resistor.

The reference voltage generating circuit, which has similarly achieved the function of compensating for the temperature non-linearity of a diode, is shown in FIG. 20. This circuit was devised by the same inventor as the present inventor and described in FIG. 12 of the JP Patent Kokai Publication No. JP-P2006-209212A (Aug. 10, 2006).

FIG. 20 shows a reference voltage generating circuit in which the first current-to-voltage converter circuit (I-V1) and the second current-to-voltage conversion circuit (I-V2) are each changed to a current-to-voltage conversion circuit in which a resistor is connected in parallel with a diode and further a resistor is connected in series with the parallel connection. It is noted that the circuit shown in FIG. 20 is not analytic.

If assumed in FIG. 20 that the current mirror ratio is equal and the output currents I1, I2 and I3 are all equal, we have

I₁=I₂=I₃ (35)

The OP amp controls so that VA=VB, wherein

V_{A}=V_{F1}+R₁I₁ (36)

and

V_{B}=V_{F2}+R₃I₂ (37)

so that

$${V}_{F 1} - {V}_{F 2} = Δ {V}_{F} = {I}_{1} ( {R}_{3} - {R}_{1} ) \qquad ( 38 )$$

Hence,

I₁=I₂=I₃=ΔV_{F}/(R₃−R₁) (39)

The reference voltage obtained V_{REF} is given by

V_{REF}=R₅I₃=ΔV_{F}/R₅/(R₃−R₁) (40)

In order for Vref not to have a temperature characteristic, ΔV_{F} must be set so as not to have temperature characteristic.

ΔV_{F} may also be expressed as

$$Δ {V}_{F} = {V}_{T} ln \{ N ( \frac{1 - \frac{{V}_{F 1}}{{I}_{1} {R}_{2}}}{1 - \frac{{V}_{F 2}}{{I}_{1} {R}_{4}}} ) \} \qquad ( 41 )$$

Since V_{T} is proportional to absolute temperature, it is changed at a temperature change of ±76° C. in a range of 224/300˜1˜376/300. The exponential value is 2.10995˜2.71828˜3.501997, with the rate of change being −22.4%˜0%˜+28.8%.

However, the width of temperature change at ±76° C. is 152°, so that, if the rate of change is divided by the width of temperature change, the result is −0.337% at most.

It seems to be possible to have this order of temperature change taken charge of by

{1−V_{F1}/(I₁R₂)}/{1−V_{F2}/(I₁R₄)}.

Simulated values, obtained by the present inventor, are shown below. If, with VDD=1.3V, N and R1 to R5 are set so that N=2, R1=1.2 kΩ, R2=80 kΩ, R3=2.311 kΩ, R4=34 kΩ and R5=20 kΩ, the values of V_{ref} are:

633.13 mV at −53° C.,

632.682 mV at −20° C.,

632.81 mV at 0° C.,

632.948 mV at 27° C.,

633.13 mV at 70° C.

632.799 mV at 107° C.

so that wave-shaped characteristic has been obtained. The width of the temperature variations is suppressed to 0.0714%.

It has been confirmed that the temperature non-linearity of a diode has been compensated in this reference voltage generating circuit as well.

### SUMMARY OF THE DISCLOSURE

The above-described conventional reference voltage generating circuits have the following problems.

The first problem is that the adverse effect of the supply power variations is manifested. This results because the output circuit is arranged outside the control loop.

The second problem is that fluctuations become significant. This results because control is exercised so that the voltage in a circuit where there is a resistor connected in series with a diode will become equal to the voltage in a circuit where there is no such resistor.

The third problem is that, since a broad input voltage range for the OP amp is needed, the circuit is difficult to be operated at a low voltage. This results because the input voltage of the OP amp is varied with the temperature.

It is therefore an object of the present invention to provide a reference voltage generating circuit in which a controlled voltage is made a reference voltage and an output circuit is taken into a control loop to reduce variations.

It is another object of the present invention to provide a reference voltage generating circuit improved in characteristic or performance, for example, a reference voltage generating circuit capable of generating an output voltage not less than or not higher than 1V.

It is yet another object of the present invention to provide a reference voltage generating circuit which is improved in operational accuracy and which may be operated at a low voltage. It is a more specific object of the present invention to provide a reference voltage generating circuit affected to a lesser extent by power supply voltage variations or device-based fluctuations, and which may be operated from a voltage on the order of 1.2V by having the output voltage set to 1V or less.

The invention disclosed in the present application has substantially the following constitution.

A reference voltage generating circuit according to the present invention includes control means for exercising control so that a preset output voltage of a first current-to-voltage converter circuit will be equal to a preset output voltage of a second current-to-voltage conversion circuit, and a current mirror circuit for supplying the current to the first and second current-to-voltage converter circuits. At least a preset output voltage of the first current-to-voltage converter circuit or a preset output voltage of the second current-to-voltage conversion circuit is to be used as the reference voltage.

According to the present invention, the first and second current-to-voltage converter circuits are each composed of a series connection of a resistor and a diode (or a bipolar transistor connected as diode).

In the present invention, a resistor may be connected to each of the first and second current-to-voltage converter circuits and one of respective mid-point voltages may be used as output voltage.

In the present invention, the first and second current-to-voltage converter circuits are each composed of a series connection of a resistor and a diode (or a bipolar transistor connected as diode) and a further resistor connected in parallel with each series connection. A mid-point voltage of the resistor in the parallel path may be used as an output voltage.

In the present invention, the first and second current-to-voltage converter circuits are each a series connection of a resistor and a diode (or a bipolar transistor connected as diode) and a further resistor connected in parallel with the series connection. A mid-point voltage of the further resistor in the parallel path may be used as the preset voltage of each of the current-to-voltage converter circuits.

A still further resistor may be connected in parallel with each of the first and second current-to-voltage converter circuits.

A reference voltage generating circuit according to the present invention, includes a first current-to-voltage converter circuit for outputting a preset output voltage and a divided voltage; a second current-to-voltage converter circuit for outputting a preset output voltage and a divided voltage; control means for exercising control so that the two divided voltages are made equal to each other, and a current mirror circuit for supplying currents to the first current-to-voltage converter circuit and to the second current-to-voltage conversion circuit. At least a preset output voltage of the first current-to-voltage converter circuit or a preset output voltage of the second current-to-voltage conversion circuit is used as a reference voltage.

The first and second current-to-voltage converter circuits are each a series connection of a resistor and a diode (or a bipolar transistor connected as diode) and a further resistor connected in parallel with the series connection, and each output a divided voltage of the preset output voltage.

According to the present invention, a reference voltage generating circuit includes control means for exercising control so that a preset output voltage of a first current-to-voltage converter circuit will be equal to a preset output voltage of a second current-to-voltage converter circuit, a third current-to-voltage converter circuit, a fourth current-to-voltage converter circuit, and a current mirror circuit for supplying the current to the first to fourth current-to-voltage converter circuits. A resistor is connected between the first and third current-to-voltage converter circuits, and another resistor is connected between the second and fourth current-to-voltage converter circuits. At least a preset output voltage of the first current-to-voltage converter circuit or a preset output voltage of the second current-to-voltage converter circuit is used as a reference voltage.

The first and second current-to-voltage converter circuits are each a resistor, whereas the third current-to-voltage converter circuit is a diode (or a bipolar transistor connected as diode), and the fourth current-to-voltage converter circuit is a series connection of a resistor and a diode (or a bipolar transistor connected as diode).

According to the present invention, a reference voltage generating circuit includes control means for exercising control so that a preset divided voltage of a first current-to-voltage converter circuit will be equal to a preset output voltage of a second current-to-voltage converter circuit, a third current-to-voltage converter circuit, a fourth current-to-voltage converter circuit, and a current mirror circuit for supplying the current to the first to fourth current-to-voltage converter circuits. A resistor is connected between the first and third current-to-voltage converter circuits, and another resistor is connected between the second and fourth current-to-voltage converter circuits. At least a preset output voltage of the first current-to-voltage converter circuit or a preset output voltage of the second current-to-voltage converter circuit is used as a reference voltage.

The first and second current-to-voltage converter circuits are each composed of a voltage-dividing resistor outputting a divided voltage. The third current-to-voltage converter circuit is composed of a diode (or a bipolar transistor connected as diode), whereas the fourth current-to-voltage converter circuit is composed of a series connection of a resistor and diode (or a bipolar transistor connected as diode).

Or, according to the present invention, a reference voltage generating circuit includes control means for exercising control so that a preset output voltage of a first current-to-voltage converter circuit will be equal to a preset output voltage of a second current-to-voltage converter circuit, a third current-to-voltage converter circuit, a fourth current-to-voltage converter circuit, and a current mirror circuit for supplying the current to the first to fourth current-to-voltage converter circuits. A resistor is connected between the first and third current-to-voltage converter circuits, and another resistor is connected between the second and fourth current-to-voltage converter circuits. At least a preset output voltage of the third current-to-voltage converter circuit or a preset output voltage of the fourth current-to-voltage converter circuit is used as a reference voltage.

The first current-to-voltage converter circuit is composed of a diode (or a bipolar transistor connected as diode). The second current-to-voltage conversion circuit is composed of a series connection of a resistor and a diode (or a bipolar transistor connected as diode). The third and fourth current-to-voltage converter circuits are each a resistor.

Or, according to the present invention, a reference voltage generating circuit includes control means for exercising control so that a preset output voltage of a first current-to-voltage converter circuit will be equal to a preset output voltage of a second current-to-voltage converter circuit, a third current-to-voltage converter circuit, a fourth current-to-voltage converter circuit, and a current mirror circuit for supplying the current to the first to fourth current-to-voltage converter circuits. The current is caused to flow via the first current-to-voltage converter circuit to a mid-point terminal of the third current-to-voltage converter circuit, whereas the current is caused to flow via the second current-to-voltage conversion circuit to a mid-point terminal of the fourth current-to-voltage converter circuit. At least a preset output voltage of the first current-to-voltage converter circuit or a preset output voltage of the second current-to-voltage converter circuit is used as a reference voltage.

The first and second current-to-voltage converter circuits are each a resistor, whereas the third current-to-voltage converter circuit is composed of a parallel connection of a diode (or a bipolar transistor connected as diode) and a resistor and includes the aforementioned mid-point terminal. The fourth current-to-voltage converter circuit is composed of a series connection of a diode (or a bipolar transistor connected as diode) and a resistor and a further resistor connected in parallel with the series connection.

Or, according to the present invention, a reference voltage generating circuit includes control means for exercising control so that a preset output voltage of a first current-to-voltage converter circuit will be equal to a preset output voltage of a second current-to-voltage converter circuit, a third current-to-voltage converter circuit, a fourth current-to-voltage converter circuit, and a current mirror circuit for supplying the current to the first to fourth current-to-voltage converter circuits. The third current-to-voltage converter circuit and the fourth current-to-voltage converter circuit cause the currents to flow into a mid-point terminal of the first current-to-voltage converter circuit and into that of the second current-to-voltage converter circuit. At least a preset output voltage of the third current-to-voltage converter circuit or a preset output voltage of the fourth current-to-voltage converter circuit is used as a reference voltage.

The first current-to-voltage converter circuit is composed of a parallel connection of a diode (or a bipolar transistor connected as diode) and a resistor, and has the aforementioned mid-point terminal. The second current-to-voltage conversion circuit is composed of a series connection of a resistor and a diode (or a bipolar transistor connected as diode) and a further resistor connected in parallel with the series connection, and has the aforementioned mid-point terminal.

Or, according to the present invention, a reference voltage generating circuit includes control means for exercising control so that a preset mid-point terminal voltage of a first current-to-voltage converter circuit will be equal to a preset mid-point terminal voltage of a second current-to-voltage converter circuit, a third current-to-voltage converter circuit, a fourth current-to-voltage converter circuit, and a current mirror circuit for supplying the current to the first to fourth current-to-voltage converter circuits. The third current-to-voltage converter circuit and the fourth current-to-voltage converter circuit cause the currents to flow into a mid-point terminal of the first current-to-voltage converter circuit and into that of the second current-to-voltage converter circuit. At least a preset output voltage of the third current-to-voltage converter circuit or a preset output voltage of the fourth current-to-voltage converter circuit is used as a reference voltage.

The first current-to-voltage converter circuit is composed of a parallel connection of a diode (or a bipolar transistor connected as diode) and a resistor, and has the aforementioned mid-point terminal. The second current-to-voltage conversion circuit is composed of a series connection of a resistor and a diode (or a bipolar transistor connected as diode) and a further resistor connected in parallel with the series connection, and has the aforementioned mid-point terminal.

Or, according to the present invention, a reference voltage generating circuit includes first control means for exercising control so that a preset output voltage of a first current-to-voltage converter circuit will be equal to a preset output voltage of a second current-to-voltage converter circuit, and a first current mirror circuit for supplying the current to the first and second current-to-voltage converter circuits. The reference voltage generating circuit also includes second control means for exercising control so that a preset output voltage of a third current-to-voltage converter circuit will be equal to a preset output voltage of a fourth current-to-voltage converter circuit, and a second current mirror circuit for supplying the current to the third and fourth current-to-voltage converter circuits. The reference voltage generating circuit further includes means for performing weighted summation of the currents flowing through the first and second current mirror circuits. The resulting current obtained on weighted summation is then converted into a voltage which is used as reference voltage.

The first current-to-voltage converter circuit is composed of a parallel connection of a diode (or a bipolar transistor connected as diode) and a resistor, whereas the second current-to-voltage conversion circuit is composed of a series connection of a resistor and a diode (or a bipolar transistor connected as diode) and a further resistor connected in parallel with the series connection. The third current-to-voltage converter circuit is a diode (or a bipolar transistor connected as diode), whereas the fourth current-to-voltage conversion circuit is composed of a series connection of a resistor and a diode (or a bipolar transistor connected as diode).

Or, according to the present invention, a resistor is connected between the diode (or the bipolar transistor connected as diode) driven by the current from the first current mirror circuit and the first current-to-voltage converter circuit, and a further resistor is connected between the diode (or the bipolar transistor connected as diode) driven by the current from the first current mirror circuit and the second current-to-voltage converter circuit.

Or, according to the present invention, a reference voltage generating circuit includes first control means for exercising control so that a preset output voltage of a first current-to-voltage converter circuit will be equal to a preset output voltage of a second current-to-voltage converter circuit, and a first current mirror circuit for supplying the current to the first and second current-to-voltage converter circuits. The reference voltage generating circuit also includes second control means for exercising control so that a preset output voltage of a third current-to-voltage converter circuit will be equal to a preset output voltage of a fourth current-to-voltage converter circuit, and a second current mirror circuit for supplying the current to the third and fourth current-to-voltage converter circuits. The reference voltage generating circuit further includes means for performing weighted summation of the currents flowing through the first and second current mirror circuits. The resulting current obtained on weighted summation is then converted into a voltage which is used as reference voltage.

The first and third current-to-voltage converter circuits are each made up of a parallel connection of a diode (or a bipolar transistor connected as diode) and a resistor, whereas the second and fourth current-to-voltage converter circuits are each made up of a series connection of a resistor and a diode (or a bipolar transistor connected as diode) and a further resistor connected in parallel with the series connection.

Or, according to the present invention, a reference voltage generating circuit includes first control means for exercising control so that a preset mid-point terminal voltage of a first current-to-voltage converter circuit will be equal to a preset mid-point terminal voltage of a second current-to-voltage converter circuit, and a first current mirror circuit for supplying the current to the first and second current-to-voltage converter circuits. The reference voltage generating circuit also includes second control means for exercising control so that a preset mid-point terminal voltage of a third current-to-voltage converter circuit will be equal to a preset mid-point terminal voltage of a fourth current-to-voltage converter circuit, and a second current mirror circuit for supplying the current to the third and fourth current-to-voltage converter circuits. The reference voltage generating circuit further includes means for performing weighted summation of the currents flowing through the first and second current mirror circuits. The resulting current obtained on weighted summation is then converted into a voltage which is used as reference voltage.

The first and third current-to-voltage converter circuits are each composed of a parallel connection of a diode (or a bipolar transistor connected as diode) and a resistor and each include the aforementioned mid-point terminal. The second and fourth current-to-voltage converter circuits are each composed of a series connection of a diode (or a bipolar transistor connected as diode) and a resistor and a further resistor connected in parallel with the series connection, and each include the aforementioned mid-point terminal.

Or, according to the present invention, a reference voltage generating circuit includes first and second current-to-voltage converter circuits, interconnected via a series resistor. A further resistor is connected to a mid-point junction of the series resistor and grounded. The reference voltage generating circuit further includes control means for exercising control so that the terminal voltages of the first and second current-to-voltage converter circuits will be equal to each other, third and fourth current-to-voltage converter circuits, and a first current mirror circuit for supplying the currents to the first to fourth current-to-voltage converter circuits. The reference voltage generating circuit further includes a second current mirror circuit for supplying the currents via resistors to the first and second current-to-voltage converter circuits, and second control means for exercising control so that a preset output voltage of the fourth current-to-voltage converter circuit will be equal to the terminal voltage of one of the two resistors. A preset output voltage of the fourth current-to-voltage converter circuit is used as a reference voltage.

The first and third current-to-voltage converter circuits are each a diode (or a bipolar transistor connected as diode). The second current-to-voltage conversion circuit is composed of a series connection of a resistor and a diode (or a bipolar transistor connected as diode), and the fourth current-to-voltage converter circuit is a resistor.

Or, according to the present invention, a reference voltage generating circuit includes control means for exercising control so that preset terminal voltages of the first and second current-to-voltage converter circuits, driven by constant current, will be equal to each other, and means for dividing an output voltage of the second current-to-voltage conversion circuit, with the divided voltage being used as a reference voltage.

The first current-to-voltage converter circuit is a diode (or a bipolar transistor connected as diode), whereas the second current-to-voltage conversion circuit is a plural number of parallel-connected diodes (or bipolar transistors connected as diodes).

The meritorious effects of the present invention are summarized as follows.

A first meritorious effect of the present invention is that the variations may be minimized. The reason is that, according to the present invention, the output circuit is taken into a control loop and the reference voltage is the controlled voltage.

A second meritorious effect of the present invention is that the adverse effect due to fluctuations may be reduced. The reason is that, in the present invention, the circuit topology of two current-to-voltage converter circuits may be identified with that of the output circuit.

A third meritorious effect of the present invention is that the reference voltage generating circuit may be operated at a low voltage. The reason is that, in the present invention, the output voltage is fixed at a constant voltage value.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTIONS OF THE DRAWINGS

FIG. 1 is a diagram showing an illustrative conventional circuit.

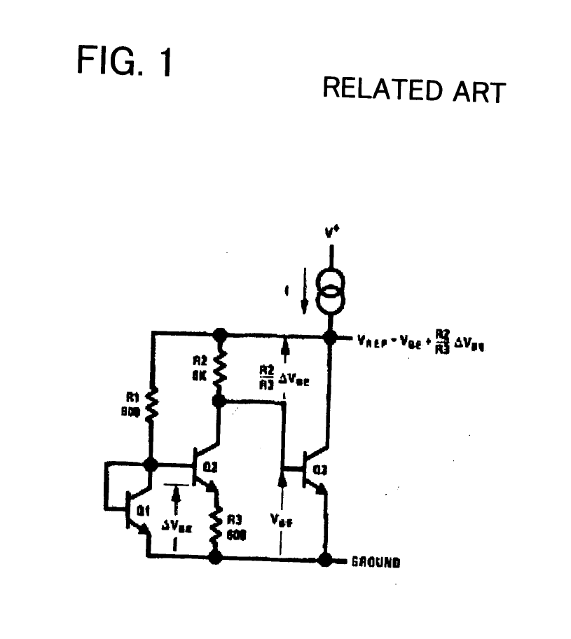

FIG. 2 is a diagram showing an illustrative conventional circuit appearing in literature.

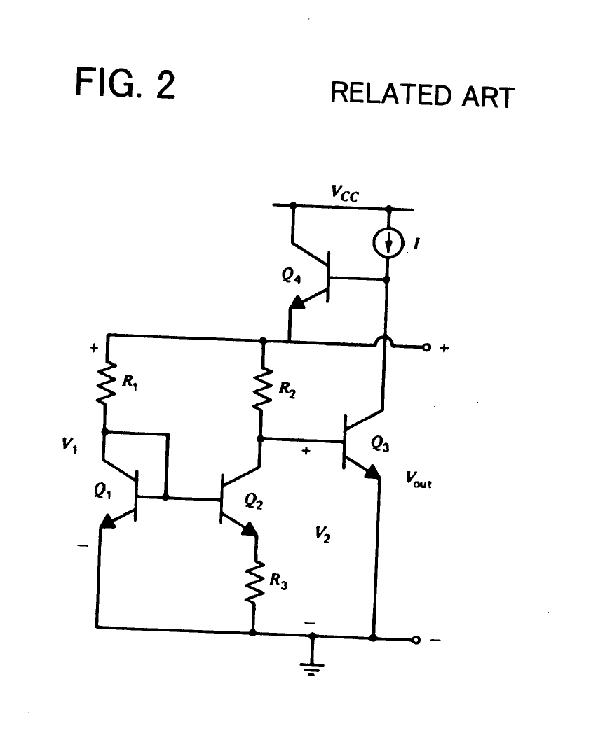

FIG. 3 is a diagram for illustrating the method for canceling out temperature characteristic of a conventional circuit appearing in literature.

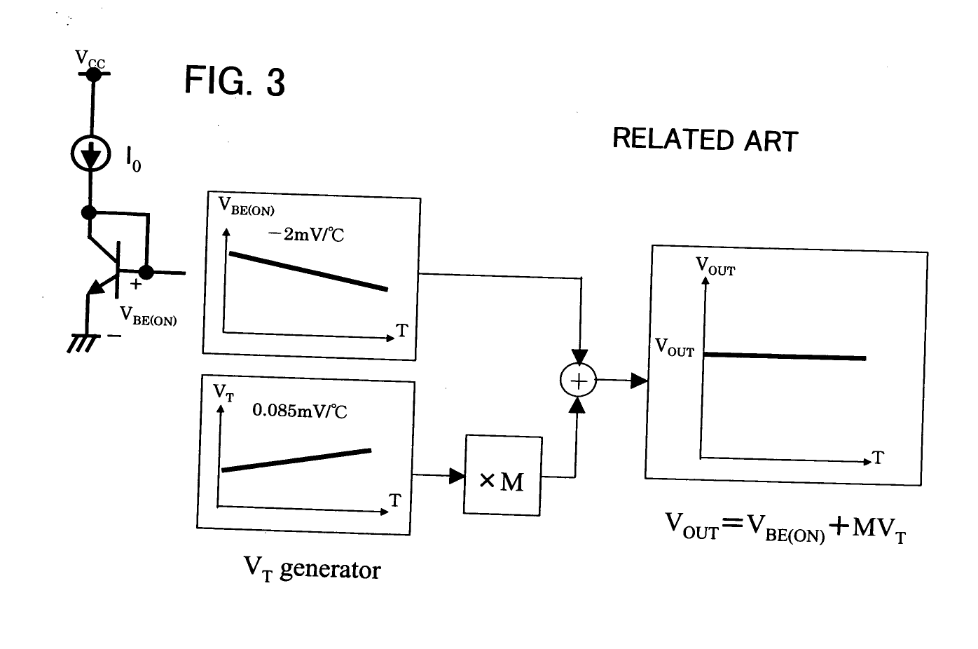

FIG. 4 is a diagram showing an illustrative conventional circuit appearing in literature.

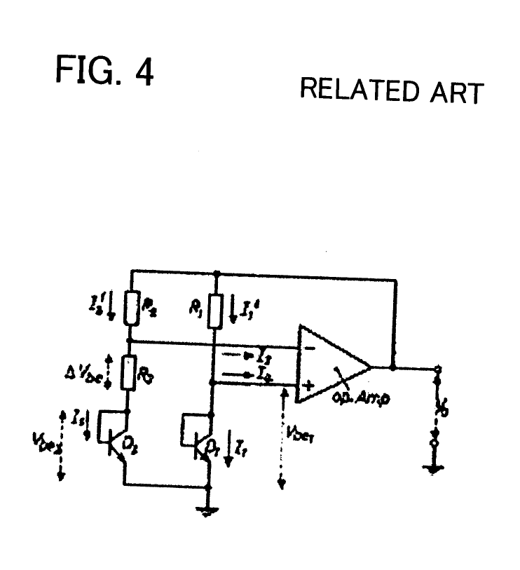

FIG. 5 is a diagram showing an illustrative conventional circuit of a self-bias configuration.

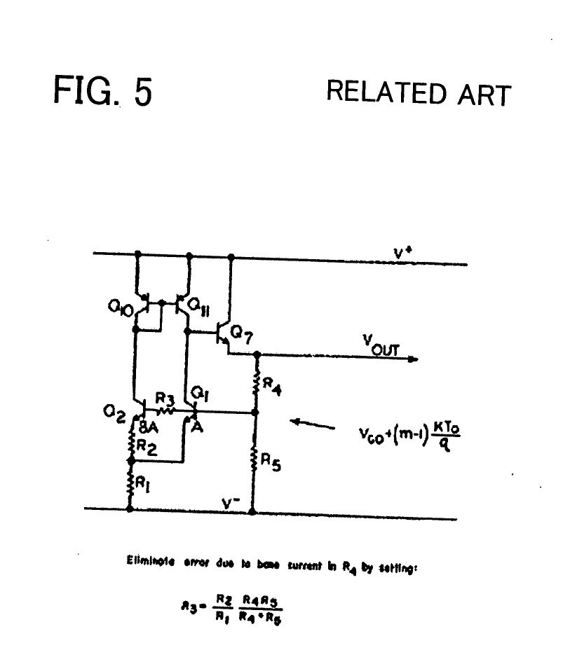

FIG. 6 is a diagram showing an illustrative low-voltage conventional circuit.

FIG. 7 is a block diagram showing an illustrative circuit topology of a reference voltage generating circuit.

FIG. 8 is a diagram showing a well-known illustrative conventional circuit.

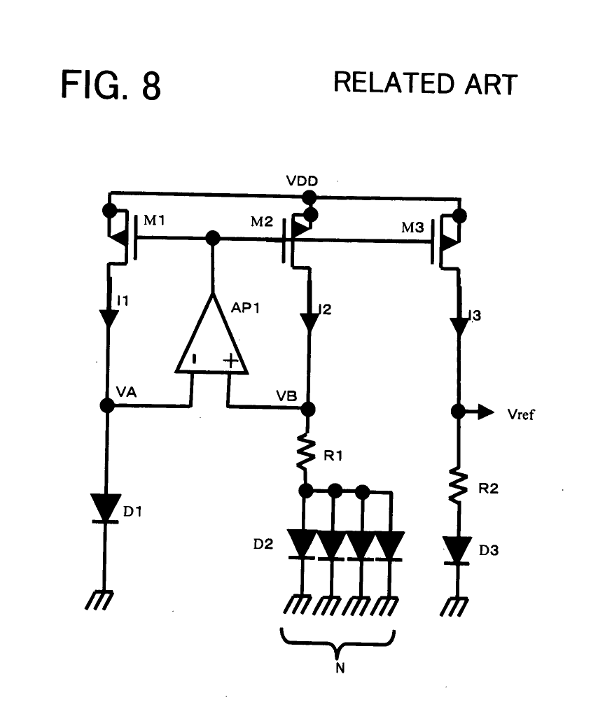

FIG. 9 is a diagram showing an illustrative circuit devised in the course of development of a low-voltage conventional circuit.

FIG. 10 is a diagram showing a conventional circuit in which a low input voltage is used.

FIG. 11 is a diagram showing a modification of a low-voltage conventional circuit.

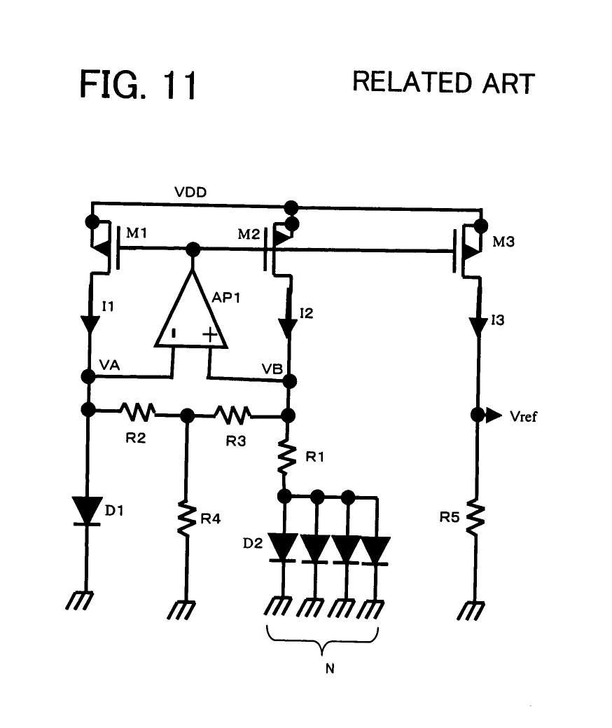

FIG. 12 is a diagram showing an illustrative conventional circuit (1) in which an output circuit is configured to achieve a low input voltage.

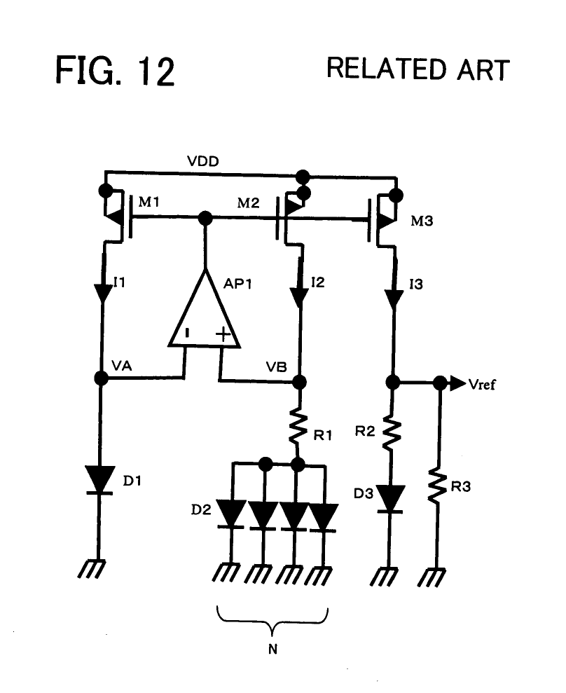

FIG. 13 is a diagram showing an illustrative conventional circuit (2) in which an output circuit is configured to achieve a low input voltage.

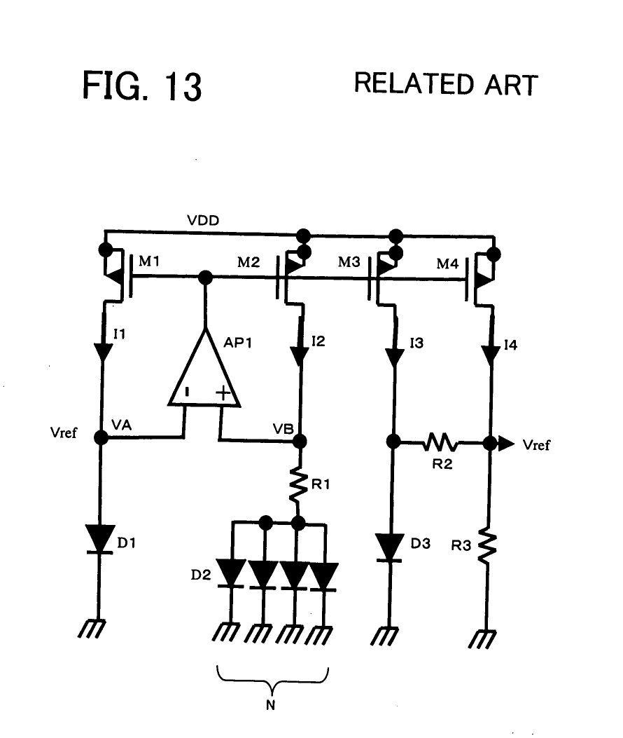

FIG. 14 is a diagram showing a modification of the illustrative conventional circuit (2) in which an output circuit is configured to achieve a low input voltage.

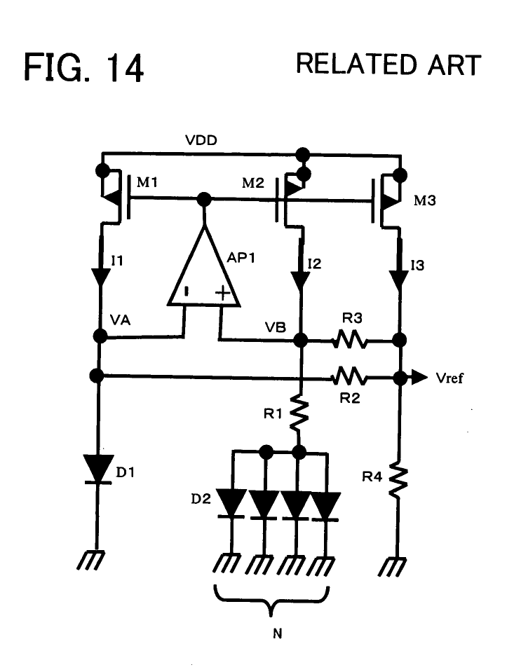

FIG. 15 is a diagram showing a modification of the illustrative conventional circuit (3) in which an output circuit is configured to achieve a low input voltage.

FIG. 16 is a diagram showing another illustrative conventional circuit in which temperature characteristic is increased to achieve a low input voltage.

FIG. 17 is a diagram showing an illustrative conventional circuit (1) with improved temperature non-linearity of a diode.

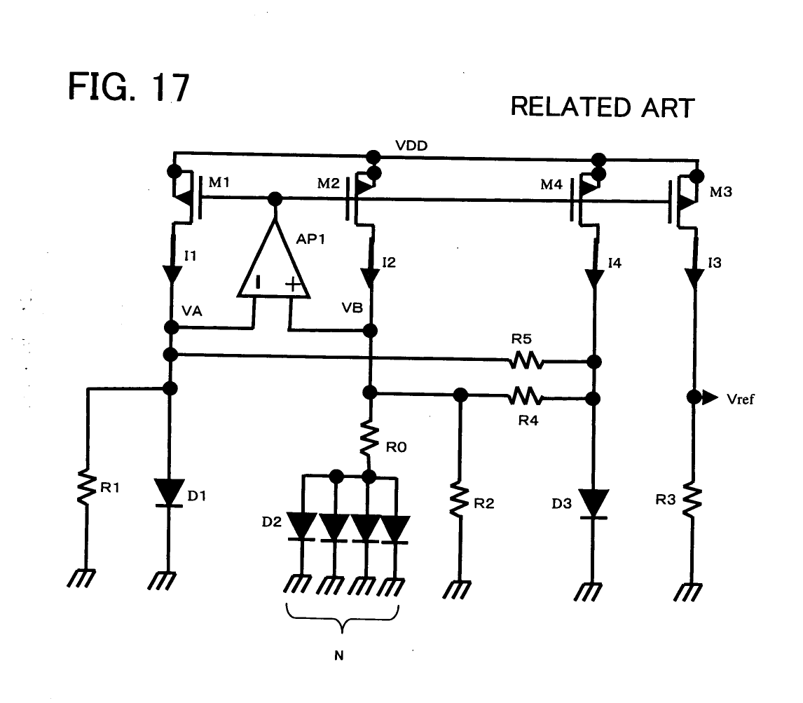

FIG. 18 is a diagram showing an illustrative conventional circuit with apparent temperature non-linearity of a diode.

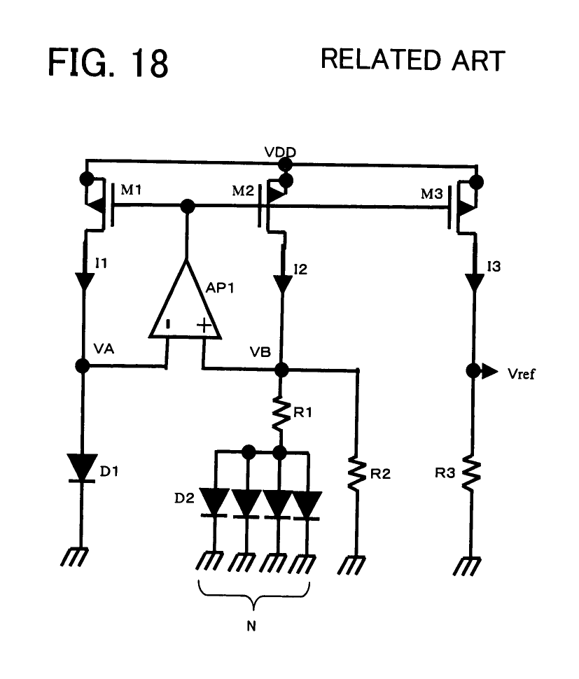

FIG. 19 is a diagram showing an illustrative conventional circuit (2) with compensated temperature non-linearity of a diode.

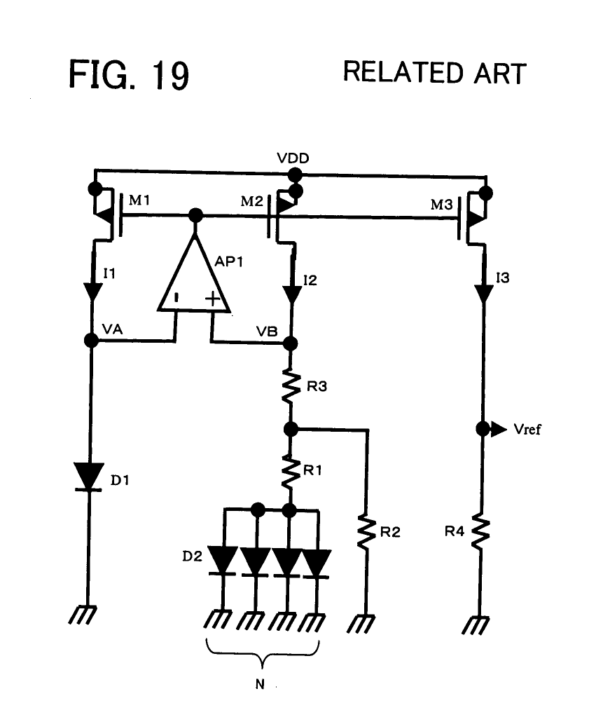

FIG. 20 is a diagram showing an illustrative conventional circuit (3) with compensated temperature non-linearity of a diode.

FIG. 21 is a diagram showing a circuit configuration of an embodiment of the present invention (claim 1).

FIG. 22 is a diagram showing a circuit configuration of an embodiment of the present invention (claim 2).

FIG. 23 is a diagram showing a circuit configuration of an embodiment of the present invention (claim 3).

FIG. 24 is a diagram showing a circuit configuration of an embodiment of the present invention (claim 4).

FIG. 25 is a diagram showing a circuit configuration of a first embodiment of the present invention (claim 5).

FIG. 26 is a diagram showing a circuit configuration of a second embodiment of the present invention (claim 5).

FIG. 27 is a diagram showing a circuit configuration of an embodiment of the present invention (claim 6).

FIG. 28 is a diagram showing a circuit configuration of an embodiment of the present invention (claim 7).

FIG. 29 is a diagram showing a circuit configuration of an embodiment of the present invention (claim 8).

FIG. 30 is a diagram showing a circuit configuration of an embodiment of the present invention (claim 9).

FIG. 31 is a diagram showing a circuit configuration of an embodiment of the present invention (claim 10).

FIG. 32 is a diagram showing a circuit configuration of an embodiment of the present invention (claim 11).

FIG. 33 is a diagram showing a circuit configuration of an embodiment of the present invention (claim 12).

FIG. 34 is a diagram showing a circuit configuration of an embodiment of the present invention (claim 13).

FIG. 35 is a diagram showing a circuit configuration of an embodiment of the present invention (claim 14).

FIG. 36 is a diagram showing a circuit configuration of an embodiment of the present invention (claim 15).

FIG. 37 is a diagram showing a circuit configuration of an embodiment of the present invention (claim 16).

FIG. 38 is a diagram showing a circuit configuration of a first embodiment of the present invention (claim 17).

FIG. 39 is a diagram showing a circuit configuration of a second embodiment of the present invention (claim 17).

FIG. 40 is a diagram showing a circuit configuration of an embodiment of the present invention (claim 18).

FIG. 41 is a diagram for illustrating the operation of the embodiment of the present invention (claim 18).

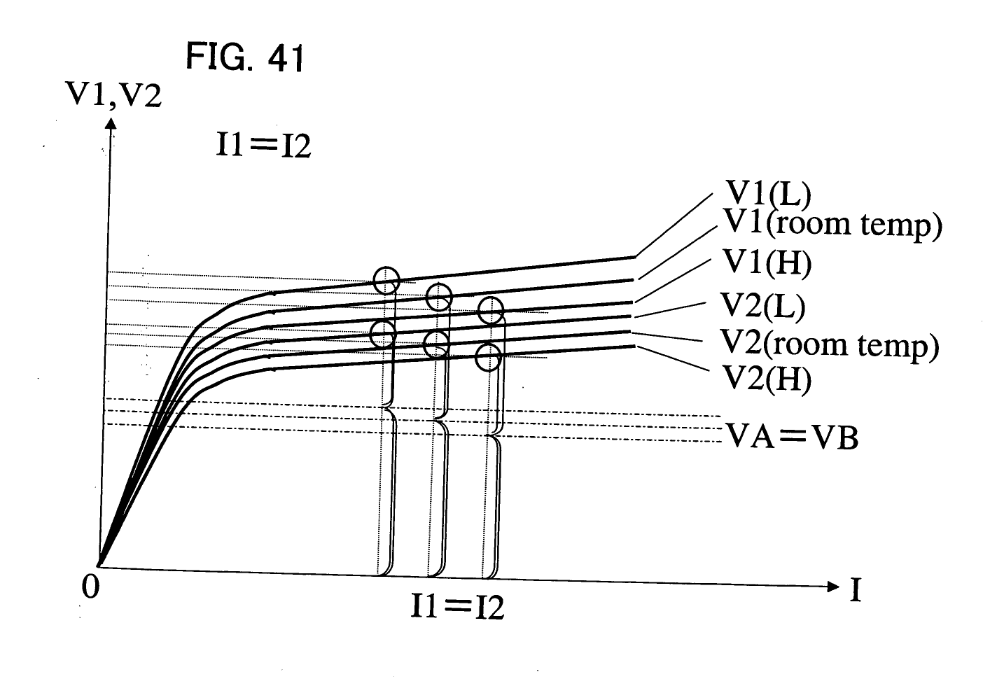

FIG. 42 is a diagram showing a circuit configuration of a first embodiment of the present invention (claim 19).

FIG. 43 is a diagram showing a circuit configuration of a second embodiment of the present invention (claim 19).

FIG. 44 is a diagram showing a circuit configuration of a first embodiment of the present invention (claim 20).

FIG. 45 is a diagram showing a circuit configuration of a second embodiment of the present invention (claim 20).

FIG. 46 is a diagram showing a circuit configuration of an embodiment of the present invention.

FIG. 47 is a diagram showing a circuit configuration of an embodiment of the present invention.

FIG. 48 is a diagram showing a circuit configuration of an embodiment of the present invention.

FIGS. 49A and 49B are diagrams showing a list of the widths of temperature variations of the conventional and inventive circuits.

FIG. 50 is a diagram showing the circuit configuration of another first embodiment of the present invention (claim 1).

FIG. 51 is a diagram showing the circuit configuration of another second embodiment of the present invention (claim 1).

FIG. 52 is a diagram showing the circuit configuration of another second embodiment of the present invention (claim 1).

FIG. 53 is a diagram showing the circuit configuration of another first embodiment of the present invention (claim 7).

FIG. 54 is a diagram showing the circuit configuration of another second embodiment of the present invention (claim 7).

FIG. 55 is a diagram showing the circuit configuration of another third embodiment of the present invention (claim 7).

FIG. 56 is a diagram showing the circuit configuration of another first embodiment of the present invention (claim 9).

FIG. 57 is a diagram showing the circuit configuration of another second embodiment of the present invention (claim 9).

FIG. 58 is a diagram showing the circuit configuration of another third embodiment of the present invention (claim 9).

FIG. 59 is a diagram showing the circuit configuration of another first embodiment of the present invention (claim 10).

FIG. 60 is a diagram showing the circuit configuration of another second embodiment of the present invention (claim 10).

FIG. 61 is a diagram showing the circuit configuration of another third embodiment of the present invention (claim 10).

FIG. 62 is a diagram showing the circuit configuration of another first embodiment of the present invention (claim 11).

FIG. 63 is a diagram showing the circuit configuration of another second embodiment of the present invention (claim 11).

FIG. 64 is a diagram showing the circuit configuration of another third embodiment of the present invention (claim 11).

FIG. 65 is a diagram showing the circuit configuration of another first embodiment of the present invention (claim 13).

FIG. 66 is a diagram showing the circuit configuration of another second embodiment of the present invention (claim 13).

FIG. 67 is a diagram showing the circuit configuration of another third embodiment of the present invention (claim 13).

FIG. 68 is a diagram showing the circuit configuration of another first embodiment of the present invention (claim 14).

FIG. 69 is a diagram showing the circuit configuration of another second embodiment of the present invention (claim 14).

FIG. 70 is a diagram showing the circuit configuration of another third embodiment of the present invention (claim 14).

FIG. 71 is a diagram showing the circuit configuration of another first embodiment of the present invention (claim 15).

FIG. 72 is a diagram showing the circuit configuration of another second embodiment of the present invention (claim 15).

FIG. 73 is a diagram showing the circuit configuration of another third embodiment of the present invention (claim 15).

FIG. 74 is a diagram showing the circuit configuration of another first embodiment of the present invention (claim 17).

FIG. 75 is a diagram showing the circuit configuration of another first embodiment of the present invention (claim 17).

FIG. 76 is a diagram showing the circuit configuration of another second embodiment of the present invention (claim 17).

FIG. 77 is a diagram showing the circuit configuration of an embodiment of the present invention (claim 21).

FIG. 78 is a diagram showing the circuit configuration of another embodiment of the present invention.

### PREFERRED MODES OF THE INVENTION

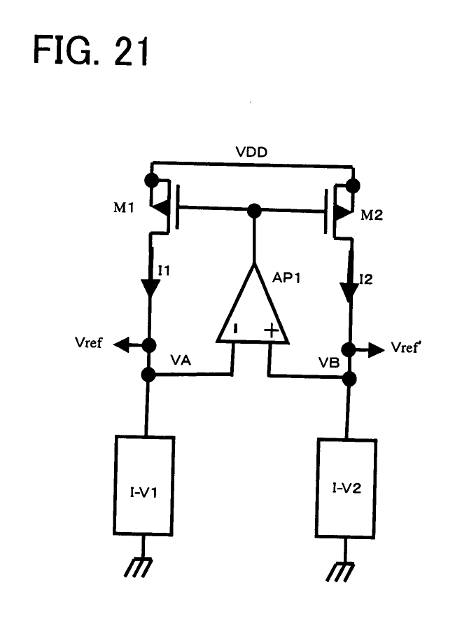

Certain preferred embodiments of the present invention will now be described with reference to the drawings. FIG. 21 is a diagram showing a circuit configuration of a CMOS reference voltage generating circuit of the present invention (claim 1).

Referring to FIG. 21, a current I1 is caused to flow into a first current-to-voltage converter circuit (I-V1) to generate a terminal voltage VA which then is output as a reference voltage Vref. A current I2 is caused to flow into a second current-to-voltage converter circuit (I-V2) to generate a terminal voltage VB which then is output as a reference voltage Vref′.

The currents I1 and I2 are supplied from a current mirror circuit. This current mirror circuit is made up of MOS transistors M1, M2. The currents I1 and I2 are supplied from the MOS transistors M1 and M2, respectively. The common gates of the MOS transistors M1, M2 of the current mirror circuit are controlled by the output voltage of the OP amp (AP1).

The OP amp (AP1) has its inverting input terminal (−) connected to the first current-to-voltage converter circuit (I-V1), while having its non-inverting input terminal (+) connected to the second current-to-voltage conversion circuit (I-V2).

This OP amp (AP1) controls a terminal voltage VA of the first current-to-voltage converter circuit (I-V1) so that the terminal voltage VA will be equal to a terminal voltage VB of the second current-to-voltage conversion circuit (I-V2).

These terminal voltages VA and VB are equal to the reference voltages Vref and Vref′, respectively. Hence, the reference voltages Vref and Vref′ are taken into a control loop so that new output circuits are unneeded.

Moreover, the reference voltages Vref and Vref′ have temperature characteristic cancelled and hence the reference voltages are constant voltages despite variations in the power supply voltage VDD. Consequently, the inverting and non-inverting input terminals of the OP amp (AP1) become constant for all time, and hence the operating point is fixed.

However, in case the first current-to-voltage converter circuit (I-V1) and the second current-to-voltage conversion circuit (I-V2) are of the identical circuit configuration, numerous operating points are produced to render the operating point indefinite. It is therefore desirable to align the circuit topologies of the first current-to-voltage converter circuit (I-V1) and the second current-to-voltage conversion circuit (I-V2) so that the circuits will be varied in characteristics in the same manner against device-based variations.

Here, a startup circuit is dispensed with for simplicity. In the following description of the operation or the embodiments, the description of the startup circuit is similarly dispensed with.

### Embodiment 1

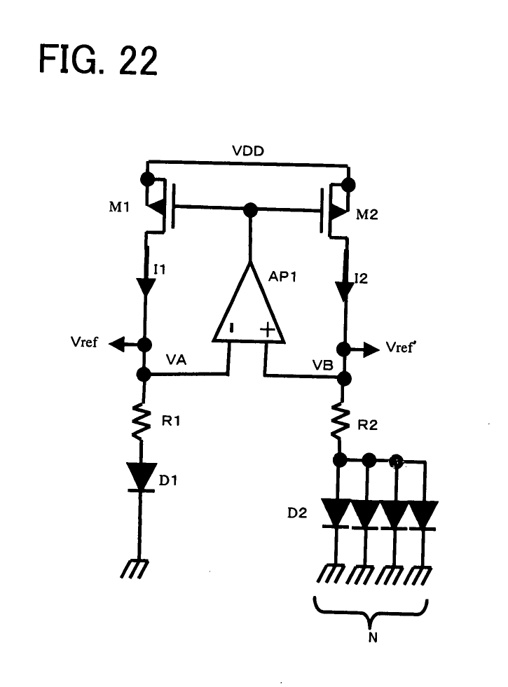

FIG. 22 is a diagram showing the circuit configuration of an embodiment of a CMOS reference voltage generating circuit of the present invention (claim 2).

In FIG. 22, MOS transistors M1 and M2 constitute a current mirror circuit. The common gate voltages of the MOS transistors are controlled by the OP amp (API) so that the voltages at two input terminals (+) and (−) of the OP amp (AP1) will be equal to each other, whereby currents I1 and I2 flowing in the current mirror circuit are determined.

It should be noted that the first current-to-voltage converter circuit (I-V1), made up of a resistor R1 and a diode D1, and the second current-to-voltage conversion circuit (I-V2), made up of a resistor R2 and a plural number of diodes D2, are each a series connection of the resistor and one or more diodes or bipolar transistors connected as diodes.

Hence, the circuit topologies of the first current-to-voltage converter circuit and the second current-to-voltage conversion circuit are the same.

With the use of the unified circuit topologies of the first and second current-to-voltage converter circuit, the circuit operation of the two circuits may be the same. Even if process variations are produced, the variations may be expected to occur in the same manner for the two devices, such that output voltage characteristics may be expected to become small against manufacture tolerances.

However, in case the first current-to-voltage converter circuit and the second current-to-voltage conversion circuit are of the identical circuit configuration, numerous operating points are produced to render the operating point indefinite. For this reason, the number of the diodes of the first current-to-voltage converter circuit is made to differ from that of the diodes of the second current-to-voltage conversion circuit.

The ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four diodes D2 are parallel-connected for the second current-to-voltage conversion circuit. The four parallel-connected diodes D2 have common anodes connected via resistor R2 to the non-inverting input terminal (+) of the OP amp (AP1).

With the forward voltages VF1 and VF2 of the diodes (or bipolar transistors connected as diodes) D1 and D2, in FIG. 22, the OP amp (AP1) exercises control so that two input terminal voltages will be equal to each other (VA=VB).

If the output currents I1 and I2 from the current mirror circuit are equal to each other, then

$$\begin{matrix}{I}_{1} = {I}_{2} & ( 42 ) \\ Hence , & \\ V A = R 1 I 1 + V F 1 & ( 43 ) \\ and & \\ \begin{matrix}V B = R 2 I 2 + V F 2 \\ = R 211 + V F 2 \\ = V A\end{matrix} & ( 44 )\end{matrix}$$

Hence,

ΔVF=VF1−VF2=(R2−R1)I1=ΔRI1=V_{T}ln(N) (45)

where R2>R1 (ΔR>0).

By substitution into the equations (43) and (44), we have

$$\begin{matrix}{V}_{A} = {V}_{F 1} + \frac{R 2}{Δ R} Δ {V}_{F} = {V}_{ref} & ( 46 ) \\ and & \\ {V}_{B} = {V}_{F 2} + \frac{{R}_{2}}{Δ R} Δ {V}_{F} = {V}_{ref}^{′} & ( 47 )\end{matrix}$$

It should be noted that {VF1+(R1/ΔR)V_{T}ln(N)} is a voltage value of the order of 1.2V having temperature characteristic cancelled. Specifically, VF1 has a negative temperature characteristic of approximately −1.9 mV/° C., while V_{T} has a positive temperature characteristic of 0.0853 mV/° C. Thus, for canceling out temperature characteristic, the value of (R1/ΔR)ln(N) is 22.27. On the other hand, since V_{T} is 26 mV at ambient temperature, (R1/ΔR)V_{T}ln(N) is approximately 579 mV at am V_{T}ln(N)} is approximately 1.205V.

In similar manner, {VF2+(R2/ΔR)V_{T}ln(N)} is also a voltage value of the order of 1.205V having temperature characteristic cancelled. Specifically, VF2 has a negative temperature characteristic of approximately −1.9 mV/° C., whereas V_{T} has a positive temperature characteristic of 0.0853 mV/° C.

Thus, for canceling out the temperature characteristic, the value of (R1/ΔR)ln(N) is greater by 1 than 22.27, that is, 23.37. On the other hand, since V_{T} is 26 mV at ambient temperature, (R2/ΔR)V_{T}ln(N) is approximately 600 mV at ambient temperature. Thus, if VF2 is 600 mV at ambient temperature, {VF2+(R2/ΔR)V_{T}ln(N)} is approximately 1.205V.

Simulated values, obtained by the present inventor, are shown below. If, with VDD=1.8V, N, R1 and R2 are set so that N=4, R1=16.3 kΩ and R2=17.0305 kΩ, the values of Vref are:

1.33307V at −53° C.,

1.33837V at 27° C. and

1.3322V at 107° C.

so that upside-down cup shaped characteristic has been obtained. The width of the temperature variations is 0.47%.

### Embodiment 2

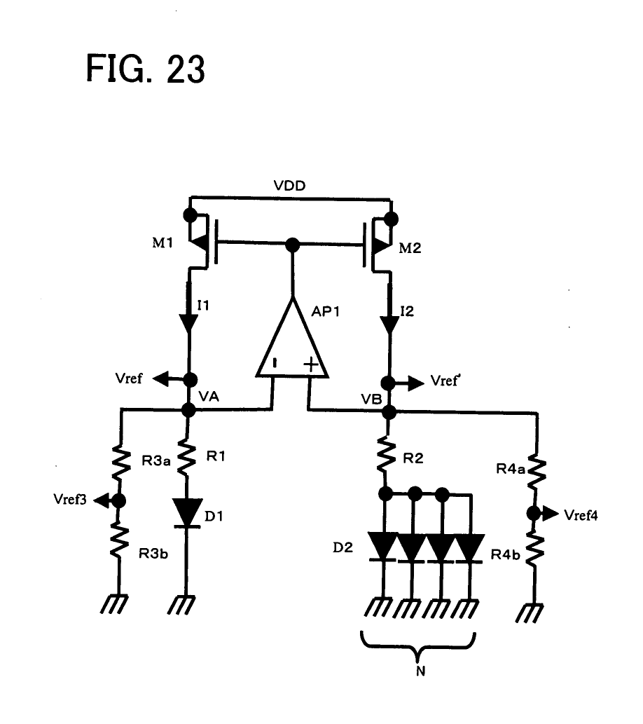

FIG. 23 is a diagram showing the circuit configuration of an embodiment of a CMOS reference voltage generating circuit of the present invention (claim 3). There is shown an easy-to-understand method for generating a reference voltage lower than 1.205V in the invention of the present application in which a controlled voltage is to be a reference voltage.

In FIG. 23, MOS transistors M1, M2 constitute a current mirror circuit. The common gate voltage of the MOS transistors is controlled to provide for two equal input terminal voltages of the OP amp (AP1), whereby the currents I1 and I2 flowing through the current mirror circuit (M1, M2) are determined.

The first current-to-voltage converter circuit (I-V1) and the second current-to-voltage conversion circuit (I-V2), as the objects of comparison, are each made up of series connection of a resistor and a diode (or a bipolar transistor connected as diode), and a resistor connected in parallel with the series connection.

Hence, the first current-to-voltage converter circuit (I-V1) and the second current-to-voltage conversion circuit (I-V2) are of the same circuit topology.

With the use of the unified circuit topologies of the first and second current-to-voltage converter circuits (I-V converter circuits), the circuit operation of the two circuits may be the same. Even if process variations are produced, the variations may be expected to occur in the same manner for the two devices, such that output voltage characteristics may be expected to become small against manufacture tolerances.

However, in case the first current-to-voltage converter circuit and the second current-to-voltage conversion circuit are of the identical circuit configuration, numerous operating points are produced to render the operating point indefinite. For this reason, the resistance values of the two parallel-connected resistors are set so as to be equal to each other, but the number of the diodes of the first current-to-voltage converter circuit is made to differ from that of the diodes of the second current-to-voltage conversion circuit.

The ratio of the numbers of the parallel-connected diodes (or bipolar transistors connected as diodes) of the first and second current-to-voltage converter circuits, as the objects for comparison, is set to 1:N.

Specifically, a sole diode D1 is used for the first current-to-voltage converter circuit, while two to four diodes D2 are parallel-connected for the second current-to-voltage conversion circuit.

With the forward voltages VF1 and VF2 of the diodes (or bipolar transistors connected as diodes) D1 and D2, in FIG. 23, the OP amp (AP1) exercises control so that two input terminal voltages will be equal to each other (VA=VB).

If the output currents I1 and I2 from the current mirror circuit are equal to each other, then

I₁=I₂ (48)

The current I1 is divided into a current I1A flowing through the diode D1 and a current I1B flowing through series-connected (R3a+R3b).

In similar manner, the current I2 is divided into a current I2A flowing common through a resistor R2 and N parallel-connected diodes D2 and a current I2B flowing through series-connected resistors (R4a+R4b).

Hence,

I1=I1A+I1B (49)

I2=I2A+I2B (50)

It is now assumed that the resistance value of the resistors (R3a, R3b), connected in parallel with the diode D1, is equal to that of the resistors (R4a, R4b), connected in parallel with the diode D2. Then,

R3a+R3b=R4a+R4b (51)

Thus, if the voltages VA and VB are controlled to be equal to each other, the currents flowing through the series-connected resistors (R3a+R3b) and (R4a+R4b) are equal to each other, so that

I1B=I2B (52)

From the equation (45),

$$\begin{matrix}I 1 A = I 2 A & ( 53 ) \\ Hence , & \\ V A = R 1 I 1 A + V F 1 & ( 54 ) \\ \begin{matrix}V B = R 2 I 1 A + V F 2 \\ = R 2 I 1 A + V F 2 \\ = V A\end{matrix} & ( 55 ) \\ Hence , & \\ \begin{matrix}Δ {V}_{F} = V F 1 - V F 2 \\ = ( R 2 - R 1 ) I 1 A \\ = Δ R I 1 A = {V}_{T} ln ( N )\end{matrix} & ( 56 ) \\ where R 2 > R 1 ( Δ R > 0 ) . & \end{matrix}$$

Substitution into the equations (54), (44) gives

$$\begin{matrix}{V}_{A} = {V}_{F 1} + \frac{{R}_{2}}{Δ R} Δ {V}_{F} = {V}_{ref} & ( 57 ) \\ {V}_{B} = {V}_{F 2} + \frac{{R}_{2}}{Δ R} Δ {V}_{F} = {V}_{ref}^{′} & ( 58 )\end{matrix}$$

{VF1+(R1/ΔR)V_{T}ln(N)} is a voltage value of the order of 1.2V from which temperature characteristic have been cancelled. Specifically, VF1 has a negative temperature characteristic of approximately −1.9 mV/° C., whereas V_{T} has a positive temperature characteristic of approximately 0.0853 mV/° C.

Hence, in order for the temperature characteristic to be cancelled, the value of (R1/ΔR)ln(N) is 22.27. Since V_{T} is 26 mV at ambient temperature, the value of (R1/ΔR)V_{T}ln(N) is about 579 mV at ambient temperature. Thus, with VF1 at ambient temperature of 626 mV, {VF1+(R1/ΔR)V_{T}ln(N)} is approximately 1.205 mV.

Similarly, {VF2+(R2/ΔR)V_{T}ln(N)} is a voltage value of the order of 1.2V from which temperature characteristic have been cancelled. Specifically, VF2 has a negative temperature characteristic of approximately −1.9 mV/° C., whereas V_{T} has a positive temperature characteristic of approximately 0.0853 mV/° C. Hence, in order for the temperature characteristic to be cancelled, the value of (R2/ΔR)ln(N) is greater by 1 than 22.27, or 23.27. Since V_{T} is 26 mV at ambient temperature, the value of (R2/ΔR)V_{T}ln(N) is about 605 mV at ambient temperature. Thus, with VF2 at ambient temperature of 600 mV, {VF2+(R2/ΔR)V_{T}ln(N)} is approximately 1.205 mV.

Further, by voltage division by resistors R3a and R3b, we have:

$${V}_{ref 3} = \frac{{R}_{3 b}}{{R}_{3 b} + {R}_{3 b}} {V}_{ref} \qquad ( 59 )$$

By further voltage division by resistors R4a and R4b,

$${V}_{ref 3} = \frac{{R}_{3 b}}{{R}_{3 b} + {R}_{3 b}} {V}_{ref} \qquad ( 60 )$$

The reference voltage Vref3, Vref4, thus obtained, are constant voltages not higher than 1.2V, from which temperature characteristic have been cancelled (compensated). Hence, these may be used as the reference voltages.

If series resistors (R3a+R3b) and (R4a+R4b) are connected in parallel with the reference voltage generating circuit shown in FIG. 22, the reference voltage generated is not changed as long as the sum of the resistance values remains equal.

### Embodiment 3

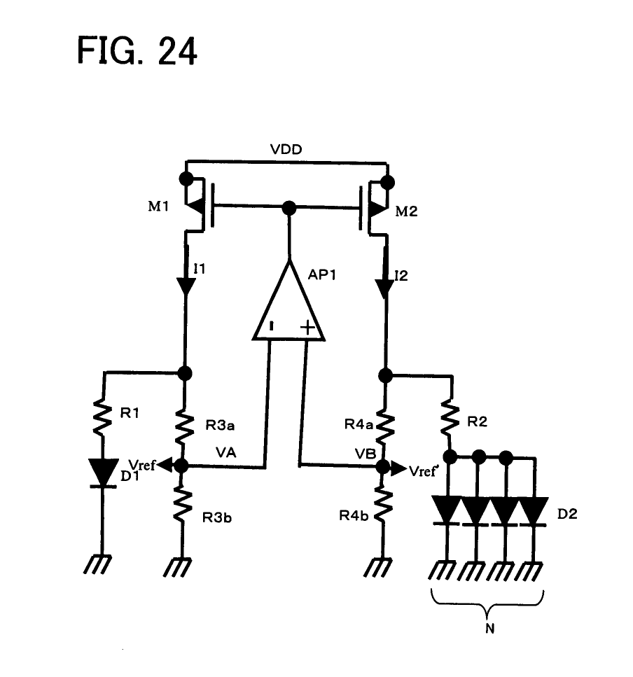

FIG. 24 is a diagram showing the circuit configuration of an embodiment of a CMOS reference voltage generating circuit of the present invention (claim 4). In FIG. 24, MOS transistors M1, M2 constitute a current mirror circuit. The common gate voltages of the MOS transistors are controlled by the OP amp (AP1) so that the voltages at two input terminals of the OP amp (AP1) will be equal to each other, whereby currents I1 and I2 flowing in the current mirror circuit are determined. It should be noted that the first current-to-voltage converter circuit and the second current-to-voltage conversion circuit, as the objects for comparison, are each a series connection of a resistor and a diodes or bipolar transistor connected as diode. In addition, two resistors are connected in parallel with the series connection of the resistors and the diodes, with an intermediate voltage of the two resistors being a controlled voltage.

Hence, the circuit topologies of the first current-to-voltage converter circuit (I-V1) and the second current-to-voltage conversion circuit (I-V2) are the same.

With the use of the unified circuit topologies of the first and second current-to-voltage converter circuits (I-V converter circuits), the circuit operation of the two circuits may be the same. Even if process variations are produced, such variations may be expected to occur in the same manner for the two devices, such that output voltage characteristics may be expected to become small against manufacture tolerances.

However, in case the first current-to-voltage converter circuit and the second current-to-voltage conversion circuit are of the identical circuit configuration, numerous operating points are produced to render the operating point indefinite. For this reason, the number of the diodes of the first current-to-voltage converter circuit is made to differ from that of the diodes of the second current-to-voltage conversion circuit, even though the two parallel-connected resistors are of the same value and the voltage-dividing ratio is selected to be equal to provide for the equal mid-point voltages. The ratio of the numbers of the parallel-connected diodes (or bipolar transistors connected as diodes) of the first and second current-to-voltage converter circuits, as the objects for comparison, is set to 1:N. Specifically, a sole diode D1 is used for the first current-to-voltage converter circuit, while two to four diodes D2 are parallel-connected for the second current-to-voltage conversion circuit.

The operation of the present embodiment is now described. With the forward voltages VF1, VF2 of the diodes (or bipolar transistors connected as diodes) D1, D2, in FIG. 24, the OP amp (AP1) exercises control so that two input terminal voltages will be equal to each other (VA=VB).

If the output currents from the current mirror circuit are equal to each other, then

I₁=I₂ (61)

The current I1 is divided into a current I1A flowing through the diode D1 and a current I1B flowing through series-connected resistors (R3a+R3b).

In similar manner, the current I2 is divided into a current I2A flowing common through resistor R1 and N parallel-connected diodes D2 and a current I2B flowing through series-connected resistors (R4a+R4b).

Hence,

I1=I1A+I1B (62)

I2=I2A+I2B (63)

It is now assumed that the resistance value of the resistors (R3a, R3b), connected in parallel with the diode D1, is equal to that of the resistors (R4a, R4b), connected in parallel with the diode D2. Then,

R3a+R3b=R4a+R4b (64)

If the voltage dividing ratio is equal,

R3a=R4a (65)

and

R3b=R4b (66)

Hence, if the voltages VA and VB are controlled to be equal to each other, the currents flowing through the series-connected resistors (R3a+R3b) and (R4a+R4b) are equal to each other, so that

I1B=I2B (67)

From the equation (61),

I1A=I2A (68)

Hence, the drain voltage VD1 of the MOS transistor M1 is given by

VD1=R1I1A+VF1 (69)

The drain voltage VD2 of the MOS transistor M2 is given by

$$\begin{matrix}\begin{matrix}V D 2 = R 2 I 2 A + V F 2 \\ = R 2 I 1 A + V F 2 \\ = V D 1\end{matrix} & ( 70 ) \\ Hence , & \\ \begin{matrix}Δ {V}_{F} = V F 1 - V F 2 \\ = ( R 2 - R 1 ) I 1 A \\ = Δ R I 1 A = {V}_{T} ln ( N )\end{matrix} & ( 71 ) \\ where R 2 > R 1 ( Δ R > 0 ) . & \\ Hence , & \\ {V}_{A} = \frac{{R}_{3 B}}{{R}_{3 a} + {R}_{3 B}} ( {V}_{F 1} + \frac{{R}_{2}}{Δ R} Δ {V}_{F} ) = {V}_{ref} & ( 72 ) \\ {V}_{B} = \frac{{R}_{4 b}}{{R}_{4 a} + {R}_{4 b}} ( {V}_{F 2} + \frac{{R}_{2}}{Δ R} Δ {V}_{F} ) = {V}_{ref}^{′} & ( 73 )\end{matrix}$$

{VF1+(R1/ΔR)V_{T}ln(N)} is a voltage value of the order of 1.2V from which temperature characteristic have been cancelled. Specifically, VF1 has a negative temperature characteristic of approximately −1.9 mV/° C., whereas V_{T} has a positive temperature characteristic of approximately 0.0853 mV/° C. Hence, in order for the temperature characteristic to be cancelled, the value of (R1/ΔR)ln(N) is approximately 22.27 at ambient temperature. On the other hand, since V_{T} is 26 mV at ambient temperature, (R1/ΔR)V_{T}ln(N) is approximately 579 mV at ambient temperature.

Consequently, with VF1 of 626 mV at ambient temperature, {VF1+(R1/ΔR)}V_{T}ln(N) is approximately 1.205 mV, which is further divided by the resistors R3a and R3b to yield a voltage equal to 1.205 mV times R3b/(R3a+R3b) (<1), or a low reference voltage Vref.

In similar manner, {VF2+(R2/ΔR)V_{T}ln(N)} is a voltage value of the order of 1.2V from which temperature characteristic have been cancelled. Specifically, VF2 has a negative temperature characteristic of approximately −1.9 mV/° C., whereas V_{T} has a positive temperature characteristic of approximately 0.0853 mV/° C. Hence, in order for the temperature characteristic to be cancelled, the value of (R2/ΔR)ln(N) is a value greater than 22.27 by 1, that is, 23.27. On the other hand, since V_{T} is 26 mV at ambient temperature, (R2/ΔR)V_{T}ln(N) is approximately 605 mV at ambient temperature.

Consequently, with VF2 of 600 mV at ambient temperature, {VF2+(R2/ΔR)V_{T}ln(N)} is approximately 1.205 mV, which is further divided by the resistors R4a and R4b to yield a voltage equal to 1.205 mV times R4b/(R4a+R4b) (<1), or a low reference voltage Vref.

If series resistors (R3a+R3b) and (R4a+R4b) are connected in parallel with the reference voltage generating circuit shown in FIG. 22, the reference voltage generated is not changed as long as the sum of the resistance values remains equal.

### Embodiment 4

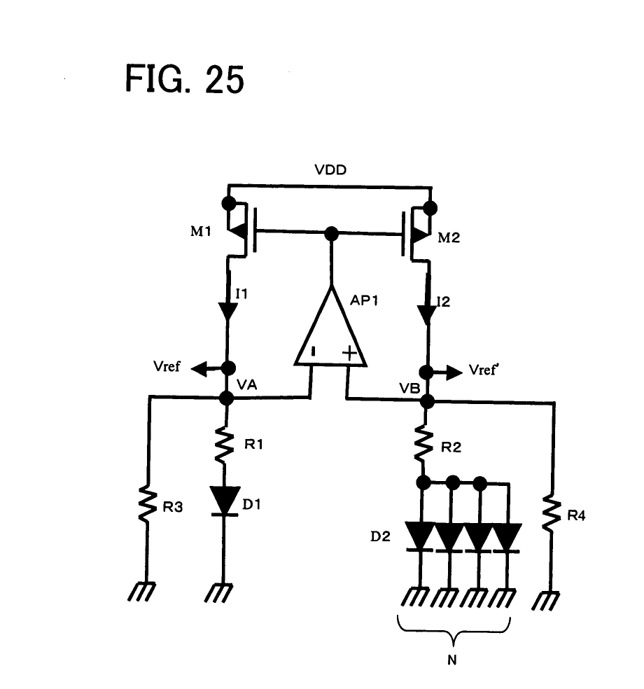

FIG. 25 is a diagram showing a circuit configuration of an embodiment of a CMOS reference voltage generating circuit of the present invention (claim 5). The circuit topology appears to be the same as that of FIG. 23. However, in the present embodiment, the resistors R3 and R4, connected in parallel with each other, are made to differ from each other to provide for the reference voltage Vref (Vref′) lower than 1.205V.

In FIG. 25, the MOS transistors M1 and M2 constitute a current mirror circuit. The common gate voltages of the MOS transistors are controlled by the OP amp (AP1) so that the voltages at two input terminals of the OP amp (AP1) will be equal to each other, whereby currents I1 and I2 flowing in the current mirror circuit are determined.

It should be noted that the first current-to-voltage converter circuit and the second current-to-voltage conversion circuit, as the objects for comparison, are each a series connection of the resistor and one or more diodes or bipolar transistors connected as diodes. In addition, two resistors R3 and R4 are connected in parallel with the series connection of the resistors and the diodes.

Hence, the circuit topologies of the first current-to-voltage converter circuit (I-V1) and the second current-to-voltage conversion circuit (I-V2) are the same. With the use of the unified circuit topologies of the first and second current-to-voltage converter circuits, the circuit operation of the two circuits may be the same. Even if process variations are produced, such variations may be expected to occur in the same manner for the two devices, such that output voltage characteristics may be expected to become small against manufacture tolerances. However, in case the first current-to-voltage converter circuit and the second current-to-voltage conversion circuit are of the identical circuit configuration, numerous operating points are produced to render the operating point indefinite. For this reason, the number of the diodes of the first current-to-voltage converter circuit is made to differ from that of the diodes of the second current-to-voltage conversion circuit, even though the resistance values of the two parallel-connected resistors R3 and R4 are selected to be equal to each other.

The ratio of the numbers of the parallel-connected diodes (or bipolar transistors connected as diodes) of the first and second current-to-voltage converter circuits, as the objects for comparison, is set to 1:N. Specifically, a sole diode D1 is used for the first current-to-voltage converter circuit, while two to four diodes D2 are parallel-connected for the second current-to-voltage conversion circuit.

The operation of the present embodiment is now described. With the forward voltages VF1, VF2 of the diodes (or bipolar transistors connected as diodes) D1 and D2, in FIG. 25, the OP amp (AP1) exercises control so that two input terminal voltages will be equal to each other (VA=VB). If the output currents from the current mirror circuit are equal to each other, then

I₁=I₂ (74)

The current I1 is divided into a current I1A flowing through the diode D1 and a current I1B flowing through the resistor R3. In similar manner, the current I2 is divided into a current I2A flowing common through series connection of the resistor R2 and N parallel-connected diodes D2 and a current I2B flowing through the resistor R4. In similar manner, the current I2 is divided into a current I2A flowing through the resistor R4.

Hence,

I1=I1A+I1B (75)

I2=I2A+I2B (76)

If the parallel-connected resistors are of different values,

R3≠R4 (77)

Hence, if the voltages VA and VB are controlled to the same voltage value, the currents flowing through the respective resistors R3 and R4 differ from each other, that is,

I1B≠I2B (78)

The following equations hold:

$$\begin{matrix}{I}_{1} = \frac{{V}_{A} - {V}_{F 1}}{{R}_{1}} + \frac{{V}_{A}}{{R}_{3}} & ( 79 ) \\ {I}_{2} = \frac{{V}_{B} - {V}_{F 2}}{{R}_{2}} + \frac{{V}_{B}}{{R}_{4}} & ( 80 )\end{matrix}$$

Thus, the following equations

$$\begin{matrix}{V}_{A} = \frac{{R}_{3}}{{R}_{1} + {R}_{3}} ( {V}_{F 1} + {R}_{1} {I}_{1} ) = {V}_{ref} & ( 81 ) \\ and & \\ {V}_{B} = \frac{{R}_{4}}{{R}_{2} + {R}_{4}} ( {V}_{F 2} + {R}_{2} {I}_{2} ) = {V}_{ref}^{′} & ( 82 ) \\ hold . & \end{matrix}$$

It should be noted that (VF1+R1I1) may be set to a voltage value of the order of 1.2V that has temperature characteristic cancelled. In more detail, if VF1 has a negative temperature characteristic of approximately −1.9 mV/° C., and temperature characteristic of the resistors are discounted, it is sufficient that the current I1 has a positive temperature characteristic and is approximately equal to the current proportional to absolute temperature, or V_{T}ln(N)/ΔR, as conventionally. V_{T}1 has a positive temperature characteristic of 0.0853 mV/° C. Thus, for canceling out temperature characteristic, the value of (R1/ΔR)ln(N) is 22.27. Also, since V_{T} is 26 mV at ambient temperature, (R1/ΔR)V_{T}ln(N) is approximately 579 mV at ambient temperature. Hence, if VF1 is 626 mV at ambient temperature, {VF1+(R1/ΔR)V_{T}ln(N)} is approximately 1.205V.

Similarly, (VF2+R2I2) can be set to a voltage value of the order of 1.2V that has temperature characteristic cancelled. In more detail, if VF2 has a negative temperature characteristic of approximately −1.9 mV/° C., and temperature characteristic of the resistors are discounted, it is sufficient that the current I2 has a positive temperature characteristic and is approximately equal to the PTAT current (current proportional to absolute temperature) V_{T}ln(N)/ΔR, as conventionally. V_{T}1 has a positive temperature characteristic of 0.0853 mV/° C. Thus, for canceling out temperature characteristic, the value of (R2/ΔR)V_{T}ln(N) is larger than 22.27 by 1, that is, 23.27. Since V_{T} is 26 mV at ambient temperature, (R2/ΔR)V_{T}ln(N) is approximately 605 mV at ambient temperature. Hence, if VF2 is 600 mV at ambient temperature, {VF1+(R2/ΔR)V_{T}ln(N)} is approximately 1.205V.

Moreover, since VA=VB, if we set ΔR=R2−R1,

VF1+R1I1=VF1+(R1/ΔR)V_{T}ln(N) (83)

and

VF2+R2I2=VF2+(R2/ΔR)V_{T}ln(N) (84)

are valid, then

$$\frac{{R}_{3}}{{R}_{1} + {R}_{3}} = \frac{{R}_{4}}{{R}_{2} + {R}_{4}} \qquad ( 85 )$$

must be valid.

Solving the equation (64), we have

$${R}_{4} = {R}_{3} ( 1 + \frac{Δ R}{{R}_{1}} ) \qquad ( 86 )$$

That is, if the resistor R2 is set to a value slightly greater than the resistor R1, and the resistor R4 is set to a value slightly greater than the resistor R3, the condition may be expected to be met.

The reference voltages Vref3 and Vref4, thus obtained, are constant voltages, not higher than 1.205 V, as indicated in the equations (81) and (82), and have temperature characteristic cancelled. Hence, these voltages may be used as reference voltages.

Thus, the reference voltage generating circuit, shown in FIG. 25, differs from the reference voltage generating circuit, shown in FIG. 23, only in connecting series-connected resistors (R3a+R3b) (=R3) and (R4a+R4b) (=R4) in parallel and in differentiating the sums of the resistance values thereof (corresponding to R3 and R4). These apparently minor changes cause the operation of the reference voltage generating circuit to be changed to render it possible to produce the low reference voltage.

By the way, the method of causing the current I1 having a positive temperature characteristic, specifically the current IPTAT (current proportional to the absolute temperature), to flow into a current-to-voltage converter circuit, made up of a series connection of a resistor R1 and a diode D1 and a resistor R3, connected in parallel with the series connection, as shown in FIG. 23, to generate a constant voltage not higher than 1.205V having temperature characteristic cancelled, is the above-described method proposed by H. Neuteboom et al. It is noted that their treatise (“A DSP-Based Hearing Instrument IC.” IEEE Journal of Solid-State Circuits, Vol. 32, No. 11 pp. 1790-1806) is a long text of 17 pages, however, the writers are not experts in the technical field, as may be surmised from the title of the treatise. Only one page is devoted to the description of the reference voltage generating circuit.

It is also noted that two subjects of the new technology within their domain of expertise, introduced in the document, are applied for patent and registered, however, no patent application has been filed for the reference voltage generating circuit which was not within their domain of expertise.

Hence, their reference voltage generating circuit was not noticed by the experts of this technical field. Moreover, the numbers of the resistors in the drawing were mistaken for the numbers of the resistors of the equations. Further, the reference voltage values alleged to be obtained could not be obtained even if their design values are substituted into their equations. For this reason, their circuit was discounted for long.

However, their technology was ultimately recognized when the present inventor referenced this treatise as related art for the first time in U.S. Pat. No. 3,638,530 (U.S. Pat. No. 6,528,979 B2) (Mar. 4, 2003). References to the treatise were first made in 2004 in ISCAS'04 Vol. 1, pp. 1-397-400, 23-26 May 2004).

However, the reference voltages Vref and Vref′, obtained in FIG. 25 hereof, are expressed as shown in the equations (81) and (82), with the resistor connected in series with the diode, and the resistor connected in parallel with the series connection. If VF1 or VF2 has departed from a presumed value, it is inherently difficult to set the resistance values of the resistors for which VA=VB.

Simulated values, obtained by the present inventor, are shown below. If, with VDD=1.5V, N and R1 to R6 are set so that N=4, R1=16.5 kΩ, R2=R3=50 kΩ, R4=17.5 kΩ, R5=48 kΩ and R6=50 kΩ, the values of Vref are:

942.2 mV at −53° C.,

946.25 mV at 27° C.

940.37 mV at 103° C.

so that upside-down cup shaped characteristic has been obtained. The width of the temperature variations is suppressed to 0.65%.

### Other Embodiments of the Invention

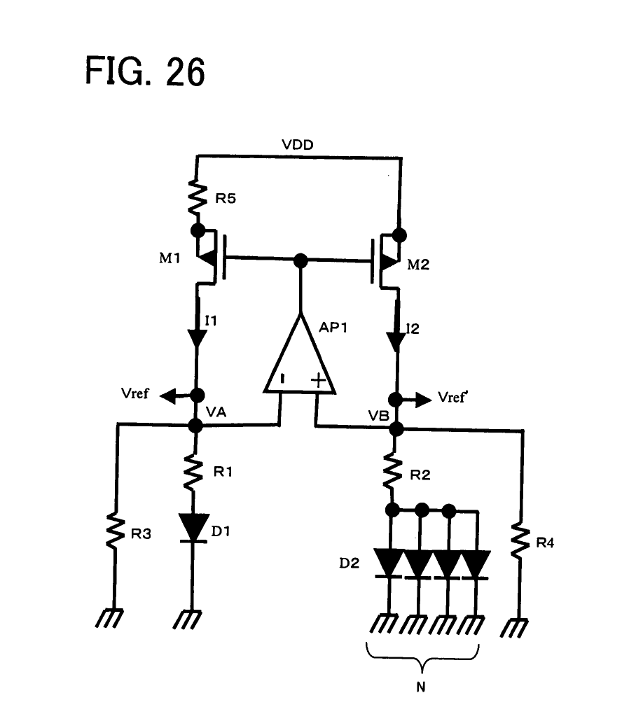

FIG. 26 shows the circuit configuration of a second embodiment of the present invention (claim 5). In FIG. 25, a linear current mirror circuit, specifically a simple current mirror circuit, is used as the current mirror circuit, as conventionally. Moreover, a low reference voltage generating circuit may be implemented by differentiating the values of the resistors R3 and R4 from each other. It may be contemplated that, if troubles such as offset of the OP amp take place, the circuit may fail to be started near a desired operating point in case of occurrence of deviations from the desired operating point.

FIG. 26 depicts a circuit diagram for a reference voltage generating circuit modified in order to take account of such case. Specifically, a linear current mirror circuit is changed to a non-linear current mirror circuit, namely the Widlar current mirror circuit, so that the circuit will be started, even except if I1=I2, to approach to the desired operating point of I1=I2. If I1<I2 due to offset from the operating point of I1=I2, or if conversely I1>I2, the operating point may still exist. The difference between FIGS. 26 and 25 consists in whether the current mirror circuit driving the first current-to-voltage converter circuit and the second current-to-voltage conversion circuit is a non-linear current mirror circuit (it is noted that, in FIG. 26, a resistor 35 is provided between the source of M1 and the power supply) or a linear current mirror circuit.

In a linear current mirror circuit, in which the current ratio of two current paths is fixed, there may be cases where the desired operating point may not be reached in case of the slightest deviation of the value of a constant from a setting value which should yield desired characteristics, or in case of occurrence of offset of the OP amp.

Thus, by changing the current mirror circuit, driving the first and second current-to-voltage converter circuits, to non-linear current mirror circuits, the relationship between the current I1 that drives the first current-to-voltage converter circuit and the current I2 that drives the second current-to-voltage converter circuit may be such that the operating point assume values in the vicinity of the desired operating point of I1=I2, more concretely, the values of I1>I2 or I1<I2. The terminal voltage VA of the first current-to-voltage converter circuit may be controlled to be equal to the terminal voltage VB of the second current-to-voltage converter circuit.

In FIG. 26, the MOS transistors M1, M2, in which a resistor R5 is inserted as source resistance, constitute a non-linear current mirror circuit (Widlar current mirror). The common gate voltages of the MOS transistors are controlled by the OP amp (AP1) so that two input terminal voltages of the OP amp will be equal to each other, thereby determining the currents I1 and I2 flowing in the current mirror circuit.

The first and second current-to-voltage converter circuits, as objects for comparison, are each composed of a series-connection of a resistor and a diode or diodes (or bipolar transistor or transistors, connected as diode) and a resistor connected in parallel with the series connection.

Hence, the circuit topologies of the first current-to-voltage converter circuit (I-V1) and the second current-to-voltage conversion circuit (I-V2) are the same. With the use of the unified circuit topologies of the first and second current-to-voltage converter circuits (I-V converter circuits), the circuit operation of the two circuits may be the same. Even if process variations are produced, such variations may be expected to occur in the same manner for the two devices, such that output voltage characteristics may be expected to become small against manufacture tolerances. However, in case the first current-to-voltage converter circuit and the second current-to-voltage conversion circuit are of the identical circuit configuration, numerous operating points are produced to render the operating point indefinite. Hence, the resistance values of two parallel-connected resistors are selected to be equal to each other, but the number of the diodes of the first current-to-voltage converter circuit is made to differ from that of the diodes of the second current-to-voltage conversion circuit. The ratio of the numbers of the parallel-connected diodes (or bipolar transistors connected as diodes) of the first and second current-to-voltage converter circuits, as the objects for comparison, is set to 1:N. Specifically, a sole diode D1 is used for the first current-to-voltage converter circuit, while two to four diodes D2 are parallel-connected for the second current-to-voltage conversion circuit.

The operation of the present embodiment is now described. With the forward voltages VF1, VF2 of the diodes (or bipolar transistors connected as diodes) D1, D2, in FIG. 25, the OP amp (AP1) exercises control so that two input terminal voltages will be equal to each other (VA=VB).

The output currents of the current mirror circuit are assumed to be I1 and I2. In a linear current mirror circuit, in which the current ratio of two current paths is fixed, there may be cases where the desired operating point may not be reached in case of the slightest deviation of the value of a constant from a setting value of I1=I2 which should yield desired characteristics. However, by changing the current mirror circuit, driving the first and second current-to-voltage converter circuits, to a non-linear current mirror circuit, the relationship between the current I1 that drives the first current-to-voltage converter circuit and the current I2 that drives the second current-to-voltage converter circuit may be such that an operating point will assume a value in the vicinity of the desired operating point of I1=I2, more concretely, the values of I1>I2 or I1<I2. Thus, the terminal voltage VA of the first current-to-voltage converter circuit may be controlled to be equal to the terminal voltage VB of the second current-to-voltage converter circuit.

Thus, there may be achieved a reference voltage equally satisfying the equations (74) to (82) shown in the description of the operation of the embodiment of FIG. 25, in which temperature characteristic for less than 1.205V are cancelled.

Simulated values, obtained by the present inventor, are shown below. If, with VDD=1.5V, N, K1 and R1 to R5 are set so that N=4, K1=2, R1=183 kΩ, R2=19.38 kΩ, R3=36.6 kΩ, R4=41.5 kΩ and R5=1.8 kΩ, the values of Vref are:

876 mV at −53° C.,

899 mV at 27° C.

877 mV at 107° C.

so that upside-down cup shaped characteristic has been obtained. The width of the temperature variations is of a larger value of 2.6%.

### Embodiment 5

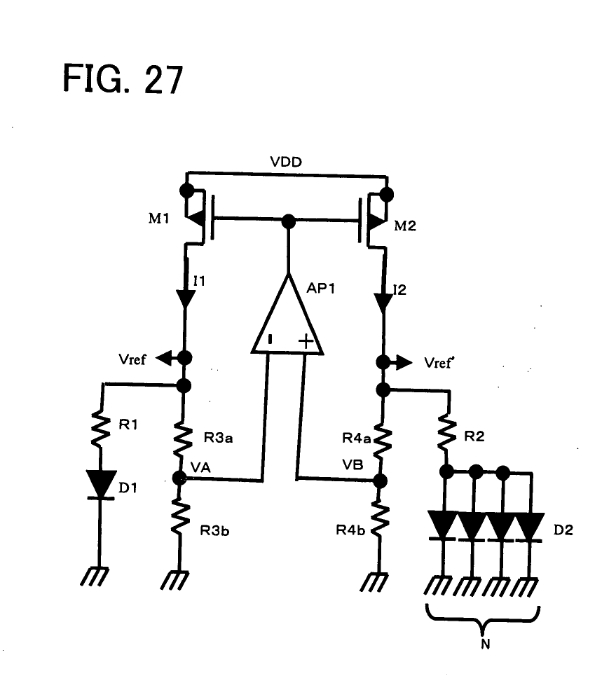

FIG. 27 depicts a diagram showing the circuit configuration of an embodiment of a CMOS reference voltage generating circuit of the present invention (claim 6). To use the above-described output circuit, proposed by H. Neuteboom et al., as the first or second current-to-voltage converter circuit, it may be contemplated to divide each of parallel-connected resistors and to exercise control to provide for two equal resistance-divided voltages.

In FIG. 27, the MOS transistors M1 and M2 constitute a current mirror circuit, the common gate voltages of which are controlled by the OP amp (AP1) so that two input terminal voltages of the OP amp will be equal to each other, thereby determining the currents I1 and I2 flowing in the current mirror circuit.

The first and second current-to-voltage converter circuits, as objects for comparison, are each composed of a series-connection of a resistor and a diode or diodes (or bipolar transistor or transistors, each connected as a diode) and two resistors connected in parallel with the series connection. The voltages resulting from resistance division by the two resistors represent voltages under control. Hence, the circuit topologies of the first and second current-to-voltage converter circuits (I-V converter circuits) are the same. With the use of the unified circuit topologies of the first and second current-to-voltage converter circuits (I-V converter circuits), the circuit operation of the two circuits may be the same. Thus, even if process variations are produced, such variations may be expected to occur in the same manner for the two devices, such that output voltage characteristics may be expected to become small against manufacture tolerances. However, the first and second current-to-voltage converter circuits have different values of constants and the number of the diodes of the first current-to-voltage converter circuit is made to differ from that of the diodes of the second current-to-voltage conversion circuit. The ratio of the numbers of the parallel-connected diodes (or bipolar transistors connected as diodes) of the first and second current-to-voltage converter circuits, as the objects for comparison, is set to 1:N. Specifically, a sole diode D1 is used for the first current-to-voltage converter circuit, while two to four diodes D2 are parallel-connected for the second current-to-voltage conversion circuit.

The operation of the present embodiment is now described. With the forward voltages VF1, VF2 of the diodes (or bipolar transistors connected as diodes) D1 and D2, in FIG. 27, the OP amp (AP1) exercises control so that two input terminal voltages will be equal to each other (VA=VB).

If the output currents from the current mirror circuit are equal to each other,

I1=I2 (87)

The current I1 is divided into a current I1A flowing through the diode D1 and a current I1B flowing through the series resistors (R3a+R3h). Similarly, the current I2 is divided into a current I2A flowing common through series connection of the resistor R1 and N parallel-connected diodes D2 and a current I2B flowing through series-connected resistors (R4a+R4b).

Hence,

I1=I1A+I1B (88)

and

I2=I2A+I2B (89)

The drain voltage VD1 of the MOS transistor M1 is Vref′, whereas the drain voltage VD2 of the MOS transistor M2 is Vref.

Hence,

$$\begin{matrix}{I}_{1 A} = \frac{{V}_{ref}^{′} - {V}_{R 1}}{{R}_{1}} & ( 90 ) \\ {I}_{1 B} = \frac{{V}_{ref}^{′}}{{R}_{3 a} + {R}_{3 b}} & ( 91 ) \\ {I}_{2 A} = \frac{{V}_{ref} - {V}_{R 2}}{{R}_{2}} & ( 92 ) \\ and & \\ {I}_{2 B} = \frac{{V}_{ref}}{{R}_{4 a} + {R}_{4 b}} & ( 93 )\end{matrix}$$

Solving the equations (88) to (93), we have

$$\begin{matrix}{V}_{ref} = \frac{{R}_{3 a} + {R}_{3 b}}{{R}_{1} + {R}_{3 a} + {R}_{3 b}} ( {V}_{F 1} + {R}_{1} {I}_{1} ) & ( 94 ) \\ and & \\ {V}_{ref}^{′} = \frac{{R}_{4 a} + {R}_{4 b}}{{R}_{2} + {R}_{4 a} + {R}_{4 b}} ( {V}_{F 2} + {R}_{2} {I}_{2} ) & ( 95 )\end{matrix}$$

It is noted that (VF1+R1I1) is a voltage value of the order of 1.2V from which temperature characteristic is cancelled. Specifically, VF1 has a negative temperature characteristic of the order of −1.9 mV/° C. Thus, for canceling out the temperature characteristic, the temperature characteristic of R1I1 is a positive temperature characteristic of 1.9 mV/° C. The voltage is further divided by the resistors R3a and R3b to yield a voltage equal to 1.205V times (R3a+R3b)/(R1+R3a+R3b) (<1) as a low reference voltage Vref.

In similar manner, (VF2+R2I2) is a voltage value of the order of 1.2V from which temperature characteristic is cancelled. Specifically, VF2 has a negative temperature characteristic of the order of −1.9 mV/° C. Thus, for canceling out temperature characteristic, the temperature characteristic of R2I2 are positive temperature characteristic of 1.9 mV/° C. The voltage is further divided by the resistors R4a and R4b to yield a voltage equal to 1.205V times (R4a+R4b)/(R2+R4a+R4b) (<1) as a low reference voltage Vref.

Also,

$$\begin{matrix}{V}_{A} = \frac{{R}_{3 b}}{{R}_{3 a} + {R}_{3 b}} {V}_{ref} & ( 96 ) \\ and & \\ {V}_{B} = \frac{{R}_{4 b}}{{R}_{4 a} + {R}_{4 b}} {V}_{ref}^{′} & ( 97 )\end{matrix}$$

Since the OP amp exercises control to VA=VB, Vref=Vref′ is unnecessary and it is sufficient to set a constant so that the equation

$$\begin{matrix}{V}_{A} = \frac{{R}_{3 b}}{{R}_{3 a} + {R}_{3 b}} \frac{{R}_{3 a} + {R}_{3 b}}{{R}_{1} + {R}_{3 a} + {R}_{3 b}} ( {V}_{F 1} + {R}_{1} {I}_{1} ) \\ = \frac{{R}_{4 b}}{{R}_{4 a} + {R}_{4 b}} \frac{{R}_{4 a} + {R}_{4 b}}{{R}_{2} + {R}_{4 a} + {R}_{4 b}} ( {V}_{F 2} + {R}_{2} {I}_{2} ) = {V}_{B}\end{matrix} \qquad ( 98 )$$

will be valid.

### Embodiment 6

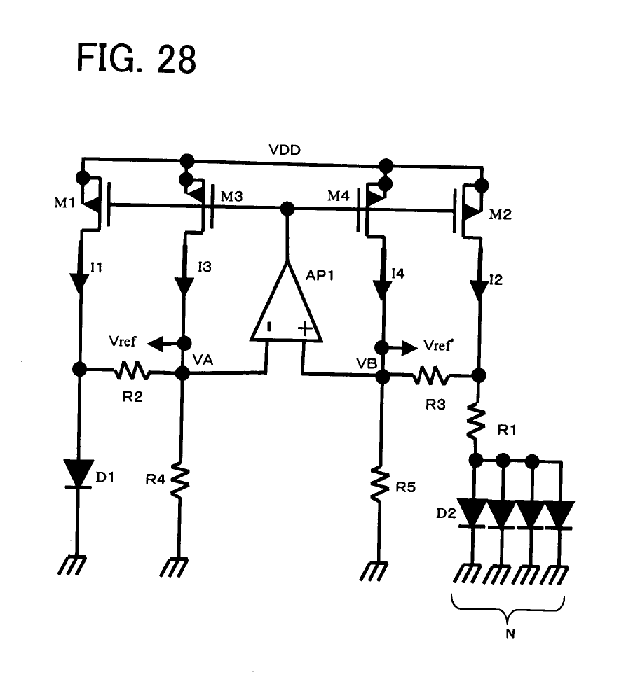

FIG. 28 depicts a diagram showing the circuit configuration of a CMOS reference voltage generating circuit of the present invention (claim 7). In FIG. 28, MOS transistors M1 to M4 constitute current mirror circuits. The common gate voltages of the MOS transistors are controlled by an OP amp (AP1) so that two input terminal voltages of the OP amp will become equal to each other, thereby determining currents I1 to I4 flowing through the current mirror circuit.

A first current-to-voltage converter circuit is composed of a diode D1 or a bipolar transistor connected as diode, whereas a second current-to-voltage converter circuit is a series connection of a resistor R1 and a plural number of diodes D2 (or bipolar transistors connected as diodes).

A third current-to-voltage converter circuit for comparison is composed of a resistor R4, whereas a fourth current-to-voltage converter circuit for comparison is composed of a resistor R5.

The first current-to-voltage converter circuit (D1) and the third current-to-voltage converter circuit (R4) are interconnected by a resistor R2, whereas the second current-to-voltage converter circuit (R1, D2) and the fourth current-to-voltage converter circuit (R5) are interconnected by a resistor R3. Hence, the circuit topologies of the first and second current-to-voltage converter circuits differ from each other.

Although the first and second current-to-voltage converter circuits differ from each other, the third current-to-voltage converter circuit is the same as the fourth current-to-voltage converter circuit. The first and second current-to-voltage converter circuits differ from each other as to the number of the diodes used. The ratio of the number of diodes D1 and the parallel-connected diodes D2 (or the bipolar transistors connected as diodes) of the first and second current-to-voltage converter circuits is set to 1:N. Specifically, a sole diode D1 is used for the first current-to-voltage converter circuit, and two to four diodes D2 are connected in parallel for the second current-to-voltage converter circuit.

The operation of the present embodiment is now described. In FIG. 28, with the forward voltages VF1 and VF2 of diodes (or bipolar transistors connected as diodes) D1 and D2, the OP amp (AP1) exercises control so that two output terminal voltages will be equal to each other (VA=VB).

If the output currents from the current mirror circuit are the same, then

I₁=I₂=I₃=I₄ (99)

The current I1 is divided into the current I1A flowing through the diode D1 and the current I1B flowing from the resistor R2 to the resistor R4. If the value of Vref is set to not higher than the forward voltage (0.6V) of the diode, the current I1B divided is positive. If the value of Vref is set to higher than the forward voltage (0.6V) of the diode, the current I1B divided is negative. In similar manner, the current I2 is divided into a current I2A, flowing common through the resistor R1 and N parallel-connected diodes D2, connected in series with the resistor R1, and a current I2B flowing through the resistor R5.

Hence,

I1=I1A+I1B (100)

and

I2=I2A+I2B (101)

The resistance values are set to R2=R3 and R4=R5. Thus, if the voltages VA and VB are controlled to be equal to each other, the currents flowing through the resistors R4 and R5 are equal to each other, so that

I3+I1B=I4+I2B (102)

Since I3=I4,

I1B=I2B (103)

Also, from the equations (92), (93) and (94),

I1A=I2A (104)

Hence, we have

ΔVF=VF1−VF2=V_{T}ln(N) (105).

Therefore,

$${V}_{ref} = {R}_{4} ( {I}_{1 A} + 2 {I}_{1 B} ) = {R}_{4} \{ \frac{{V}_{T} ln ( N )}{{R}_{1}} + 2 \frac{{V}_{F1} - {V}_{A}}{{R}_{2}} \} \qquad ( 106 )$$

Solving this, we have

$${V}_{ref} = \frac{2 {R}_{4}}{{R}_{2} + 2 {R}_{4}} \{ {V}_{F 1} + \frac{{R}_{2}}{2 {R}_{1}} {V}_{T} ln ( N ) \} = {V}_{ref}^{′} \qquad ( 107 )$$

[VF1+{R2/(2R1)}V_{T}ln(N)] can be set to a voltage value of the order of 1.2V, having temperature characteristic cancelled. Specifically, VF1 has a negative temperature characteristic on the order of −1.9 mV/° C., whereas V_{T} has a positive temperature characteristic of 0.0853 mV/° C. Thus, for canceling out temperature characteristic, the value of (R2/(2R1)V_{T}ln(N) is 22.27. Also, since V_{T} is 26 mV at ambient temperature, [VF1+{R2/(2R1)}V_{T}ln(N)] is approximately 1.205V.

The reference voltages Vref, Vref′, thus obtained, are each a constant voltage which is divided by resistances and multiplied by 2R4/(R2+2R4) and which may be set to 1.205V or less. That is, the reference voltages Vref, Vref′ are each a constant voltage having temperature characteristic cancelled. Hence, they may be used as reference voltages.

The values of simulation result are shown below. If, with VDD=1.2V, N and R1 to R5 are set so that N=4, R1=1.115 kΩ and R2=R3=40 kΩ and R4=R5=6 kΩ, the values of Vref are:

315.97 mV at −53° C.,

317.08 mV at 27° C. and

315.96 mV at 103° C.

so that upside-down cup shaped characteristic has been obtained. The width of the temperature variations is suppressed to a lower value of 0.36%.

### Further Embodiment of the Invention

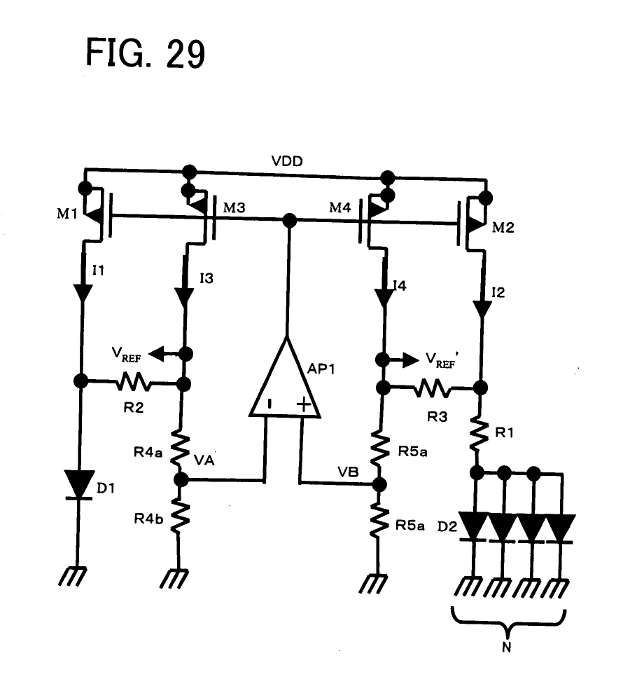

FIG. 29 depicts a diagram showing the circuit configuration of an embodiment of a CMOS reference voltage generating circuit of the present invention (claim 8).

If, in FIG. 28, it is desired to lower the input voltages of the control OP amp, it is sufficient to divide the resistors R4 and R5 into R4a, R4b and R5a, R5b to supply the so divided voltages as input voltages for the control OP amp, provided that R4a=R5a and R4b=R5b.

### Further Embodiment of the Invention

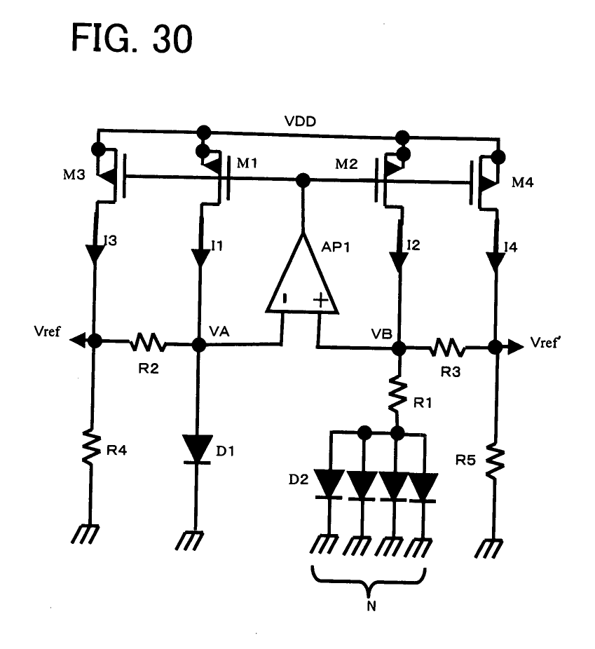

FIG. 30 depicts a diagram showing the circuit configuration of an embodiment of a CMOS reference voltage generating circuit of the present invention (claim 9).

In FIG. 28, two reference voltage outputs are supplied to the non-inverting and inverting input terminals of the OP amp as voltages for control. However, only two of the terminal voltages of the current-to-voltage converter circuits, driven by four output currents I1 to I4 from the current mirror circuits (M1 to M4), are used as voltages under control. The two terminal voltages of the current-to-voltage converter circuits, that are not the voltages under control, are coupled via resistors to the terminal voltages of the current-to-voltage converter circuits that are the voltages under control, thus affecting the control loop. The terminal voltages of the current-to-voltage converter circuits, as voltages for control, may be interchanged, as may be understood with ease.

In FIG. 30, MOS transistors M1 to M4 constitute a current mirror circuit. The common gate voltage is controlled by the OP amp (AP1) so that two input terminal voltages of the OP amp will be equal to each other. This determines the currents I1 to I4 flowing through the current mirror circuit.

The first current-to-voltage converter circuit for comparison is a diode D1 (or a bipolar transistor connected as diode). The second current-to-voltage converter circuit is a series connection of a resistor R1 and a diode D2 (or a bipolar transistor connected as diode). Third and fourth current-to-voltage converter circuits are constituted by resistors R4, R5, respectively. The first and third current-to-voltage converter circuits are interconnected by a resistor R2. The second and fourth current-to-voltage converter circuits are interconnected by a resistor R3.

Hence, first and second current-to-voltage converter circuits differ in circuit topologies. Although the first and second current-to-voltage converter circuits differ from each other, the third and fourth current-to-voltage converter circuits are identical. Also, the first and second current-to-voltage converter circuits differ from each other in the number of diodes. The ratio of the numbers of the parallel-connected diodes (or bipolar transistors connected as diodes) of the first and second current-to-voltage converter circuits for comparison is set to 1:N. Specifically, a sole diode D1 is used for the first current-to-voltage converter circuit, while two to four diodes D2 are parallel-connected for the second current-to-voltage converter circuit.

The operation of the present embodiment is now described. With the forward voltages VF1, VF2 of the diodes (or bipolar transistors connected as diodes) D1, D2, in FIG. 30, the OP amp (AP1) exercises control so that two input terminal voltages will be equal to each other (VA=VB).

If the output currents I1 to I4 from the current mirror circuit (M1 to M4) are equal to each other, then

I₁=I₂=I₃=I₄ (108)

The current I1 is divided into a current I1A flowing through the diode d1 and a current I1B flowing from resistor R2 to resistor R4. If the value of Vref is set to not higher than the forward voltage (0.6V) of the diode, the current I1B divided is positive, whereas, if the value of Vref is set to higher than the forward voltage (0.6V) of the diode, the current I1B divided is negative. In similar manner, the current I2 is divided into a current I2A flowing common through resistor R1 connected in series with N parallel-connected diodes D2 and a current I2B flowing from resistor R3 to resistor R5.

Hence,

I1=I1A+I1B (109)

I2=I2A+I2B (110)

It is assumed that resistance values are such that R2=R3 and R4=R5. Thus, if the voltages VA and VB are controlled to be equal to each other, the current flowing through resistor R4 and that through resistor R5 are equal to each other, such that

I3+I1B=I4+I2B (111)

Since I3=I4,

I1B=I2B (112)

Also, from the equations (109), (110) and (112),

I1A=I2A (113)

Hence,

$$\begin{matrix}{I}_{1 A} = {I}_{2 A} = \frac{{V}_{F 1} - {V}_{F 2}}{{R}_{1}} = \frac{Δ {V}_{F}}{{R}_{1}} = \frac{{V}_{T} ln ( N )}{{R}_{1}} & ( 114 ) \\ and & \\ {I}_{1 B} = {I}_{2 B} = \frac{{V}_{F 1} - {V}_{ref}}{{R}_{2}} & ( 115 )\end{matrix}$$

Since Vref is the terminal voltage of the resistor R4,

$${V}_{ref} = {R}_{4} ( {I}_{3} + {I}_{1 B} ) = {R}_{4} ( {I}_{1 A} + 2 {I}_{1 B} ) = {R}_{4} \{ \frac{\frac{{V}_{T} ln ( N )}{{R}_{1}} +}{2 \frac{{V}_{F 1} - {V}_{A}}{{R}_{2}}} \} \qquad ( 116 )$$

Finding Vref, we have

$${V}_{ref} = \frac{2 {R}_{4}}{{R}_{2} + 2 {R}_{4}} \{ {V}_{F 1} + \frac{{R}_{2}}{2 {R}_{1}} {V}_{T} ln ( N ) \} = {V}_{ref}^{′} \qquad ( 117 )$$

[VF1+{(R2/(2R1)}V_{T}ln(N)] can be set to a voltage value of the order of 1.2V, having voltage characteristics cancelled. Specifically, VF1 has a negative temperature characteristic of approximately −1.9 mV/° C., while V_{T} has a positive temperature characteristic of 0.0853 mV/° C. For canceling out temperature characteristic, the value of (R2/R1)ln(N) is 22.27. Also, since V_{T} is 26 mV at ambient temperature, (R2/2R1)V_{T}l is approximately 579 mV at ambient temperature. Hence, if VF1 is 626 mV at ambient temperature, {VF1+(R2/2R1)(V_{T}ln(N)) is approximately 1.205V.

The reference voltages Vref, Vref′, thus obtained, are each a constant voltage obtained on resistance division and multiplication by 2R4/(R2+2R4). These voltages are each a constant voltage which may be set to not higher than 1.205V and from which temperature characteristic is cancelled. Hence, these may each be used as a reference voltage.

### Embodiment 7

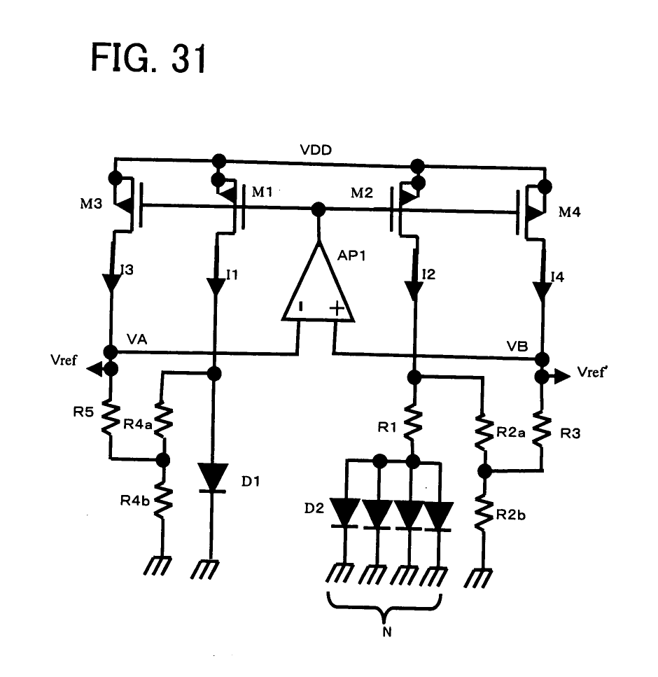

FIG. 31 depicts a diagram showing the circuit configuration of an embodiment of a CMOS reference voltage generating circuit of the present invention (claim 10). In the operation of JP Patent Kokai Publication No. JP-A-11-45125, as an example of a conventional circuit, parallel-connected resistors R2 and R4 are set so that the operating point is such as cancels out temperature characteristic. However, if resistance values of the parallel-connected resistors R2 and R4 are increased, temperature characteristic become positive. This will be evident from the fact that, if the resistance values of the parallel-connected resistors R2 and R4 are increased to infinitely large values, it is equivalent to removing the parallel-connected resistors R2 and R4, in which case the resulting circuit is a known conventional circuit having a positive temperature characteristic. If conversely the resistance values of the parallel-connected resistors R2, R4 are decreased, temperature characteristic will be negative, with the temperature characteristic not being cancelled. From the CTAT (complementary proportional to absolute temperature) current, thus obtained, there is obtained a voltage value having a negative temperature characteristic smaller than the forward voltage of the diode (about 600 mV).

Initially, the way of providing a low reference voltage by increasing the resistance values of the parallel-connected resistors R2 and R4 for setting to positive temperature characteristic, is described.

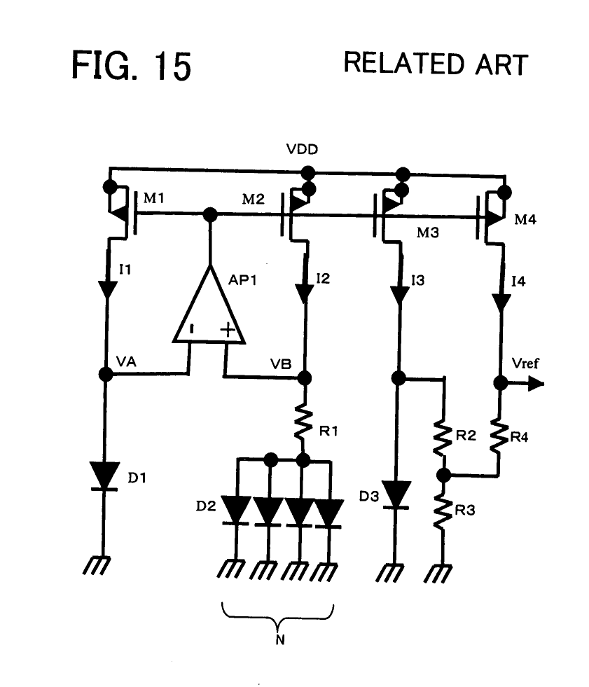

In the conventional circuit, shown in FIG. 15, an independent output circuit is provided. However, if, in the Bamba's reference voltage generating circuit, the resistance values of the parallel-connected resistors R2 and R4 are increased, the temperature characteristic become positive. The diode of the output circuit may, therefore, be shared with D1 and D2 controlled by the OP amp. Also, the two input voltages of the OP amp may be set to two output voltages Vref, Vref′.

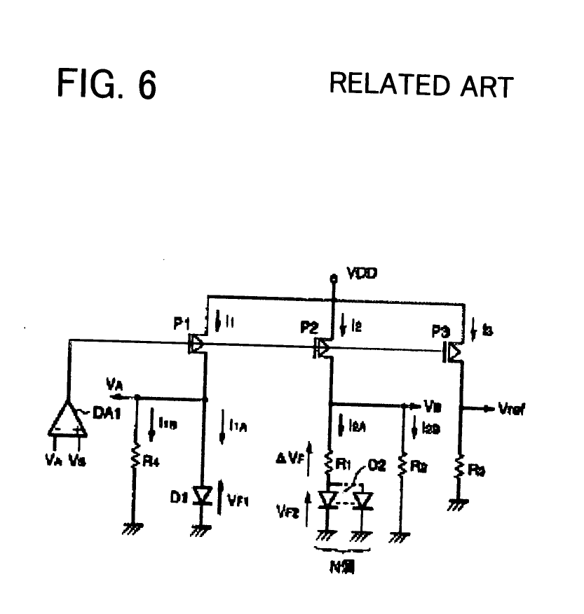

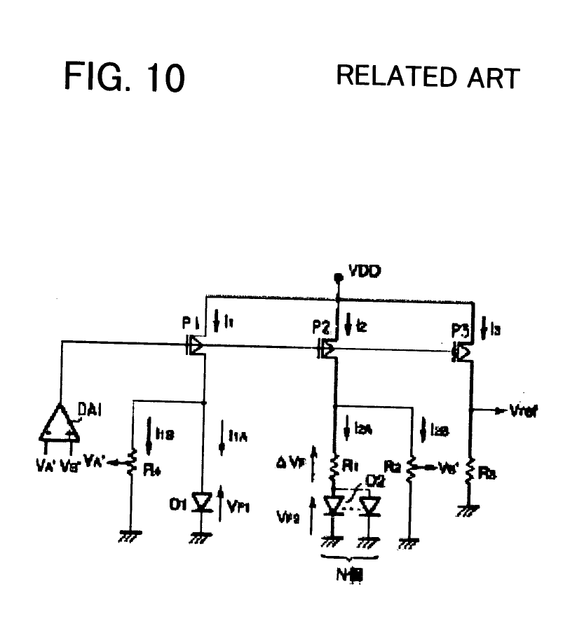

As for circuit configuration, the Bamba's reference voltage generating circuit is changed from the circuit shown in FIG. 6 so that parallel-connected resistors R2 and R4 are split into R2a, R2b and R4a, R4b, respectively, the currents are caused to flow from a common current mirror circuit through resistors R3 and R5 to respective division points, with the terminal voltages of the resistors R3 and R5 being output voltages Vref and Vref′, as shown in FIG. 10. One ends of the resistors R3, R5 are connected to a junction between R2a and R2b and to a junction between R4a and R4b, with the other ends of the resistors being connected to the non-inverting (positive phase) input terminal (+) of the OP amp (AP1), drain of the transistor M4, Vref′, inverting (negative phase) input terminal (−), drain of the transistor M3 and Vref.

The operation of the present embodiment is now described. The transistors M1 to M4 constitute a current mirror circuit, and output currents I1 to I4, respectively. If the output currents from the current mirror circuit (M1 to M4) are equal to each other, then

I₁=I₂=I₃=I₄ (118)

The current I1 is divided into a current I1A flowing through the diode D1 and a current I1B flowing through resistors R2a and R2b. In similar manner, the current I2 is divided into a current I2A flowing common through resistor R1 connected in series with N parallel-connected diodes D2 and a current I2B flowing through resistor R4a and resistor R4b.

Hence,

I1=I1A+I1B (119)

I2=I2A+I2B (120)

If we set the resistance values to be equal to each other,

R2a+R2b=R4a+R4b (121)

If R2b=R4b (122)

then,

R2a=R4a (123)

Also,

R3=R5 (124)

With the forward voltages VF1 and VF2 of the diodes (or bipolar transistors connected as diodes) D1 and D2, and with the terminal voltage VX if the resistor R1,

$$\begin{matrix}\begin{matrix}{V}_{A} = {V}_{ref} = {R}_{4 b} ( {I}_{1 b} + {I}_{3} ) + {R}_{5} {I}_{3} \\ = \frac{{R}_{4 b}}{{R}_{4 a} + {R}_{4 b}} {V}_{F 1} + ( {R}_{4 b} + {R}_{5} ) {I}_{3}\end{matrix} & ( 125 ) \\ and & \\ \begin{matrix}{V}_{B} = {V}_{ref}^{′} = {R}_{2 b} ( {I}_{2 b} + {I}_{4} ) + {R}_{3} {I}_{4} \\ = \frac{{R}_{2 b}}{{R}_{2 a} + {R}_{2 b}} {V}_{X} + ( {R}_{2 b} + {R}_{3} ) {I}_{4}\end{matrix} & ( 126 )\end{matrix}$$

Hence, the OP amp (AP1) exercises control so that two terminal voltages will be equal to each other (VA=VB) such that

VX=VF1 (127)

Hence, I1a=I2a and

ΔVF=VF1−VF2=V_{T}ln(N) (128)

Hence,

$${I}_{1} = {I}_{2} = {I}_{3} = {I}_{4} = \frac{Δ {V}_{F}}{{R}_{1}} + \frac{{V}_{F 1}}{{R}_{2 a} + {R}_{2 b}} \qquad ( 129 )$$

The output reference voltage is given by

$$\begin{matrix}{V}_{ref} = {V}_{ref}^{′} = \frac{{R}_{3} + 2 {R}_{2 b}}{{R}_{2 a} + {R}_{2 b}} \{ {V}_{F 1} + \frac{{R}_{3} + {R}_{2 b}}{{R}_{3} + 2 {R}_{2 b}} \frac{{R}_{2 a} + {R}_{2 b}}{{R}_{1}} Δ {V}_{F} \} \\ = \frac{{R}_{3} + 2 {R}_{2 b}}{{R}_{2 a} + {R}_{2 b}} \{ {V}_{F 1} + \frac{{R}_{3} + {R}_{2 b}}{{R}_{3} + 2 {R}_{2 b}} \frac{{R}_{2 a} + {R}_{2 b}}{{R}_{1}} {V}_{T} ln ( N ) \}\end{matrix} \qquad ( 130 )$$

[VF1+{(R3+R2b)(R2a+R2b)/(R3+2R2B)(R1)}V_{T}ln(N)] can be set to a voltage value of the order of 1.2V from which temperature characteristic have been cancelled. Specifically, VF1 has a negative temperature characteristic of the order of −1.9 mV/° C., temperature characteristic of the resistor can be neglected, and V_{T} has a positive temperature characteristic of 0.0853 mV/° C. Thus, the value of {(R3+R2b)(R2a+R2b)/(R3+2R2B)(R1)}ln(N) is 22.27 if temperature characteristic is to be cancelled. Since V_{T} is 26 mV at ambient temperature, {(R3+R2b)(R2a+R2b)/(R3+2R2B)(R1)}V_{T}ln(N) is approximately 579 mV at ambient temperature.

Hence, if VF1 is 626 mV at ambient temperature, [VF1+{(R3+R2b)(R2a+R2b)/(R3+2R2B)(R1)}V_{T}ln(N)] is about 1.205V

The reference voltages Vref, Vref′, thus obtained, are constant voltages not higher than 1.205V, represented by a value corresponding to voltage division by resistors R2a, R2b and R3, and are constant voltages from which temperature characteristic have been cancelled. Hence, these voltages may be used as reference voltages.

Moreover, since the reference voltages Vref and Vref′ are within the control loop, it is possible to suppress voltage variations.

The values of simulation result are shown below. If, with VDD=1.5V, N is set to N=4, R1=1 kΩ, R2a=R4a=19 kΩ, R2b=R4b=2 kΩ, and R3=R5=10 kΩ, the values of Vref are:

817.11 mV at −53° C.,

820.18 mV at 27° C. and

817.55 mV at 103° C.

so that upside-down cup shaped characteristic has been obtained. The width of the temperature variations is suppressed to a lower value of 0.38%.

### Other Embodiment of the Invention

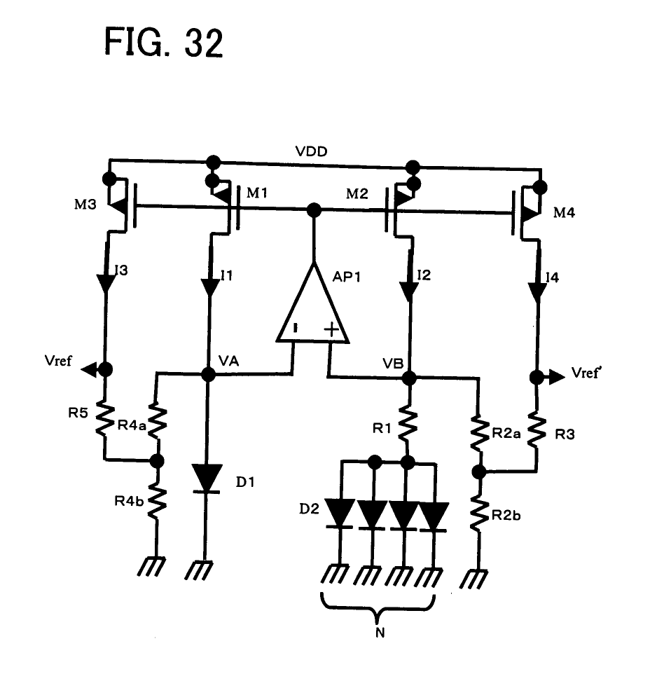

FIG. 32 depicts a diagram showing the circuit configuration of an embodiment of a CMOS reference voltage generating circuit of the present invention (claim 11). The circuit of FIG. 32 is similar to the circuit of FIG. 31 except that the input voltages (VA, VB) of the OP amp (AP1) in the circuit of FIG. 31 are changed to terminal voltages of resistors R2a-R2b and resistors R4a-R4b connected in parallel with the diodes D1 and D2, respectively. The circuit operation is the same as that of the circuit of FIG. 31.

### Other Embodiment of the Invention

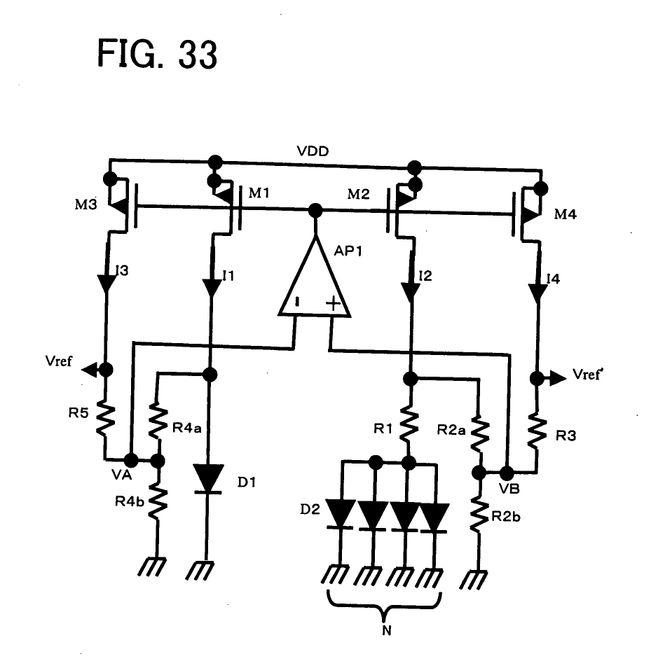

FIG. 33 depicts a diagram showing the circuit configuration of an embodiment of a CMOS reference voltage generating circuit of the present invention (claim 12). The circuit of FIG. 33 is similar to the circuit of FIG. 31 except that the input voltages (VA, VB) of the OP amp (AP1) in the circuit of FIG. 31 are changed to voltages corresponding to voltage division by resistors R2a-R2b and resistors R4a-R4b connected in parallel with the diodes D1 and D2, respectively. The circuit operation is the same as that of the circuit of FIG. 31.

There are other methods to lower the input voltage to the OP amp (AP1) without being limited to connection to the opposite side terminals of the resistors R3 and R5. There may be a method to further divide the resistors R3 and R4 or the resistors R3 and R5.

### Other Embodiment of the Invention

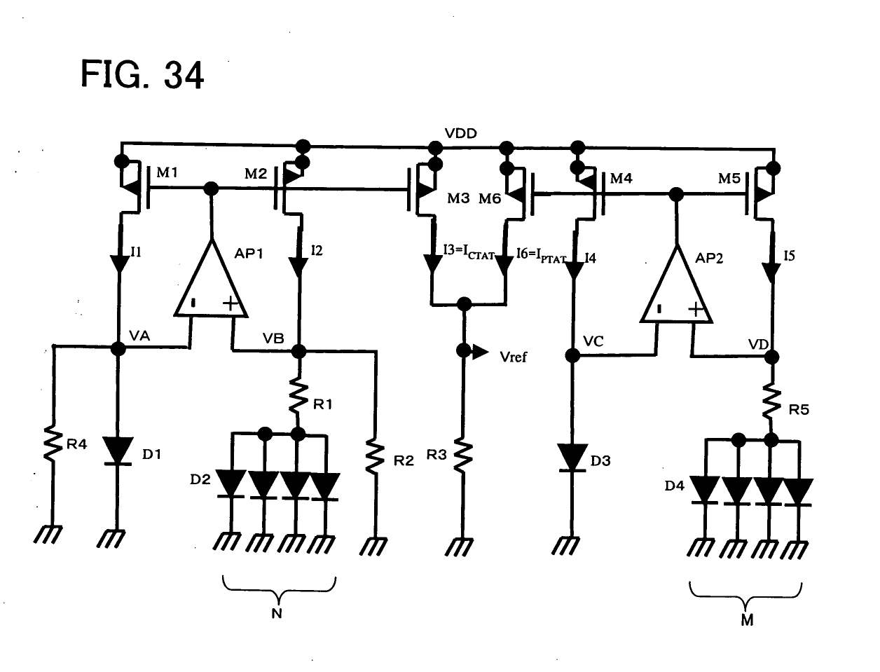

FIG. 34 depicts a diagram showing the circuit configuration of an embodiment of a CMOS reference voltage generating circuit of the present invention (claim 13). If a voltage (VCTAT) having a negative temperature characteristic lower than the forward voltage (about 600 mV) of diodes is obtained, the voltage VPTAT having a positive temperature characteristic canceling it out may also be made smaller, so that a lower reference voltage may be obtained.

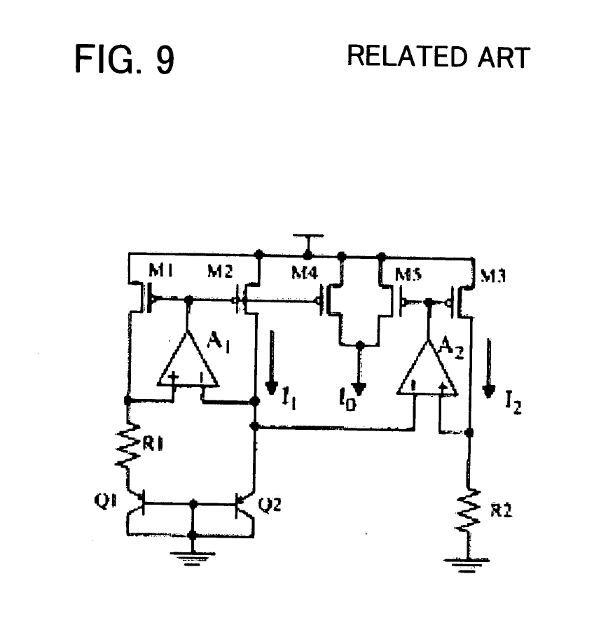

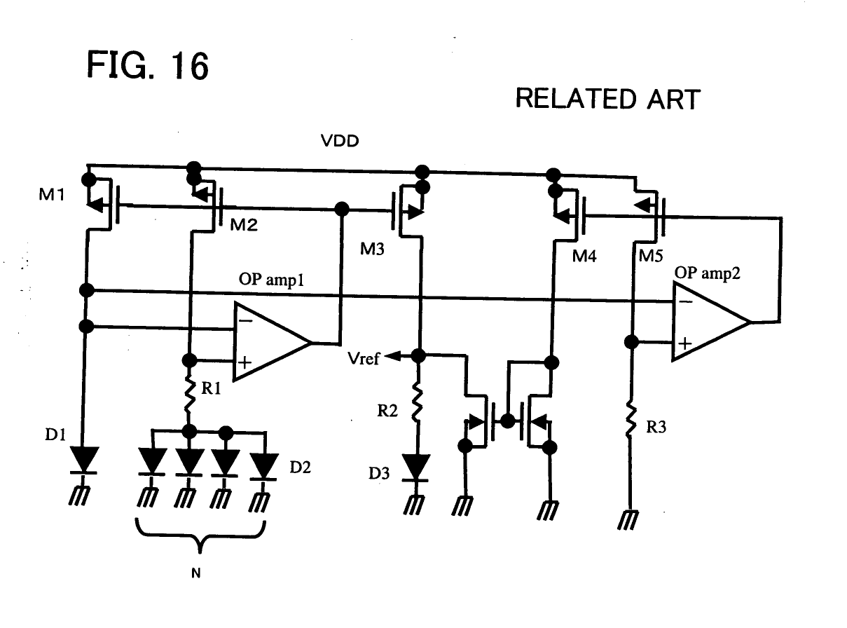

In the conventional circuit, shown in FIGS. 9 and 16, the ICPAT current is obtained by referencing the terminal voltage of diodes. However, with the Bamba's reference voltage generating circuit, temperature characteristic is negative if the parallel-connected resistors R2, R4 are reduced, so that the ICPAT current with smaller non-linear temperature characteristic of diodes may be obtained.

With the circuit configuration of the present embodiment, the parallel-connected resistors R2 and R4 in the circuit of FIG. 6 (Bamba's reference voltage generating circuit) are set to values smaller than before to implement a CTAP current circuit. Using the conventional PTAT current circuit, shown in FIGS. 9 and 16, ICTAT and IPTAT are weighted and summed together to cancel out the temperature characteristic and the resulting current is caused to flow through a resistor R3 to generate a reference voltage.

The operation of the present embodiment is now described. In FIG. 34, the OP amp (AP1) controls the common gate voltage of the transistors M1 and M2 so that VA=VB.

Hence,

VA=VB (131)

and

I1=I2 (132)

The current I1 is divided into a current I1A flowing through diode D1 and a current I1B flowing through resistor R4. Similarly, the current I2 is divided into a current I2A and a current I2B. The current I2A flows common through a resistor R1 and through N parallel-connected diodes D2 connected in series with the resistor R1. The current I2B flows through the resistor R2.

If R2=R4 (133)

then

I1A=I2A (134)

and

I1B=I2B (135)

VA=VF1 (136)

and

VB=VF2+ΔVF (137)

can be set, so that

ΔVF=VF1−VF2 (138)

The voltage drop of R1 is ΔVF and

I2A=ΔVF/R1 (139)

and

I1B=I2B=VF1/R2 (140)

The equation

ΔVF=V_{T}ln(N) (141)

where V_{T} is thermal voltage, is valid.

Hence, I3 (=I2) is expressed by

$$\begin{matrix}I 3 = VF 1 / R 2 + ( {V}_{T} ln ( N ) ) / R 1 \\ = \{ VF 1 + ( R 2 / R 1 ) ( {V}_{T} ln ( N ) ) / R 2\end{matrix} \qquad ( 142 )$$

It is noted that VF1 has a negative temperature characteristic on the order of −1.9 mV/° C., whereas V_{T} has a positive temperature characteristic on the order of 0.0853 mV/° C. Thus, in case temperature characteristic is cancelled, the value of (R2/R1)ln(N) is 22.27. However, if the value of (R2/R1)ln(N) is larger than 22.27, the current I3 has a positive temperature characteristic and, if conversely the value of (R2/R1)ln(N) is lesser than 22.27, the current I3 has a negative temperature characteristic. Here, the ICTAT current, having a negative temperature characteristic, is obtained by setting so that (R2/R1)ln(N)<22.27.

An OP amp (AP2) controls the common gate voltage of the transistors M4 and M5 so that VC=VD.

Hence,

VC=VD (143)

and

I4=I5 (144)

Also,

VC=VF3 (145)

and

VD=VF4+ΔVF′ (146)

so that

ΔVF′=VF3−VF4 (147)

The voltage drop at R5 is ΔVF′ and

ΔVF′=V_{T}ln(M) (148)

where V_{T} is thermal voltage.

Hence, I6 (=I5) is expressed as

$$\begin{matrix}I 6 = Δ {VF}^{′} / R 5 \\ = \{ {V}_{T} ln ( M ) \} / R 5\end{matrix} \qquad ( 149 )$$

Here, V_{T} has a positive temperature characteristic of 0.0853 mV/° C., so that the current I6 is the IPTAT current having a positive temperature characteristic.

The currents ICTAT (I3) and IPTAT (I6), thus obtained, are weighted and summed together, and the resulting current is caused to flow through resistor R3 to yield a low reference voltage, which is lower than 1.205V and from which temperature characteristic have been cancelled.

The values of simulation result are shown below. If, with VDD=1.5V, N, M and R1 to R5 are set so that N=M=4, R1=1 kΩ, R2=R4=10 kΩ, R3=5 kΩ and R5=1.28 kΩ, the values of Vref are:

754.78 mV at −53° C.,

757.01 mV at 27° C. and

754.72 mV at 103° C.

so that upside-down cup shaped characteristic has been obtained. The width of the temperature variations is suppressed to about 0.3%.

### Other Embodiment of the Invention

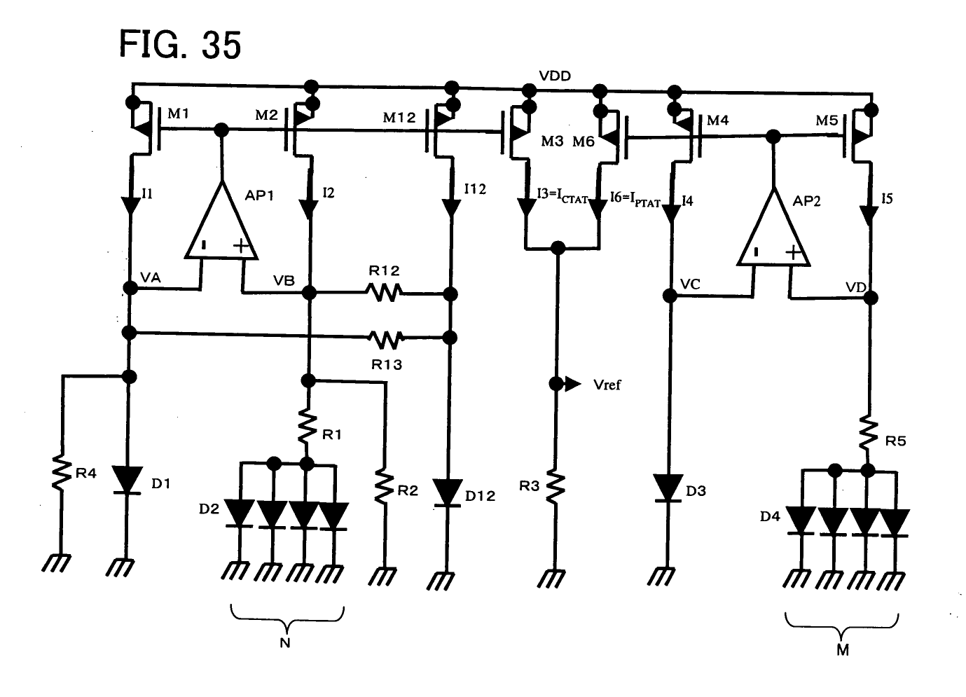

FIG. 35 depicts a diagram showing the circuit configuration of an embodiment of a CMOS reference voltage generating circuit of the present invention (claim 14).

In the present embodiment, a transistor M12, added to a current mirror circuit of the CMOS reference voltage generating circuit of FIG. 34, drives a diode D12. This diode D12 is connected to the first current-to-voltage converter circuit by a resistor R12, whilst the diode D12 is connected to the second current-to-voltage converter circuit by a resistor R13.

The operation of the present embodiment is now described. In FIG. 35, the transistor M12, diode D12 and the resistors R12 and R13, added to FIG. 34, constitute a compensation circuit for compensating for temperature non-linearity of a diode.

The values of simulation result are shown below. If, with VDD=1.5V, N, M, R1 to R5, R12 and R13 are set so that N=M=4, R1=1 kΩ, R2=R4=10 kΩ, R12=R13=3 kΩ, R3=5 kΩ and R5=1.418 kΩ, the values of Vref are:

631.242 mV at −53° C.,

631.612 mV at 27° C. and

631.228 mV at 107° C.

so that upside-down cup shaped characteristic has been obtained. The width of the temperature variations is suppressed to 0.059%.

### Other Embodiment of the Invention

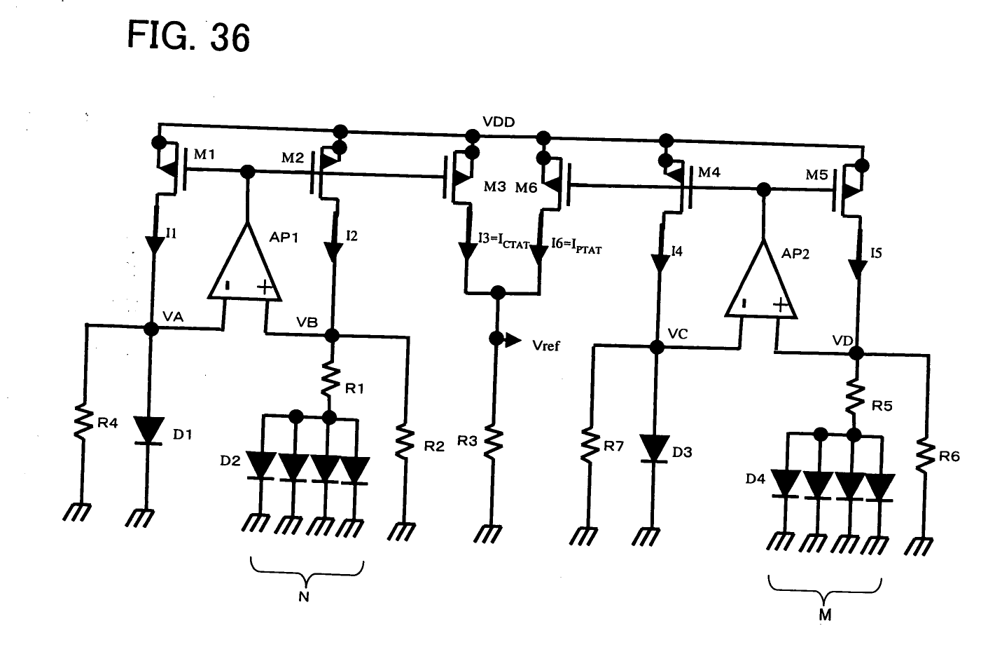

FIG. 36 depicts a diagram showing the circuit configuration of an embodiment of a CMOS reference voltage generating circuit of the present invention (claim 15). The IPTAT current may be obtained on setting (R2/R1)ln(N)>22.27 in the equation (142). Thus, with the use of the IPTAT circuit and the ICTAT circuit of the same circuit topology and with the use of the larger resistance values of the parallel-connected resistors, it is possible to implement the IPTAT circuit, as shown in FIG. 36. The ICTAT circuit may be implemented with the use of smaller resistance values of the parallel-connected resistors. The ICTAT current (I3) and the IPTAT current (I6), thus obtained, may be weighted and summed together and the resulting current is caused to flow through a resistor R23 to give a reference voltage lower than 1.205V and from which temperature characteristic is cancelled.

The values of simulation result are shown below. If, with VDD=1.5V, N, M and R1 to R7 are set so that N=M=4, R1=1 kΩ, R2=R4=10 kΩ, R3=5 kΩ, R5=1 kΩ and R6=R7=87 kΩ, the values of Vref are:

754.77 mV at −53° C.,

757.01 mV at 27° C. and

754.73 mV at 103° C.

so that upside-down cup shaped characteristic has been obtained. The width of the temperature variations is suppressed to 0.32%.

### Other Embodiment of the Invention

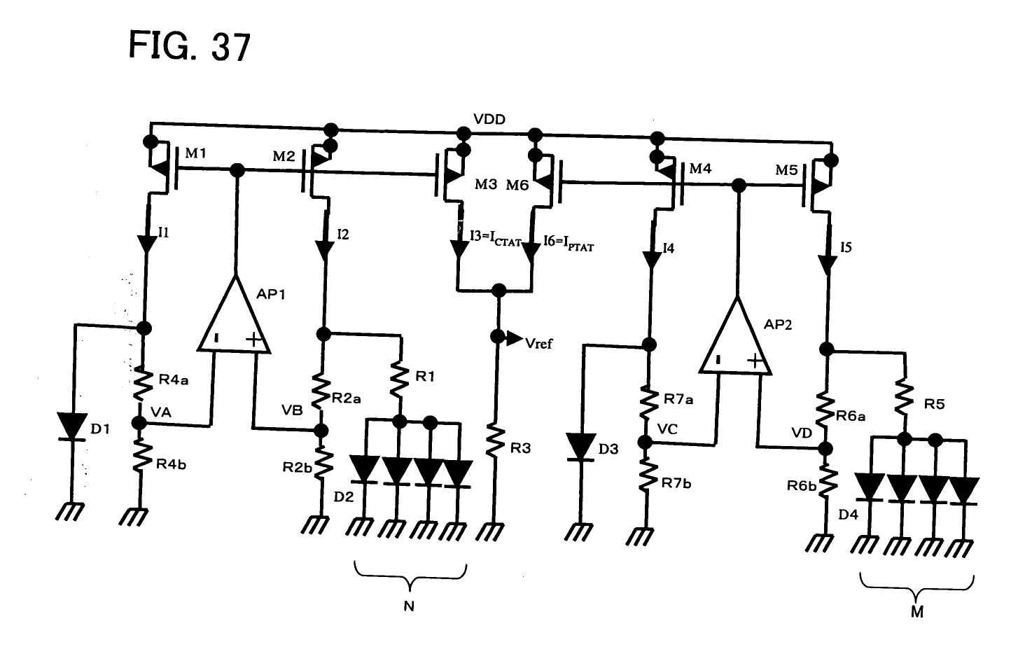

FIG. 37 depicts a diagram showing the circuit configuration of an embodiment of a CMOS reference voltage generating circuit of the present invention (claim 16). The parallel-connected resistors R2, R4, R6 and R7 of FIG. 36 may be divided by voltage-dividing resistors R2a, R2b, R4a, R4b, R6a, R6b and R7a, R7b, respectively, to lower the input voltages of an OP amp 1 and an OP amp 2. The result is shown in FIG. 37, in which R2a=R4a, R2b=R4b, R6a=R7a and R6b=R7b.

### Other Embodiment of the Invention

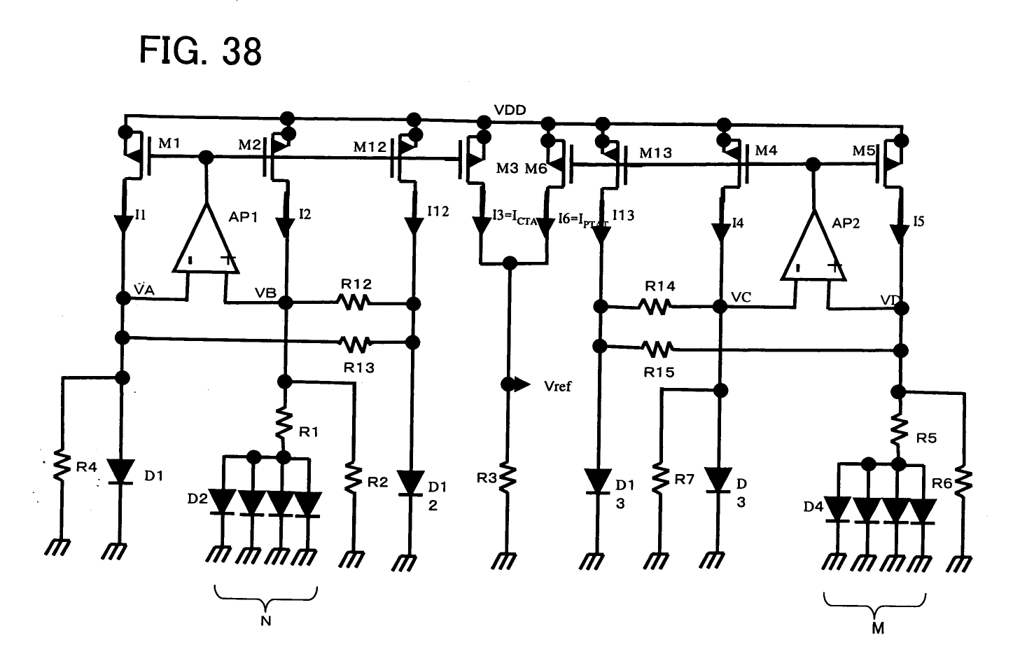

FIG. 38 depicts a diagram showing the circuit configuration of a first embodiment of a CMOS reference voltage generating circuit of the present invention (claim 17). In the reference voltage generating circuit, shown in FIG. 36, it is possible to add a compensation circuit for compensating for temperature non-linearity of a diode.

FIG. 38 depicts a diagram of a reference voltage generating circuit in which a circuit for compensating for temperature non-linearity of a diode is added to each of the PTAT circuit and the CTAT circuit.

A transistor M12, added to a first current mirror circuit (M1, M2), drives a diode D12. The diode D12 is connected to the first current-to-voltage converter circuit (D1, R4) by a resistor R13, whilst the diode D12 is connected to the second current-to-voltage converter circuit (D2, R1, R2) by a resistor R12.

A transistor M13, added to a second current mirror circuit (M4, M5), drives a diode D13. The diode D12 is connected to a third current-to-voltage converter circuit (D3, R7) by a resistor R14, whilst the diode D12 is connected to a fourth current-to-voltage converter circuit (D4, R5, R6) by a resistor R15.

The values of simulation result are shown below. If, with VDD=1.5V, N, M, R1 to R7 and R12 to R15 are set so that N=M=4, R1=1 kΩ, R2=R4=10 kΩ, R12=R13=3 kΩ, R3=5 kΩ, R5=1.115 kΩ, R6=R7=87 kΩ and R14=R15=8 kΩ, the values of Vref are:

701.545 mV at −53° C.,

702.124 mV at 27° C. and

701.542 mV at 107° C.

so that upside-down cup shaped characteristic has been obtained. The width of the temperature variations is suppressed to 0.083%.

### Other Embodiment of the Invention

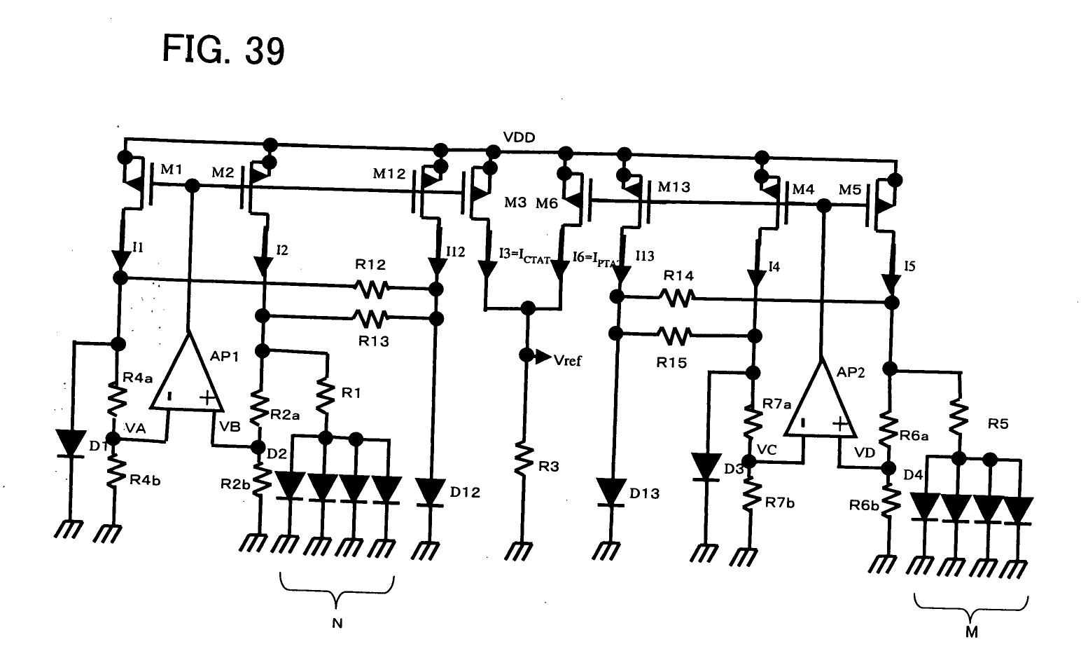

FIG. 39 depicts a diagram showing the circuit configuration of a second embodiment of a CMOS reference voltage generating circuit of the present invention (claim 17). In the reference voltage generating circuit, shown in FIG. 37, it is possible to add a compensation circuit for compensating for temperature non-linearity of a diode.

If the parallel-connected resistors R2, R4, R6 and R7 in FIG. 38 are split into voltage-dividing resistors R2a, R2b, R4a, R4b, R6a, R6b and R7a, R7b, it is possible to lower the input voltages of the OP amp 1 and the OP amp 2. The result is shown in FIG. 39, where R2a=R4a, R2b=R4b, R6a=R7a and R6b=R7b.

FIG. 39 depicts a diagram for a reference voltage generating circuit added by a circuit for compensating for temperature no-linearity of diodes.

A transistor M12, added to a first current mirror circuit (M1, M2), drives a diode D12. The diode D12 is connected to a first current-to-voltage converter circuit (diode D1 and resistors R4a and R4b) by a resistor R12, whilst the diode D12 is connected to a second current-to-voltage converter circuit (resistor R1 and diodes D2, R2a, R2b) by a resistor R13. A transistor M13, added to a second current mirror circuit (M4, M5), drives a diode D13. The diode D13 is connected to a third current-to-voltage converter circuit (resistor R5 and diodes D4, R6a, R6b) by a resistor R14, whilst the diode D13 is connected to a fourth current-to-voltage converter circuit (diode D3 and resistors R7a, R7b) by a resistor R15.

The operation of the present embodiment is equivalent to that of the reference voltage generating circuit shown in FIG. 38.

### Other Embodiment of the Invention

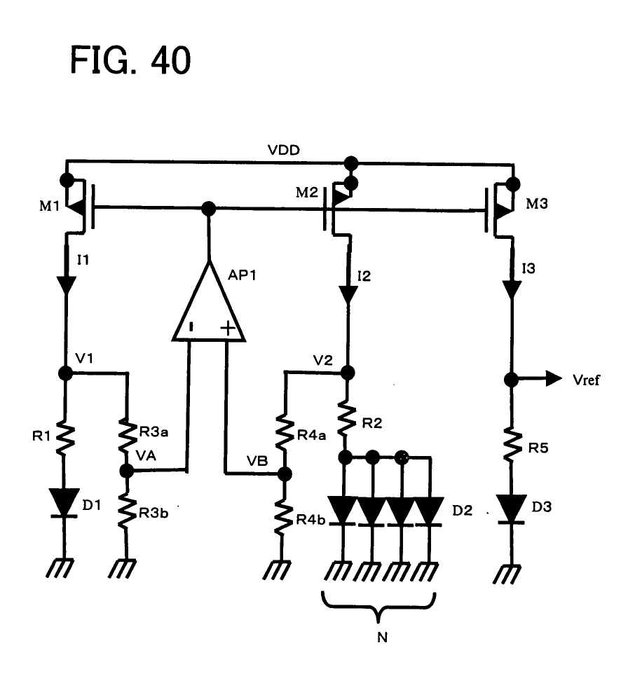

FIG. 40 depicts a diagram showing the circuit configuration of an embodiment of a CMOS reference voltage generating circuit of the present invention (claim 18).

It the IPTAT current, having higher positive temperature characteristic, can be obtained, the voltage VPTAT with positive temperature characteristic, canceling out VCTAT voltage (about 600 mV at ambient temperature) of a diode, may also be reduced to provide a low reference voltage.

In the conventional circuit, shown in FIG. 16, the ICTAT current is implemented by referencing the diode terminal voltage and subtracted from the IPTAT current to generate an IPTAT current having higher positive temperature characteristic. However, non-linear temperature characteristic of diodes become outstanding, as described above.

In FIG. 40, transistors M1 to M3 constitute a current mirror circuit. The OP amp (AP1) controls the common gate voltage of the transistors M1 to M3 so that two input terminal voltages of the OP amp will be equal to each other. This determines the currents I1 to I3 flowing through the current mirror circuit.

The first current-to-voltage converter circuit (R1, D1, R3a and R3b) and the second current-to-voltage converter circuit (R2, D2, R4a and R4b) are each a series connection of a resistor and a diode (or a transistor connected as a diode) and a resistor connected in parallel with the series connection to output divided voltages. The two divided voltages represent input voltages of the OP amp (AP1). Hence, the circuit topologies of the first and second current-to-voltage converter circuits are the same. With the use of the unified circuit topologies of the first and second current-to-voltage converter circuits (I-V converter circuits), the circuit operation of the two circuits may be the same. Even if process variations are produced, it may be these variations may be expected to occur in the same manner for the two devices, such that output voltage characteristics may be expected to become small against manufacture tolerances. However, the values of the majority of constants used in the first current-to-voltage converter circuit are different from those used in the second current-to-voltage converter circuit. Moreover, the number of the diodes of the first current-to-voltage converter circuit is made to differ from that of the diodes of the second current-to-voltage converter circuit. That is, the ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four diodes D2 are parallel-connected for the second current-to-voltage converter circuit.

An output circuit is a series connection of a resistor and a diode (or a bipolar transistor connected as diode). One of the terminals is grounded, while the other terminal outputs a reference voltage.

The operation of the present embodiment is now described. In FIG. 40, resistors R1 and R2 are connected in series with the diodes D1 and D2 (or bipolar transistors connected as diodes), respectively. The terminal voltages of the resistors are labeled V1 and V2. The forward voltages of the diodes (or bipolar transistors connected as diodes) are labeled VF1 ad VF2. With the first and second current-to-voltage converter circuits, driven by the currents I1 and I2, if the currents I1 and I2 become higher, the voltages V1 and V2 become correspondingly higher due to inserted resistors R1 and R2. On the other hand, the voltages VF1 and VF2 become moderately higher.

If the output currents from the current mirror circuit are equal,

I1=I2 (150)

The current I1 is divided into a current I1A flowing through a series connection of the resistor R1 and the diode D1 and a current I1B flowing through series-connected resistors (R3a+R3b).

Similarly, the current I2 is divided into a current I2A flowing common through a series connection of a resistor R2 and N parallel-connected diodes D2 and a current I2B flowing through series-connected resistors (R4a+R4b).

Hence,

$$\begin{matrix}I 1 = I 1 A + I 1 B & ( 151 ) \\ and & \\ I 2 = I 2 A + I 2 B & ( 152 ) \\ Also , & \\ {I}_{1 A} = \frac{{V}_{1} - {V}_{F 1}}{{R}_{1}} & ( 153 ) \\ {I}_{1 B} = \frac{{V}_{1}}{{R}_{3 a} + {R}_{3 b}} & ( 154 ) \\ {I}_{2 A} = \frac{{V}_{2} - {V}_{F 2}}{{R}_{2}} & ( 155 ) \\ {I}_{2 B} = \frac{{V}_{2}}{{R}_{4 a} + {R}_{4 b}} & ( 156 )\end{matrix}$$

Since the OP amp (AP1) exercises control so that two input terminal voltages will be equal to each other (VA=VB),

$${V}_{A} = \frac{{R}_{3 b}}{{R}_{3 a} + {R}_{3 b}} {V}_{1} = \frac{{R}_{4 b}}{{R}_{4 a} + {R}_{4 b}} {V}_{2} = {V}_{B} \qquad ( 157 )$$

For simplicity, we set R3b to be equal to R4b (R3b=R4b). From the equation (157), the equations (154) and (156) become equal to each other.

Hence,

I1B=I2B (158)

so that the equations (153) and (155) become equal to each other.

I1A=I2A (159)

Hence, it is seen that the relationship

ΔVF=VF1−VF2=V_{T}ln(N) (160)

holds.

The relationship between V1 and V2 is expressed as

$${V}_{2} = \frac{{R}_{4 a} + {R}_{3 b}}{{R}_{3 a} + {R}_{3 b}} {V}_{1} \qquad ( 161 )$$

If we set R3a to be greater than R4a (R3a>R4a), V1>V2. If, with N>1, R1<R2, the driving currents I1 and I2 may be of positive temperature characteristic. Moreover, positive temperature characteristic may be set to be higher. However, a resistor and a diode (or a bipolar transistor connected as diode) are connected in series with the current-to-voltage converter circuit of the output circuit, the reference voltage output is higher than VF at a low temperature of the diode (or the bipolar transistor connected as diode) and specifically intermediate between the VF at lower temperature and 1.205V, or about 1V.

The values of simulation result are shown below. If, with VDD=1.5V, N, R1, R2, R3a, R3b, R4a, R4b and R5 are set so that N=4, R1=1.25 kΩ, R2=1.375 kΩ, R3a=25 kΩ, R3b=R4b=50 kΩ, R4a=22.85 kΩ and R5=1.72 kΩ, the values of Vref are:

910.02 mV at −53° C.,

916.52 mV at 27° C. and

909.98 mV at 107° C.

so that upside-down cup shaped characteristic has been obtained. The width of the temperature variations is suppressed to 0.72%. Hence, the reference voltage may be lowered by a factor of approximately ¾.

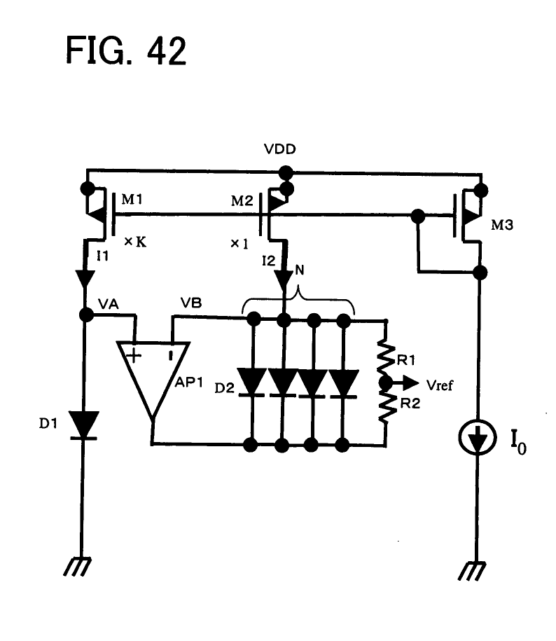

FIG. 42 depicts a diagram showing the circuit configuration of a CMOS reference voltage generating circuit of the present invention (claim 27).

In FIG. 42, MOS transistors M1 to M3 constitute a current mirror circuit with the current ratio of K:1:1. By the MOS transistor M3, driven with a constant current 10, currents I1 (=K10) and I2 (=I0) flow through the MOS transistors M1 and M2, respectively. The common gate voltage is controlled by the OP amp (AP1) so that two input terminal voltages of the OP amp will be equal to each other.

The first and second current-to-voltage converter circuits for comparison are each made up of diodes (bipolar transistors connected as diodes). The number of diodes of the first current-to-voltage converter circuit differs from that of the second current-to-voltage converter circuit. The ratio of the numbers of the diodes (or bipolar transistors connected as diodes) in the parallel path of each of the first and second current-to-voltage converter circuits is set to 1:N. Specifically, a sole diode D1 is used for the first current-to-voltage converter circuit, while two to four diodes D2 are parallel-connected for the second current-to-voltage converter circuit.

The opposite terminal of the diode (or the bipolar transistor connected as diode) D1 of the first current-to-voltage converter circuit is grounded, whereas the opposite terminal of the diode (or the bipolar transistor connected as diode) D2 of the second current-to-voltage converter circuit is connected to an output of the OP amp (AP1) and is controlled so that the terminal voltages of the first and second current-to-voltage converter circuits will be equal to each other.

An output circuit is made up by resistors R1 and R2 that divide the forward voltage of the diode (or the bipolar transistor connected as diode) D2 of the second current-to-voltage converter circuit. The divided voltage is output as the reference voltage Vref.

The operation of the present embodiment is now described. Referring to FIG. 42, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1 and I2 from the current mirror circuit is K:1,

I1=K10 (162)

I2=I0 (163)

If D1 is a unit diode (or a bipolar transistor connected as a diode), and D2 are N parallel-connected unit diodes (or bipolar transistors connected as diodes), the voltage difference ΔVF of D1 and D2 is expressed as

ΔVF=VF1−VF2=V_{T}ln(KN) (164)

Since V_{T} has a positive temperature characteristic of 0.0853 mV/° C., the voltage difference has a positive temperature characteristic and appears across the ground and the output voltage of the OP amp (AP1).

The forward voltage VF1 of D1 has a negative temperature characteristic of approximately −1.9 mV/° C., so that, if temperature characteristic is to be cancelled, it is sufficient to cancel them out with the voltage difference ΔVF of the diodes D1 and D2 and the forward voltage VF of the diodes (or the bipolar transistors connected as diodes). However, since V_{T} is 26 mV at ambient temperature, ln(KN) is only 4 if KN=55, so that the voltage difference ΔVF of the diodes D1 and D2 is only 104 mV (ΔVF=V_{T}ln(KN)=104 mV).

Hence, the temperature characteristic of ΔVF=V_{T}ln(KN) are +0.3412 mV/° C., viz., it is sufficient to set the forward voltage VF of the diode (or bipolar transistor connected as diode) to 1/5.5686 and to carry out weighted summation. The voltage-dividing resistors R1, R2 are set to sufficiently large values and the current flowing in the voltage-dividing resistor is discounted. If VF2 is about 579 mV at ambient temperature, the divided voltage is 104 mV, and about 208 mV is obtained as a weighted-summed constant voltage having temperature characteristic cancelled. VF1 at this time is about 683 mV at ambient temperature.

In FIG. 42, the voltage-dividing resistor R1 is connected to VB. However, similar characteristics may be obtained if the resistor is connected to VA.

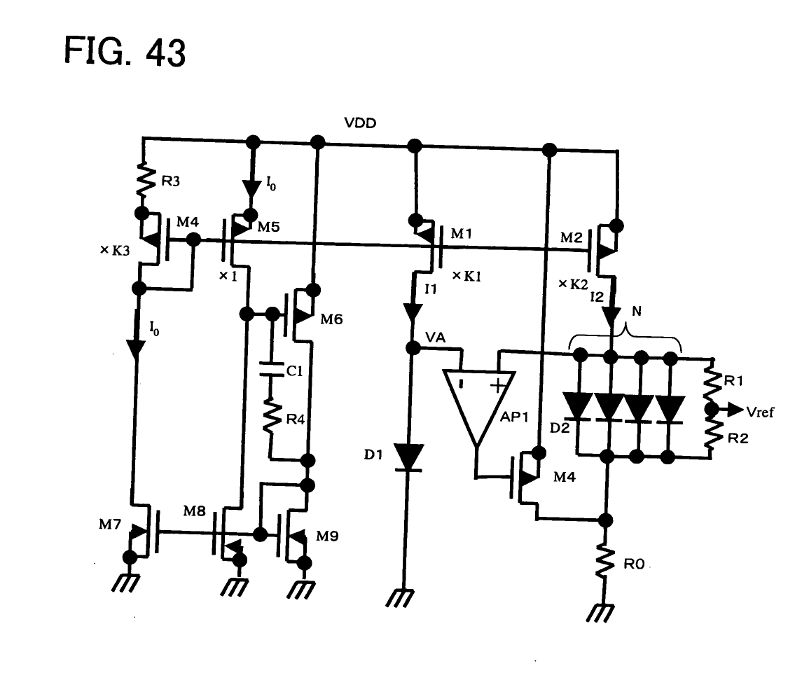

FIG. 43 shows an illustrative circuit in which, in a circuit shown in FIG. 42, the constant current I₀ is supplied from a reference voltage generating circuit that uses a reverse Widlar current mirror circuit arranged as a self-bias circuit. I₀ has a positive temperature characteristic. It should be noted however that ΔV_{F} is not higher than approximately 100 mV even at ambient temperature.

The values of simulation result are shown below. If, with VDD=1.2V, N and K1 to K3 are set so that N=6, K1=2, K2=9 and K3=4, and R1 to R4 and C1 are such that R0 =70 kΩ, R1=2187 kΩ, R2=200 kΩ, R3=250 kΩ, R4=500 kΩ and C1 is 50 pF, the values of Vref are:

145.36 mV at −53° C.,

145.362 mV at −40° C.

145.07 mV at 27° C. and

145.35 mV at 103° C.

so that upside-down cup shaped characteristic has been obtained. The width of the temperature variations is suppressed to 0.68%.

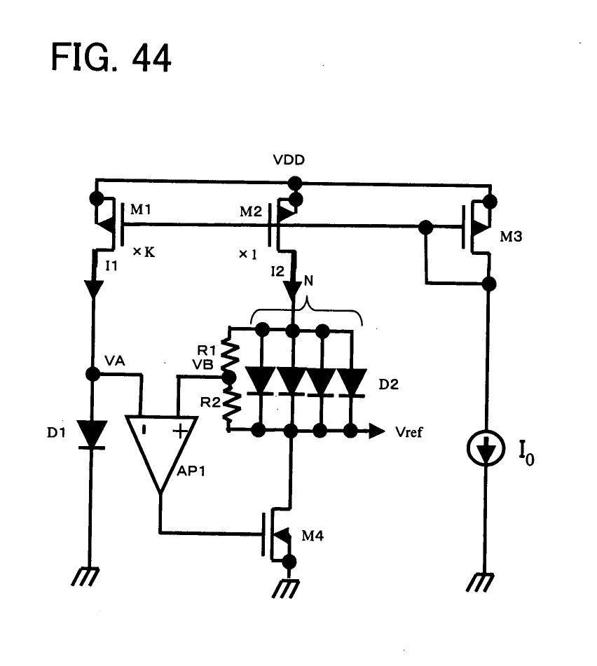

FIG. 44 is a diagram showing the circuit configuration of a CMOS reference voltage generating circuit for claim 20 of the present invention. In the circuit shown in FIG. 42, the value of ΔVF, with positive temperature characteristic, generated against the ground, is at most about 100 mV or less, even at ambient temperature. Hence, it is necessary to specifically deign the circuit to provide a positive circuit operation. To this end, the circuit configuration shown in FIG. 44 may possibly be used.

In FIG. 44, MOS transistors M1 to M3 constitute a current mirror circuit with the current ratio of K:1:1, so that, by the MOS transistor M3, driven by the constant current I₀, I1 (=K10) and I2 (=I0) flow through the MOS transistors M1 and M2, respectively. The common gate voltage is controlled by the OP amp (AP1) so that two input terminal voltages of the OP amp will be equal to each other. The first current-to-voltage converter circuit is made up of a diode (or a transistor connected as diode), whereas the second current-to-voltage converter circuit is made up of a diode (or a transistor connected as diode) and voltage-dividing resistors R1 and R2.

The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N.

Specifically, a sole diode D1 is used for the first current-to-voltage converter circuit, while two to four diodes D2 are parallel-connected for the second current-to-voltage converter circuit.

The opposite terminal of the diode (or the bipolar transistor connected as diode) D1 of the first current-to-voltage converter circuit is grounded, whereas the opposite terminals of the diodes (or the bipolar transistors connected as diodes) D2 of the second current-to-voltage converter circuit are connected to the gate of the transistor controlled by the output voltage of the OP amp (AP1), and control is exercised so that the terminal voltage of the first current-to-voltage converter circuit will be equal to the divided voltage of the second current-to-voltage converter circuit.

The reference voltage Vref is output from the lower electrodes of the diodes (or the bipolar transistors connected as diodes) D2 of the second current-to-voltage converter circuit.

The operation of the present embodiment is now described. Referring to FIG. 44, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1 and I2 from the current mirror circuit is K:1,

I1=K1₀ (165)

and

I2=I₀ (166)

If D1 is a unit diode (or a bipolar transistor connected as a diode), and D2 are N parallel-connected unit diodes (or bipolar transistors connected as diodes), the voltage difference ΔVF of D1 and D2 is expressed as

ΔVF=VF1−VF2=V_{T}ln(KN) (167)

Since V_{T} has a positive temperature characteristic of 0.0853 mV/° C., the voltage difference has a positive temperature characteristic, and is included in a voltage appearing across the ground and the output voltage of the OP amp (AP1).

On the other hand, the forward voltage VF1 of D1 has a negative temperature characteristic of about −1.9 mV/° C. Since the forward voltage VF2 of D2 also has a negative temperature characteristic of about −1.9 mV/° C., the temperature characteristic of the voltage as divided by the voltage-dividing resistors R1, R2 is diminished in keeping with the voltage-dividing resistance ratio such that

$$\begin{matrix}V A = VF 1 = VB & ( 168 ) \\ and & \\ {V}_{B} = {V}_{ref} + \frac{{R}_{2}}{{R}_{1} + {R}_{2}} {V}_{F 2} & ( 169 ) \\ Therefore , & \\ \begin{matrix}{V}_{ref} = {V}_{F 1} - \frac{{R}_{2}}{{R}_{1} + {R}_{2}} {V}_{F2} \\ = \frac{{R}_{1}}{{R}_{1} + {R}_{2}} ( {V}_{F 1} + \frac{{R}_{2}}{{R}_{1}} Δ {V}_{F} ) \\ = \frac{{R}_{1}}{{R}_{1} + {R}_{2}} \{ {V}_{F 1} + \frac{{R}_{2}}{{R}_{1}} {V}_{T} ln ( KN ) \}\end{matrix} & ( 170 )\end{matrix}$$

It is noted that {VF1+(R2/R1)V_{T}ln(KN)} may be set to a voltage value on the order of 1.2V having temperature characteristic cancelled. Specifically, VF1 has a negative temperature characteristic of about −1.9 mV/° C., whereas V_{T} has a positive temperature characteristic of 0.0853 mV/° C., so that, for canceling out temperature characteristic, it is sufficient to set the value of (R2/R1)V_{T}ln(KN) to about 22.27 to cancel out the temperature characteristic. Also, since V_{T} is 26 mV at ambient temperature, (R2/R1)V_{T}ln(KN) is about 579 mV at ambient temperature. Therefore, if VF1 is 626 mV at ambient temperature, {VF1+(R2/R1)V_{T}ln(KN)} is about 1.205V.

The reference voltage Vref, thus obtained, is a constant voltage which is divided by resistances and multiplied by R1/(R1+R2) and which may be set to 1.205V or less. That is, the reference voltage Vref is a constant voltage having temperature characteristic cancelled. Hence, the voltage may be used as reference voltage.

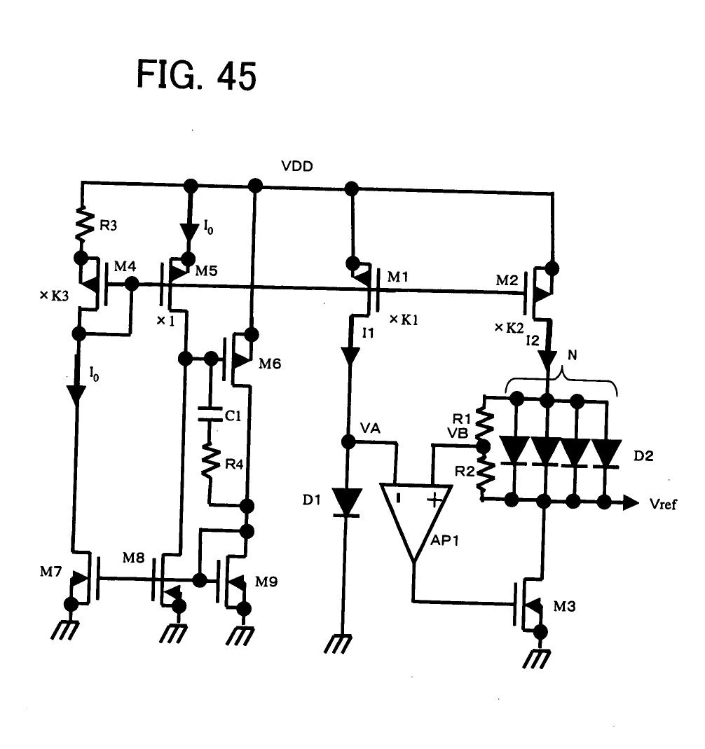

FIG. 45 depicts a circuit configuration of an embodiment of a CMOS reference voltage generating circuit of the present invention (claim 20). FIG. 45 shows an illustrative circuit in which, in a circuit shown in FIG. 44, the constant current lo is supplied from a reference voltage generating circuit that uses a reverse Widlar current mirror circuit arranged as self-bias circuit. The current I₀ has a positive temperature characteristic.

The values of simulation result are shown below. If, with VDD=1.2V, N and K1 to K3 are set so that N=6, K1=2, K2=9 and K3=4, and R1 to R4 and C1 are such that R1=200 kΩ, R2=2220 kΩ, R3=250 kΩ, R4=500 kΩ and C1 is 50 pF, the values of Vref are:

144.94 mV at −53° C.,

145.28 mV at −0° C.

145.34 mV at 27° C. and

144.9 mV at 103° C.

so that upside-down cup shaped characteristic has been obtained. The width of the temperature variations is suppressed to less than 1% for a constant power supply voltage.

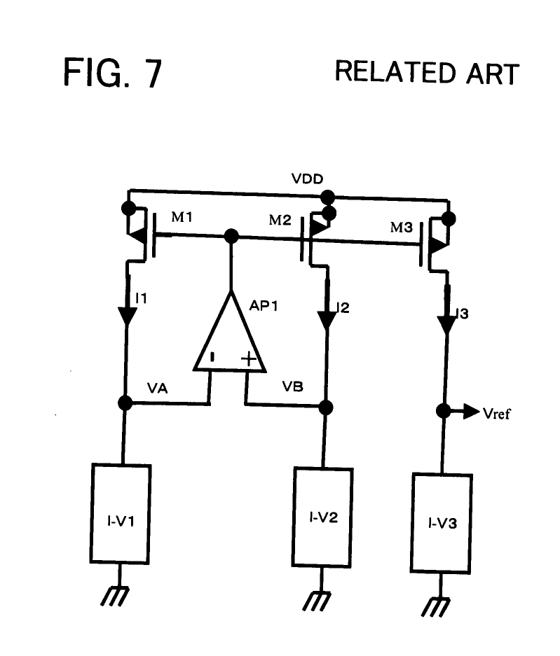

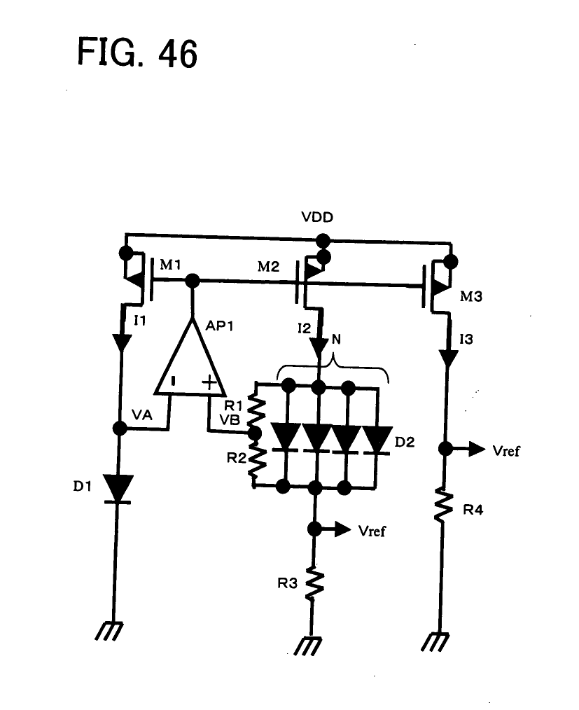

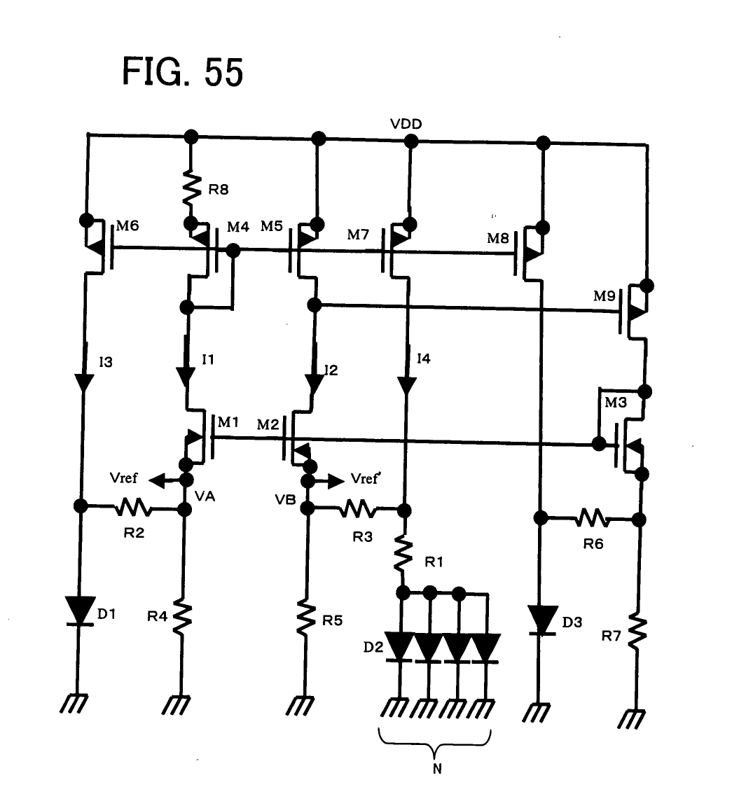

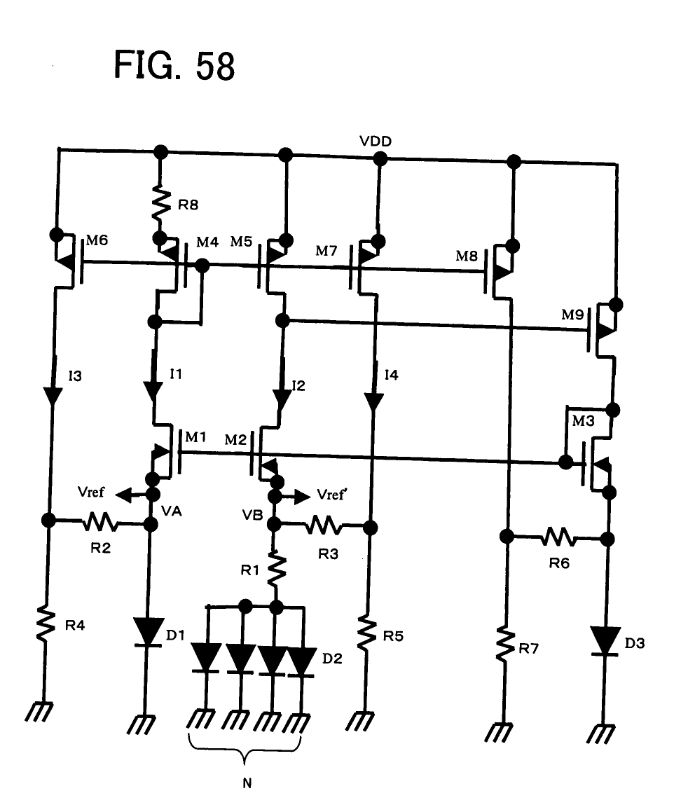

FIG. 46 is a diagram showing the circuit configuration of a CMOS reference voltage generating circuit for an embodiment of the present invention. The circuit of FIG. 55 is designed as a self-bias circuit and the reference voltage generating circuit shown in FIG. 45 may be dispensed with. The reference voltage generating circuit shown in FIG. 58 is also of the circuit topology shown in FIG. 7.

In FIG. 46, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other. The first current-to-voltage converter circuit for comparison is made up of a diode (or a bipolar transistor connected as diode), whereas the second current-to-voltage converter circuit is made up of diodes (or bipolar transistors connected as diodes), voltage-dividing resistors R1, R2 and a resistor R3 connected in series with the diodes/resistors.

The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four diodes D2 are parallel-connected for the second current-to-voltage converter circuit.

The opposite terminal of the diode (or the bipolar transistor connected as diode) D1 of the first current-to-voltage converter circuit is grounded, whereas the opposite terminals of the diodes (or the bipolar transistors connected as diodes) D2, voltage-dividing resistors R1, R2 and the resistor R3 connected in series with the resistors/diodes of the second current-to-voltage converter circuit, are grounded. Control is exercised so that the terminal voltage of the first current-to-voltage converter circuit will be equal to the divided voltage of the second current-to-voltage converter circuit.

The reference voltage Vref is output by converting the current I3 into a voltage by a resistor R4.

The operation of the present embodiment is now described. Referring to FIG. 46, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1, I2 and I3 from the current mirror circuit is 1:1:1,

I₁=I₂=I₃ (171)

It is assumed that D1 is a unit diode (or a bipolar transistor connected as a diode), and D2 are N parallel-connected unit diodes (or bipolar transistors connected as diodes). It is also assumed that the voltage-dividing resistors R1, R2 are set to sufficiently large values so that the currents flowing through these voltage-dividing resistors may be discounted. The voltage difference ΔVF of D1 and D2 is expressed as

ΔVF=VF1−VF2=V_{T}ln(N) (172)

where V_{T} has a positive temperature characteristic and hence the voltage difference has a positive temperature characteristic.

On the other hand, the forward voltage VF1 of D1 has a negative temperature characteristic of about −1.9 mV/° C.

The forward voltage VF2 of D2 also has a negative temperature characteristic of about −1.9 mV/° C. Hence, the temperature characteristic of the voltage, divided by the voltage-dividing resistors R1 and R2, is diminished in keeping with the voltage-dividing resistance ratio such that

$$\begin{matrix}V A = VF 1 = VB & ( 173 ) \\ and & \\ {V}_{B} = {I}_{2} {R}_{3} + \frac{{R}_{2}}{{R}_{1} + {R}_{2}} {V}_{F 2} & ( 174 ) \\ Hence , & \\ \begin{matrix}{I}_{2} = \frac{1}{{R}_{3}} ( {V}_{F 1} - \frac{{R}_{2}}{{R}_{1} + {R}_{2}} {V}_{F 2} ) \\ = \frac{1}{{R}_{3}} \frac{{R}_{1}}{{R}_{1} + {R}_{2}} ( {V}_{F 1} + \frac{{R}_{2}}{{R}_{1}} Δ {V}_{F} ) \\ = \frac{1}{{R}_{3}} \frac{{R}_{1}}{{R}_{1} + {R}_{2}} \{ {V}_{F 1} + \frac{{R}_{2}}{{R}_{1}} {V}_{T} ln ( N ) \}\end{matrix} & ( 175 ) \\ Hence , & \\ \begin{matrix}{V}_{ref} = {I}_{3} {R}_{4} \\ = \frac{{R}_{4}}{{R}_{3}} \frac{{R}_{1}}{{R}_{1} + {R}_{2}} \{ {V}_{F 1} + \frac{{R}_{2}}{{R}_{1}} {V}_{T} ln ( N ) \}\end{matrix} & ( 176 )\end{matrix}$$

It is noted that {VF1+(R2/R1)V_{T}ln(N)} can be set to a voltage value of the order of 1.2V from which temperature characteristic have been cancelled. Specifically, VF1 has a negative temperature characteristic of about −1.9 mV/° C., whereas V_{T} has a positive temperature characteristic of 0.0853 mV/° C., so that, for canceling out temperature characteristic, it is sufficient to set the value of (R2/R1)V_{T}ln(KN) to about 22.27 to cancel out the temperature characteristic. Also, since V_{T} is 26 mV at ambient temperature, (R2/R1)V_{T}ln(N) is about 579 mV at ambient temperature. Therefore, if VF1 is 626 mV at ambient temperature, {VF1+(R2/R1)V_{T}ln(KN)} is about 1.205V.

The reference voltage Vref, thus obtained, is a constant voltage which is divided by resistances and multiplied by R4/R3){R1/(R1+R2)} and which may be set to 1.205V or less. That is, the reference voltage Vref is a constant voltage having temperature characteristic cancelled and hence may be used as reference voltage.

In the above-mentioned description, the terminal voltage of the register R4 is used as the reference voltage. However, the reference voltage may well be changed to the terminal voltage of the register R3. In FIG. 46, assuming that the terminal voltage of the register R3 is Vref′, since control is performed by the OP amp (AP1) such that VA=VB, the following equation holds:

$${V}_{F 1} = {Vref}^{′} + \frac{{R}_{2}}{{R}_{1} + {R}_{2}} {V}_{F 2} \qquad ( 177 )$$

where VF1 and VF2 are diode forward voltages of respective D1 and D2.

Vref′ is expressed as follows:

$$\begin{matrix}{Vref}^{′} = {V}_{F 1} - \frac{{R}_{2}}{{R}_{1} + {R}_{2}} {V}_{F 2} = {V}_{F 1} - {V}_{F 2} + \frac{{R}_{1}}{{R}_{1} + {R}_{2}} {V}_{F 2} \\ = Δ {V}_{F} + \frac{{R}_{1}}{{R}_{1} + {R}_{2}} {V}_{F 2} = α {V}_{F 2} + Δ {V}_{F} ( α < 1 )\end{matrix} \qquad ( 178 )$$

Here, since I1=I2, we have:

$$Δ {V}_{F} = {V}_{T} ln ( \frac{N}{1 - \frac{{V}_{F 2}}{{I}_{1} ( {R}_{1} + {R}_{2} )}} ) \qquad ( 179 )$$

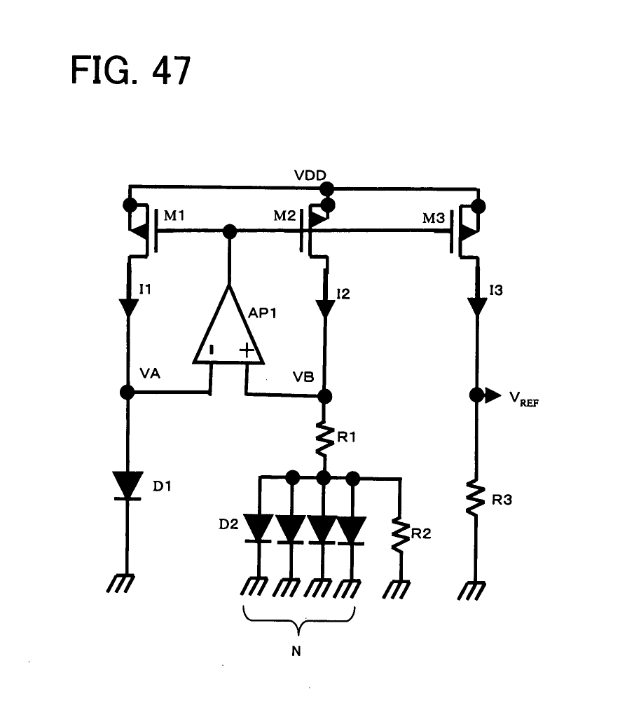

### From (179), we see that the reference voltage generating circuit shown in FIG. 46 is capable of improving the non-linear temperature characteristic of the diode, as the reference voltage generating circuit shown in FIG. 47.

The reference voltage of the equation (178) is a low voltage, such as several times 50 mV, as with ones of FIGS. 42, 43, 44, and 45. In case of the number N of diodes D2 connected in parallel being set to 148, the reverence voltage is about 250 mV. In general, the target value of the reference voltage is set to 200 mV. With the reference voltage generating circuit shown in FIG. 46, the reference voltage is speculated by the number N (log) of diodes D2 connected in parallel, for example,

100 mV@N≈3, 105 mV@N≈20, 200 mV@N≈55, 250 mV@N≈148.

The voltage obtained is far from the band-gap voltage of Si. The reason why the present inventor doesn't call it the band-gap reference but call it voltage reference would be understood.

It should be noted that in the equations (177) and (178), R3 is not present. Actually,

Vref′=R3I2 (180)

### The values of simulation result are shown below.

If, with VDD=1.3V, N and R1 to R3 are set so that N=140, R1=2.8 kΩ, R2=13.79 kΩ, and R3=1 kΩ, the reference voltage Vref′ are:

240.782 mV at −53° C.,

240.892 mV at −20° C.,

240.884 mV at 20° C.,

240.912 mV at 60° C. and

240.772 mV at 103° C.

so that the characteristic with a shape of two peaks is obtained. The temperature variation range is suppressed to 0.06%. As described above, other than the conventional voltage Vref=VBE1+KΔVBE≈1.2V (K>>1), the temperature compensated reference voltage or the reference voltage having the temperature non-linearity of VBE of a bipolar transistor or diode compensated can be obtained by Vref′=αVBE+ΔVBE (α<1).

FIG. 47 depicts a diagram showing the circuit configuration of an embodiment of a CMOS reference voltage generating circuit of the present invention. The reference voltage generating circuit shown in FIG. 47 again is of the circuit topology shown in FIG. 7. In FIG. 47, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other.

The first current-to-voltage converter circuit for comparison is made up of a diode (or a bipolar transistor connected as diode) D1, whereas the second current-to-voltage converter circuit is made up of parallel connection of diodes (or bipolar transistors connected as diodes) D2 and a resistor R2, and a resistor R1 connected in series with the resistor/diodes. The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a singe diode D1 is used for the first current-to-voltage converter circuit, while two to four parallel-connected diodes D2 are used for the second current-to-voltage converter circuit.

The reference voltage Vref output has been converted from the current I3 by a resistor R3.

The operation of the present embodiment is now described. Referring to FIG. 47, with the forward voltages VF1 and VF2 of the diodes (or bipolar transistors connected as diodes) D1 and D2, the OP amp (AP1) exercises control so that the voltages at the two input terminals will be equal to each other (VA=VB). Since I-V1 is a single diode, VA=VF1.

Since the current ratio of the output currents I1 to I3 from the current mirror circuit is 1:1:1,

$${I}_{1} = {I}_{2} = {I}_{3} = \frac{{V}_{F 1} - {V}_{F 2}}{{R}_{1}} = \frac{Δ {V}_{F}}{{R}_{1}} \qquad ( 181 )$$

The reference voltage Vref obtained is expressed as

V_{ref}=R₃I₃=ΔV_{F}R₃/R₁ (182)

The following expression:

$$Δ {V}_{F} = {V}_{T} ln ( \frac{N}{1 - \frac{{V}_{F 2}}{{I}_{1} {R}_{2}}} ) \qquad ( 182 )$$

is also valid.

Since V_{T} is proportional to the absolute temperature, it is varied in a range from 224/300˜1˜376/300 for temperature changes of ±76° C. The exponential value is in a range of 2.10995˜2.71828˜3.501997 corresponding to the rate of change of −22.4%˜0%˜+28.8%. However, since the width of temperature change of ±76° C. is 152°, the rate of change of 51.2% divided by the width of temperature change gives a value of −0.337%° C. at most. It appears that this order of temperature change may be taken care of by {1−V_{F1}/(I₁R₂)}/{(1−V_{F2}/(I₁R₃)}.

The values of simulation result are shown below. If, with VDD=1.3V, N and R1 to R3 are set so that N=3, R1=6.8065 kΩ, R2=120 kΩ and R3=20 kΩ, the values of Vref are:

168.872 mV at −53° C.,

165.593 mV at −20° C.,

165.637 mV at 0° C.,

165.77 mV at 27° C.,

165.873 mV at 60° C. and

165.592 mV at 107° C.

so that a wave shaped characteristic has been obtained. The width of the temperature variations is suppressed to 0.17%.

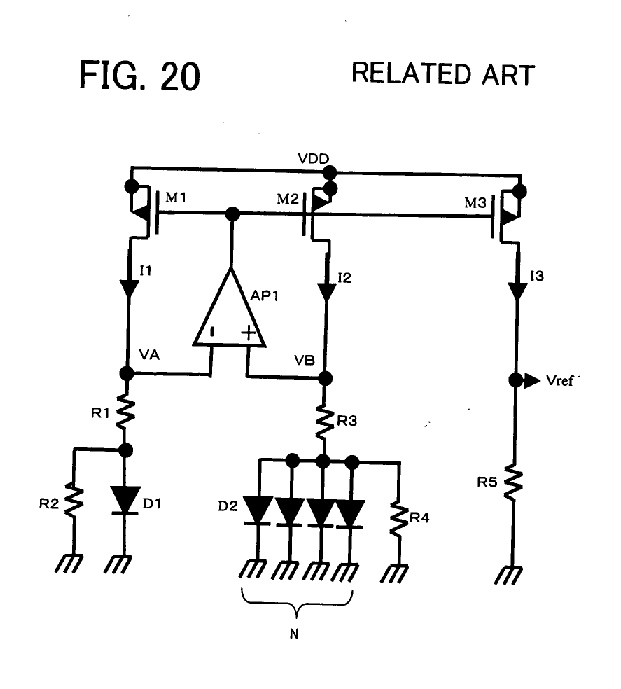

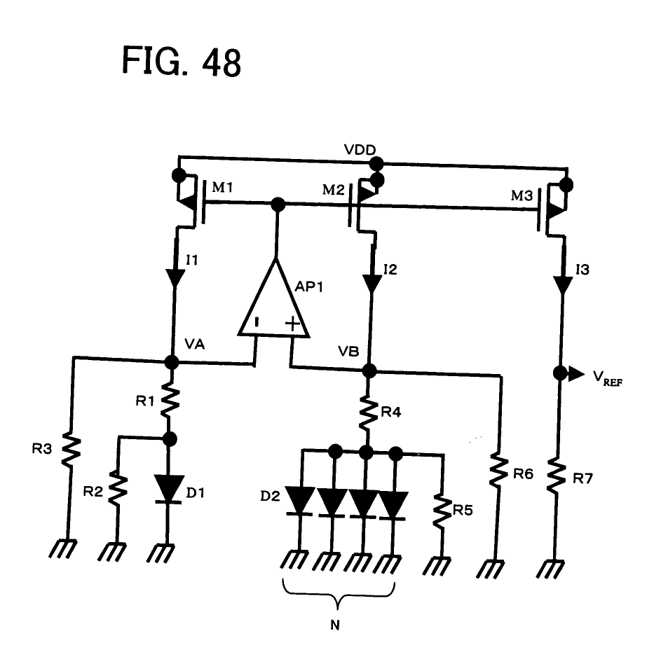

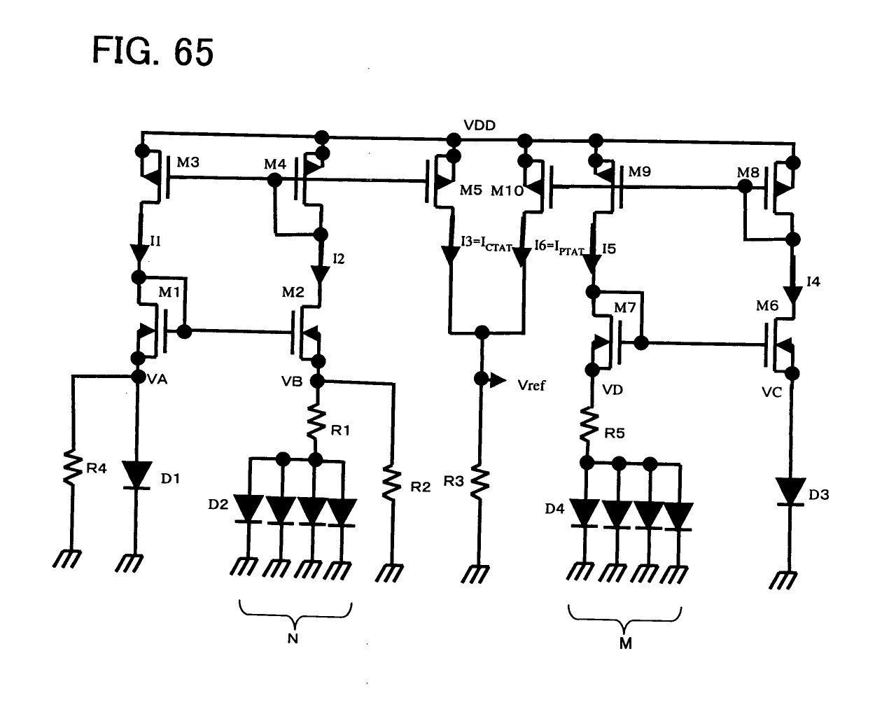

FIG. 48 depicts a diagram showing the circuit configuration of an embodiment of a CMOS reference voltage generating circuit of the present invention. The reference voltage generating circuit, shown in FIG. 65, is the reference voltage generating circuit of FIG. 20 added by resistors connected in parallel with the first current-to-voltage converter circuit I-V1 and the second current-to-voltage converter circuit I-V2. The reference voltage generating circuit, shown in FIG. 48, is also of the circuit topology shown in FIG. 7.

In FIG. 48, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other.

The first current-to-voltage converter circuit for comparison is made up of a diode (or a bipolar transistor connected as diode) D1, a resistor R2 connected in parallel with D1, a resistor R1 connected in series with D1 and R2, and a resistor R3 connected in parallel with R1, R2 and D1. The second current-to-voltage converter circuit is made up of diodes (or bipolar transistors connected as diodes) D2, a resistor R5 connected in parallel with D2, a resistor R4 connected in series with D2 and R5, and a resistor R6 connected in parallel with R4, R5 and D2.

Thus, the circuit topologies of the first and second current-to-voltage converter circuits are the same, and hence the device matching may be expected to be improved. However, the number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four parallel-connected diodes D2 are used for the second current-to-voltage converter circuit.

The reference voltage Vref output has been converted from the current I3 by a resistor R4.

The operation of the present embodiment is now described. Referring to FIG. 48, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1 to I3 from the current mirror circuit is 1:1:1,

$${I}_{1} = \frac{{V}_{A} - {V}_{F 1}}{{R}_{1}} + \frac{{V}_{A}}{{R}_{3}} = \frac{{V}_{B} - {V}_{F 2}}{{R}_{4}} + \frac{{V}_{B}}{{R}_{6}} = {I}_{2} \qquad ( 223 )$$

Since the OP amp (AP1) exercises control to VA=VB,

$$\begin{matrix}{I}_{1} = \frac{{V}_{A} - {V}_{F 1}}{{R}_{1}} + \frac{{V}_{A}}{{R}_{3}} = \frac{{V}_{B} - {V}_{F 2}}{{R}_{4}} + \frac{{V}_{B}}{{R}_{6}} = {I}_{2} & \end{matrix} \qquad ( 224 )$$

may be obtained from the equation (223).

Hence,

$${I}_{1} = {I}_{2} = \frac{{R}_{3} ( {R}_{4} + {R}_{6} ) {V}_{F 1} - {R}_{6} ( {R}_{1} + {R}_{3} ) {V}_{F 2}}{{R}_{3} {R}_{4} {R}_{6} + {R}_{1} {R}_{3} {R}_{6} - {R}_{6} {R}_{1} {R}_{3} - {R}_{1} {R}_{3} {R}_{4}} = {I}_{3} \qquad ( 225 )$$

The reference voltage Vref obtained may be expressed as

$$\begin{matrix}{V}_{ref} {R}_{7} {I}_{3} = \frac{{R}_{7} \{ {R}_{3} ( {R}_{4} + {R}_{6} ) {V}_{F 1} - {R}_{6} ( {R}_{1} + {R}_{3} ) {V}_{F 2} \}}{{R}_{3} {R}_{4} {R}_{6} + {R}_{1} {R}_{3} {R}_{6} - {R}_{6} {R}_{1} {R}_{3} - {R}_{1} {R}_{3} {R}_{4}} \\ = \frac{{R}_{7} \{ ( {R}_{3} {R}_{4} {V}_{F 1} - {R}_{6} {R}_{1} {V}_{F 2} ) + {R}_{3} {R}_{6} Δ {V}_{F} \}}{{R}_{3} {R}_{4} {R}_{6} + {R}_{1} {R}_{3} {R}_{6} - {R}_{6} {R}_{1} {R}_{3} - {R}_{1} {R}_{3} {R}_{4}}\end{matrix} \qquad ( 226 )$$

Qualitatively, with R₃R₄>R₁R₆, (R₃R₄V_{F1}−R₁R₆V_{F2}) has a negative temperature characteristic, whereas R₃R₆ΔV_{F} has a negative temperature characteristic, resulting in cancellation of temperature characteristic.

The values of simulation result are shown below. If, with VDD=1.3V, N and R1 to R7 are set so that N=2, R1=1.2 kΩ, R2=76 kΩ, R3=97 kΩ, R4=2.00505 kΩ, R5=35 kΩ, R6=100 kΩ and R7=10 kΩ, the values of Vref are:

448.564 mV at −53° C.,

448.3898 mV at −20° C.,

448.4137 mV at 0° C.,

448.4928 mV at 27° C.,

448.5612 mV at 70° C. and

448.446 mV at 107° C.

so that a wave shaped characteristic has been obtained. The width of the temperature variations is suppressed to an extremely low value of 0.039% for a constant power supply value.

### List of Width of Temperature Variations of the Conventional and Inventive Circuits

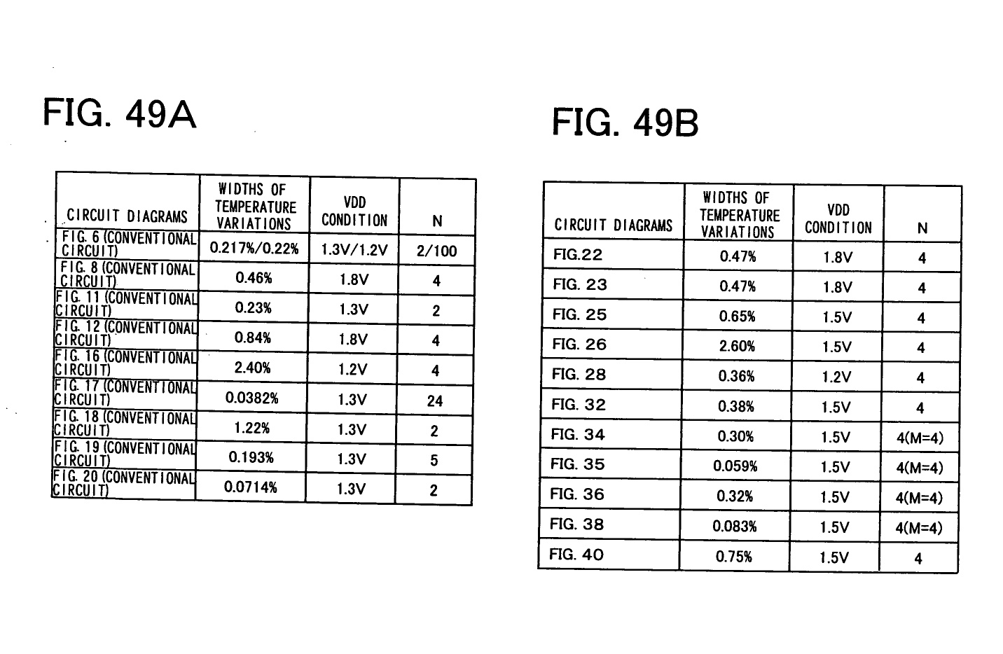

For comparing the circuit of the present invention and the conventional circuit, FIGS. 49A and 49B show the width of temperature variations of main conventional circuits and circuits of the present invention.

### Other Embodiment of the Invention

In the embodiments of claims 1 and 2 (FIGS. 21 and 22), described above, the OP amp is used as control means to provide for equal values of preset voltages.

It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158 A1) or JP Patent Kokai Publication No. JP-P2006-133916A (US Patent 2006/0091875 A1) by the same inventor as the present inventor.

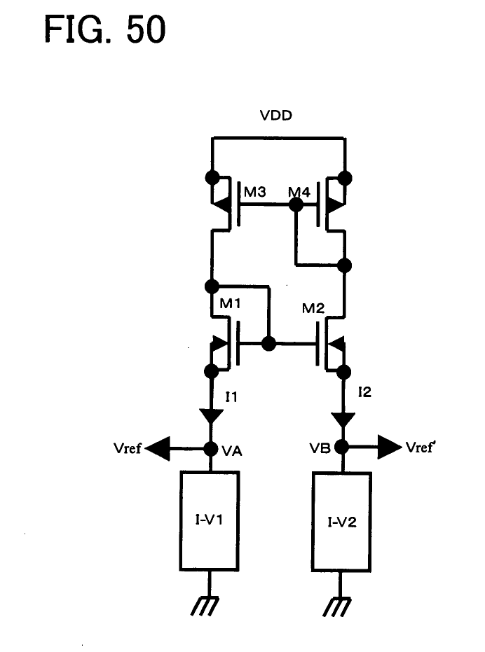

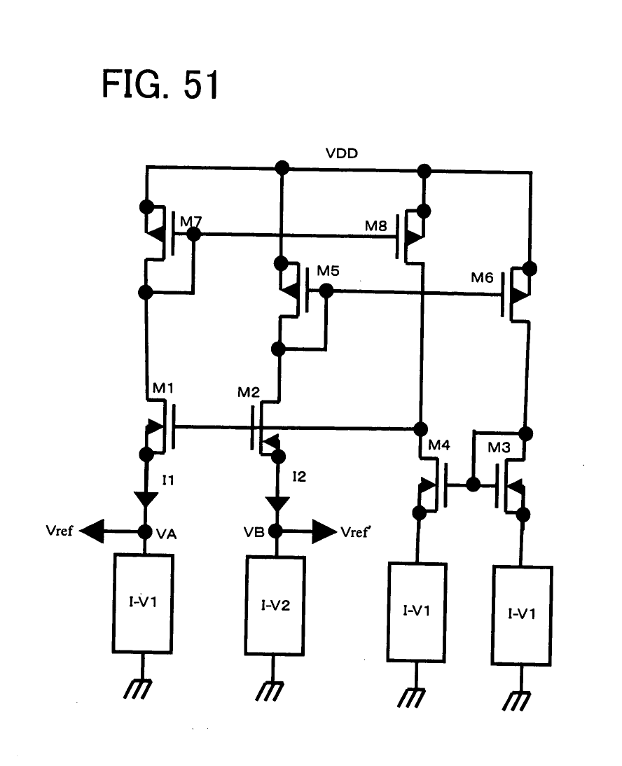

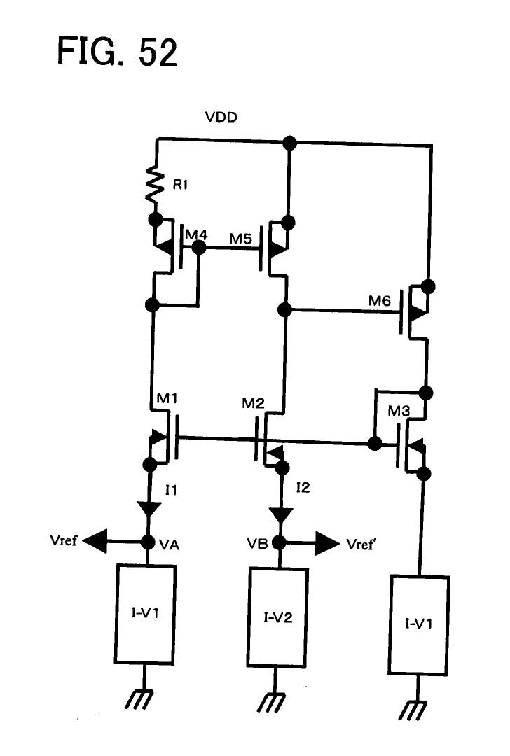

FIG. 21, as a circuit block, as an origin of the specified reference voltage generating circuit of FIG. 22, is developed as shown in FIGS. 50 to 52. For reducing the chip size, it is preferred to select, as the I-V converter in a control circuit, the first current-to-voltage converter circuit I-V1 with a smaller number of diodes, as shown in FIGS. 51 and 52. However, the second current-to-voltage converter circuit (I-V2), with a larger number of diodes, may give the same meritorious effect insofar as the circuit operation is concerned.

In FIG. 50, the gates of n-channel transistors M1 and M2 are connected in common, and M1 has a gate and a drain connected together. The gates of p-channel transistors M3 and M4 are connected in common, and M4 has a gate and a drain connected together. Hence, the n-channel transistors M1 and M2 and the p-channel transistors M3 and M4 each constitute a current mirror circuit. The current mirror circuit of the p-channel transistors M3 and M4 self-biases the current mirror circuit of the n-channel transistors M1 and M2.

Hence, the current I1 flows through transistors M1, M3 to drive the first current-to-voltage converter circuit (I-V1) to generate an output voltage Vref. Similarly, the current I2 flows through transistors M2, M4 to drive the second current-to-voltage converter circuit (I-V2) to generate an output voltage Vref′. The first current-to-voltage converter circuit (I-V1) includes a series connection of a diode and a resistor, as shown in FIG. 22, whereas the second current-to-voltage converter circuit (I-V2) also includes a series connection of N parallel-connected diodes and a resistor.

The operation of the present embodiment is now described. By self-biasing, the OP amp in the configuration of FIG. 21 may be dispensed with.

In FIG. 50, the gates of n-channel transistors M1 and M2 are connected in common, and M1 has a gate and a drain connected together. The gates of p-channel transistors M3 and M4 are connected in common, and M4 has a gate and a drain connected together. Hence, the n-channel transistors M1 and M2 and the p-channel transistors M3 and M4 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 are equal to each other. Hence, the terminal voltage VA of the first current-to-voltage converter circuit (I-V1) is equal to the terminal voltage VB of the second, current-to-voltage converter circuit (I-V2), thus achieving the same operating conditions as those with the use of the OP amp as described above. That is, the characteristic equivalent to that of FIG. 21 may be achieved, thus implementing a reference voltage generating circuit.

However, the above-described reference voltage generating circuit, shown in FIG. 50, may be affected by transistor channel length modulation. For simplicity, the startup circuit is dispensed with.

### Other Embodiment of the Invention

In FIG. 51, n-channel transistors M1 and M2, p-channel transistors M7 and M5 and n-channel transistors M3 and M4 each constitute a current mirror circuit. The n-channel transistors M1 and M2 have sources connected to the first and second current-to-voltage converter circuits (I-V1), (I-V2). The p-channel transistors M7, M5 are connected between the drains of the n-channel transistors M1 and M2 and the power supply VDD, and have drains and gates connected together. The n-channel transistors M3 and M4 have sources connected to two first current-to-voltage converter circuits (I-V1), while having gates connected in common. There are connected n-channel transistors M8 and M6 between the drains of the n-channel transistors M3 and M4. The power supply VDD, and the gates of the n-channel transistors M1 and M2, are connected in common and connected to the drain of the n-channel transistor M4. The p-channel transistors M5 and M6 have gates coupled together to form a current mirror circuit, while the p-channel transistors M7 and M8 have gates coupled together to form a current mirror circuit.

Hence, the current I1 flows through the transistors M1, M7 to drive the first current-to-voltage converter circuit (I-V1) to produce the output voltage Vref. Similarly, the current I2 flows through the transistors M2, M5 to drive the second current-to-voltage converter circuit (I-V2) to produce the output voltage Vref.

Referring to FIG. 22, the first current-to-voltage converter circuit (I-V1) is made up of a series connection of a diode and a resistor, whereas the second current-to-voltage converter circuit (I-V2) is made up of a series connection of N parallel-connected diodes and a resistor.

The operation of the present embodiment is now described. The currents flowing through the n-channel transistors M1 and M2, connected to the first and second current-to-voltage converter circuits, are compared to each other via the current mirror circuits made up of the p-channel transistors M5 and M6 and the p-channel transistors M7 and M8, in the current mirror circuit made up of the n-channel transistors M3 and M4. The common gate voltage of the n-channel transistors M1 and M2 is controlled so that the currents flowing through the n-channel transistors M1 and M2 will be equal to each other.

Hence, the gate source voltages of the n-channel transistors M1 and M2 are equal to each other, and hence the voltage VA applied to the first current-to-voltage converter circuit becomes equal to the voltage VB applied to the second current-to-voltage converter circuit to achieve the operating condition equivalent to that with the OP amp described above. That is, the characteristic similar to that FIG. 22 may be achieved to implement the reference voltage generating circuit. The two first current-to-voltage converter circuits (I-V1) are inserted so that the drain voltages of the n-channel transistors M3 and M4 will be equal to each other.

In FIG. 52, a resistor R1 is connected between the source of the p-channel transistor M4 and the power supply VDD. Since the p-channel transistor M4 has the gate voltage in common with the p-channel transistor M5, the transistor size of the n-channel transistor M4 is selected to be larger than that of the p-channel transistor M5 so that equal currents will flow through the two transistors. The current mirror circuit, made up of the p-channel transistors M4, M5, constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3 and M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M3 and the p-channel transistors M4-M6, constitutes a negative feedback circuit, and controls the common gate voltage of the n-channel transistors M1 and M2 so that the currents through the n-channel transistors M1 and M2 will become of a preset value, herein equal to each other.

Since the gate source voltages of the n-channel transistors M1 and M2 become equal to each other, the voltage applied to the first current-to-voltage converter circuit becomes equal to that applied to the second current-to-voltage converter circuit, thus achieving the same operating condition as that of using the OP amp as described above. That is, the characteristic equivalent to that of FIG. 22 may be achieved, thus implementing the reference voltage generating circuit. It is noted that the two current-to-voltage converter circuits are inserted to provide for equal drain currents of the n-channel transistors M3 and M1.

### Other Embodiment of the Invention

In the above-described embodiment (FIG. 28) of the present invention (claim 7), the OP amp is used as control means for exercising control so that preset voltages will be equal to each other.

It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

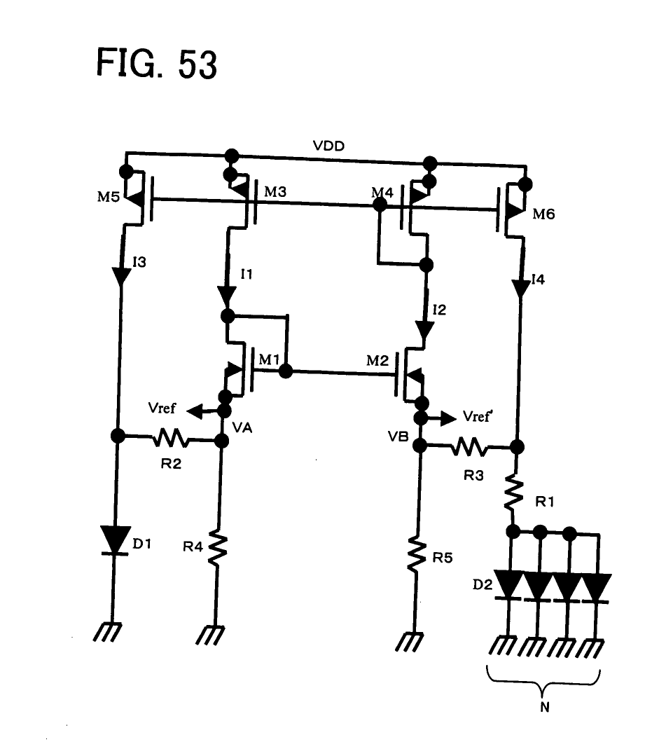

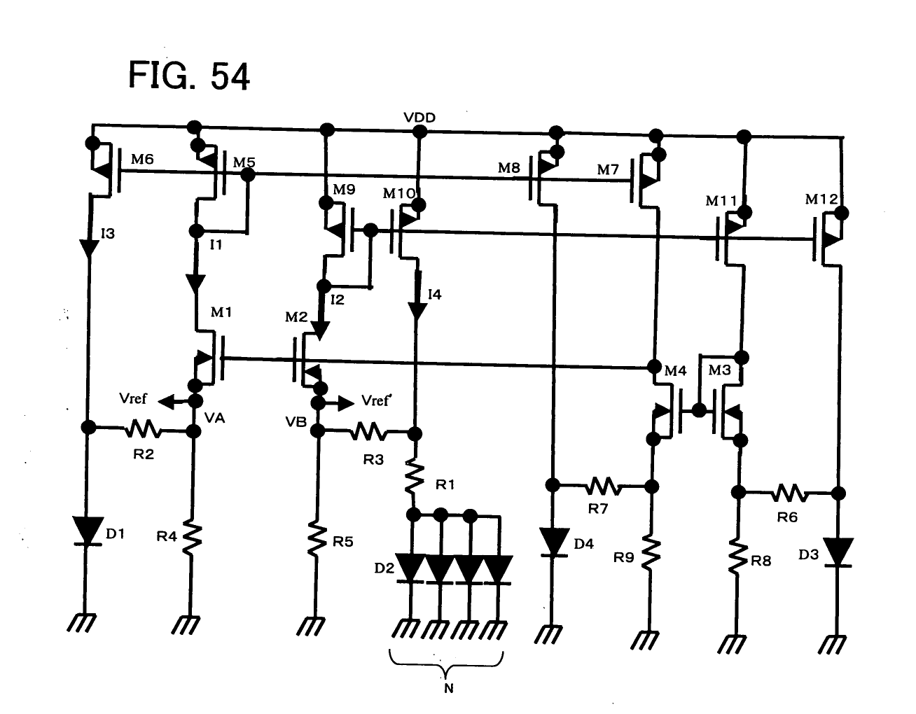

Specifically, the reference voltage generating circuit of FIG. 28 is developed as shown in FIGS. 53 to 55. For reducing the chip size, it is preferred to select, as the I-V converter in a control circuit, the first current-to-voltage converter circuit I-V1 with a smaller number of diodes, as shown in FIGS. 54 and 55. However, the second current-to-voltage converter circuit (I-V2), with a larger number of diodes, may give the same meritorious effect insofar as the circuit operation is concerned.

In FIG. 53, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2 and the p-channel transistors M3 and M4, M5 and M6 each constitute a current mirror circuit. The current mirror circuit of the p-channel transistors M3 and M4 self-biases the current mirror circuit of the n-channel transistors M1 and M2.

Hence, the current I1 flows through transistors M1 and M3, while the current I3 flows through transistor M5 to drive the first current-to-voltage converter circuit (I-V1) of the π-type to generate an output voltage Vref as a terminal voltage of the resistor R4.

Similarly, the current I2 flows through transistors M2 and M4, whereas the current I4 flows through the transistor M6 to drive the second current-to-voltage converter circuit (I-V2) of the π-type, made up of resistors R3, R5, R1 and diodes D2 to generate an output voltage Vref′ from a terminal voltage of the resistor R5. The second current-to-voltage converter circuit (I-V2) is made up of a series connection of N parallel-connected diodes D2.

The operation of the present embodiment is now described. By self-biasing, the OP amp in the configuration of FIG. 28 may be dispensed with. In FIG. 53, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2 and the p-channel transistors M3, M4, M5 and M6 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents flowing through the n-channel transistors M1 and M2 are equal to each other.

With self-biasing, the gate source voltages of the n-channel transistors M1 and M2 are equal to each other. Hence, the terminal voltage VA of the resistor R4 of the first current-to-voltage converter circuit (I-V1) of the π-type, made up of resistors R2, R4 and diode D1, is equal to the terminal voltage VB of the resistor R5 of the second current-to-voltage converter circuit (I-V2) of the π-type, made up of resistors R3, R5, R1 and diodes D2, thus achieving the same operating conditions as those with the use of the OP amp as described above. That is, the characteristic equivalent to that of FIG. 28 may be achieved, thus implementing a reference voltage generating circuit.

However, the above-described reference voltage generating circuit, shown in FIG. 53, may be affected by transistor channel length modulation. For simplicity, the startup circuit is dispensed with.

### Other Embodiment of the Invention

In FIG. 54, n-channel transistors M1 and M2 have sources connected to a terminal of the resistor R4 of the π-type first current-to-voltage converter circuit (I-V1), constituted by the resistors R2 and R4 and the diode D1, and to a terminal of the resistor R5 of the π-type second current-to-voltage converter circuit (I-V2), constituted by the resistors R3, R5 and R1 and the diodes D2. There are p-channel MOS transistors M7 and M5, connected between the drains of the n-channel transistors M1 and M2 and the power supply VDD and having the drains and the gates connected together. The p-channel MOS transistors M7 and M5 constitute a current mirror circuit. There are n-channel transistors M3 and M4, having sources connected to two first current-to-voltage converter circuit (I-V1) and having the gates connected together. The n-channel transistors M3 and M4 also constitute a current mirror circuit. There are p-channel transistors M8 and M6, connected between the drains of the n-channel transistors M3 and M4 and the power supply VDD. The gates of n-channel transistors M1 and M2, are connected together and connected to the drain of the n-channel transistor M4. The p-channel transistors M5 and M6 have gates coupled together to constitute a current mirror circuit, whereas the p-channel transistors M7 and M8 have gates coupled together to constitute a current mirror circuit,

Hence, the current I1 flows through the transistors M1, M5, and the current I3 flows through transistor M6 to drive the π-type first current-to-voltage converter circuit (I-V1) made up of the resistors R2, R4 and the diode D2 to produce the output voltage Vref from the terminal voltage of the resistor R4.

Similarly, the current I2 flows through the transistors M2 and M9, and the current I4 flows through transistor M10 to drive the π-type second current-to-voltage converter circuit (I-V2) made up of the resistors R3, R5, R1 and the diodes D2 to generate the output voltage Vref′ from the terminal voltage of the resistor R5. The second current-to-voltage converter circuit (I-V2) has N parallel-connected diodes D2

The operation of the present embodiment is now described. In FIG. 54, the currents I1 and I2, flowing through the n-channel transistors M1 and M2, connected to the first and second π-type current-to-voltage converter circuits, are compared to each other via the current mirror circuit made up of the p-channel transistors M5-M8 and the current mirror circuit made up of the p-channel transistors M9-M12, in the current mirror circuit made up of the n-channel transistors M3 and M4. The common gate voltage of the n-channel transistors M1 and M2 is controlled so that the currents I1 and I2 flowing through the n-channel transistors M1 and M2 will be equal to each other. The first current-to-voltage converter circuit is made up of the resistors R2, R4 and the diode D1, whereas the second current-to-voltage converter circuit is made up of the resistors R3, R5, R1 and the diodes D2, as described above.

Thus, the gate source voltages of the n-channel transistors M1 and M2 are equal to each other, and hence the voltage VA applied to the first π-type current-to-voltage converter circuit (I-V1) becomes equal to the voltage VB applied to the second π-type current-to-voltage converter circuit to achieve the operating condition equivalent to that with the OP amp described above. That is, the characteristic similar to that FIG. 28 may be achieved to implement the reference voltage generating circuit. The two first current-to-voltage converter circuits (I-V1) (D4, R7, R9) and (D3, R6, R8) are inserted so that the channel voltages of the n-channel transistors M3 and M4 will be equal to each other. The first current-to-voltage converter circuit is made up of the resistors R2, R4 and the diode D1, whereas the second current-to-voltage converter circuit is made up of the resistors R3, R5, R1 and the diodes D2, as described above.

### Other Embodiment of the Present Invention

In FIG. 55, a resistor R8 is connected between the source of the p-channel transistor M4 and the power supply VDD. Since the p-channel transistor M4 has the gate voltage in common with the p-channel transistor M5, the transistor size of the n-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M9, the gate of which is connected to the drain of the p-channel transistor M5. This decreases the current flowing through the p-channel transistor M3 having the common drain current.

The n-channel transistors M3 and M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M3 and the p-channel transistors M4-M9 constitutes a negative feedback circuit, and controls the common gate voltage of the n-channel transistors M1 and M2 so that the currents through the n-channel transistors M1 and M2 will become a preset value, herein equal to each other.

Since the gate source voltages of the n-channel transistors M1 and M2 become equal to each other, the voltage applied to the first current-to-voltage converter circuit becomes equal to that applied to the second current-to-voltage converter circuit, thus achieving the same operating condition as that of using the OP amp as described above. That is, the characteristic equivalent to that of FIG. 28 may be achieved, thus implementing the reference voltage generating circuit. It is noted that the two current-to-voltage converter circuits I-V1 are inserted so that the drain currents of the n-channel transistors M3 and M1 will be equal to each other.

### Other Embodiment of the Invention

In the embodiment (claim 9) of the present invention (FIG. 30), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

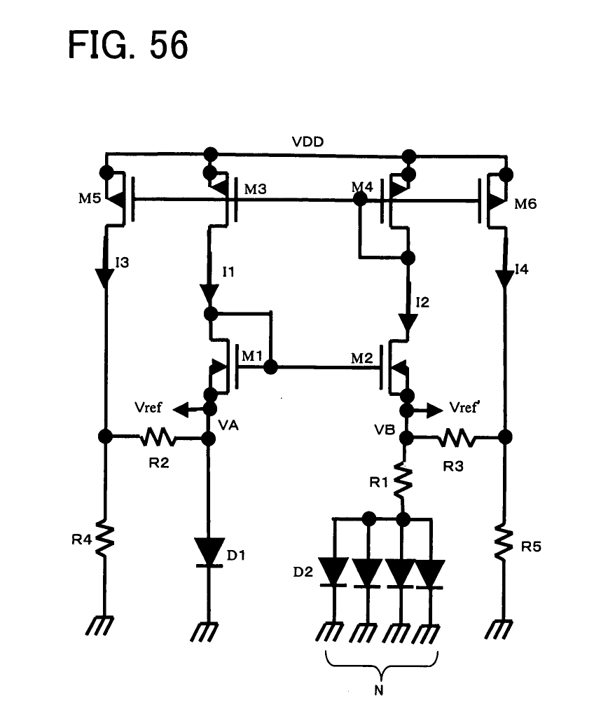

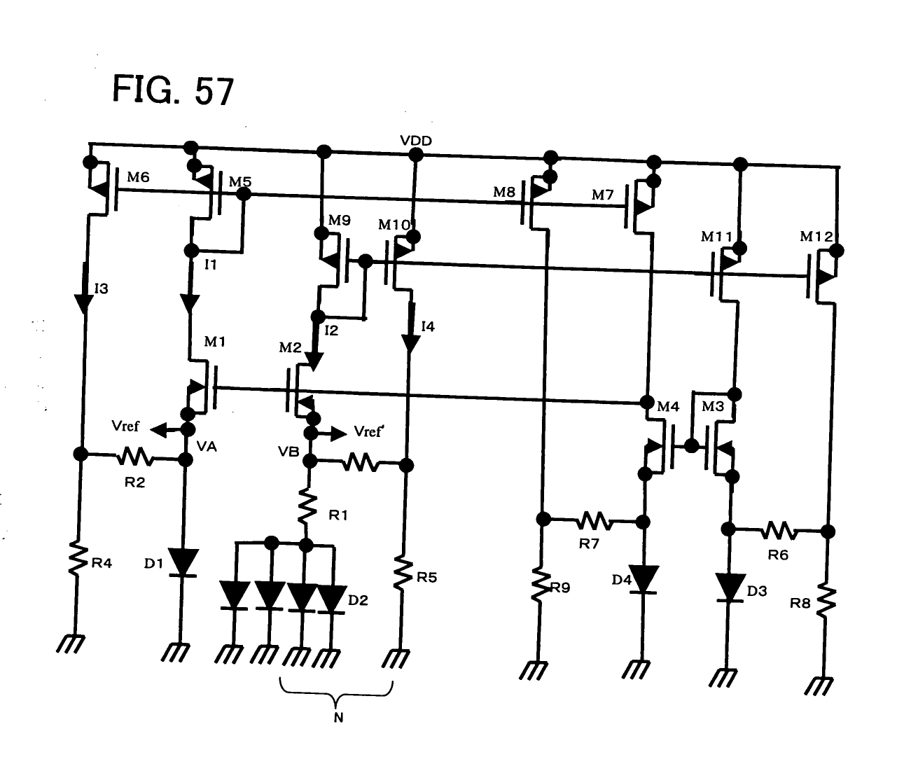

Specifically, the reference voltage generating circuit of FIG. 30 is developed as shown in FIGS. 56 to 58. For reducing the chip size, it is preferred to select, as the I-V converter in a control circuit, the first current-to-voltage converter circuit I-V1 with a smaller number of diodes, as shown in FIGS. 57 and 58. However, the second current-to-voltage converter circuit (I-V2), with a larger number of diodes, may give the same meritorious effect insofar as the circuit operation is concerned.

In FIG. 56, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2 and the p-channel transistors M3, M4, M5 and M6 each constitute a current mirror circuit. The current mirror circuit of the p-channel transistors M3 and M4 self-biases the current mirror circuit of the n-channel transistors M1 and M2. Hence, the current I1 flows through transistors M1, M3, while the current I3 flows through the transistor M5, thus driving the π-type first current-to-voltage converter circuit (I-V1), made up of the diode D1 and the resistors R2, R4. An output voltage Vref is generated from the terminal voltage of the diode D1.

Similarly, the current I2 flows through transistors M2, M4, while the current I4 flows through the transistor M6, thus driving the second π-type current-to-voltage converter circuit (I-V2), made up of the diodes D2 and the resistors R3, R5, thus generating an output voltage Vref′ from the terminal voltage of the diodes D2. The second current-to-voltage converter circuit (I-V2) is made up of N parallel-connected diodes D2.

The operation of the present embodiment is now described. By self-biasing, the OP amp in the configuration of FIG. 30 may be dispensed with.

In FIG. 56, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2 and the p-channel transistors M3, M4, M5 and M6 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 are equal to each other. Hence, the terminal voltage VA of the resistor R4 of the first π-type current-to-voltage converter circuit (I-V1), made up of the diode D1 and the resistors R2, R4, is equal to the terminal voltage VB of the resistor R1 of the second π-type current-to-voltage converter circuit (I-V2), made up of the diodes D2 and the resistors R1, R3, R5, thus achieving the same operating conditions as those with the use of the OP amp as described above. That is, the characteristic equivalent to that of FIG. 30 may be achieved, thus implementing a reference voltage generating circuit.

However, the above-described reference voltage generating circuit, shown in FIG. 55, may be affected by transistor channel length modulation. For simplicity, the startup circuit is dispensed with.

### Other Embodiment of the Invention

In FIG. 57, n-channel transistors M1 and M2 have sources connected to a terminal of a diode D1 of the first π-type current-to-voltage converter circuit (I-V1), made up of the diode D1 and resistors R2 and R4, and to a terminal of a resistor R1 of the π-type second current-to-voltage converter circuit (I-V2), made up of the resistor R1, diodes D2 and resistors R3 and R5. There are p-channel transistors M5 and M9, connected between the drains of the n-channel transistors M1 and M2 and the power supply VDD and having drains and gates connected together, and n-channel transistors M3 and M4, having sources connected to two first current-to-voltage converter circuit (I-V1) and having gates connected together. The p-channel transistors M5-M9 and the n-channel transistors M3-M4 each constitute a current mirror circuit.

There are p-channel transistors M8 and M6, connected between the drains of the n-channel transistors M3 and M4 and the power supply VDD. The gates of the n-channel transistors M1 and M2 are connected in common and connected to the drain of the n-channel transistor M4. The p-channel transistors M5 and M6 have gates coupled together to form a current mirror circuit, whereas the p-channel transistors M7 and M8 also have the gates connected in common to form a current mirror circuit.

Hence, the current I1 flows through transistors M1, M3, while the current I3 flows through the transistor M6, thus driving the first π-type current-to-voltage converter circuit (I-V1), made up of the diode D1 and the resistors R2, R4, thereby generating an output voltage Vref from the terminal voltage of the resistor R4. Similarly, the current I2 flows through transistors M2 and M9, while the current I4 flows through the transistor M6, thus driving the second π-type current-to-voltage converter circuit (I-V2), made up of the diodes D2 and the resistors R1, R3, R5, thereby generating an output voltage Vref from the terminal voltage of the resistor R1 and the diodes D2. The second current-to-voltage converter circuit (I-V2) is made up of N parallel-connected diodes D2.

The operation of the present embodiment is now described. Referring to FIG. 57, the currents flowing through the n-channel transistors M1 and M2, connected to the first and second π-type current-to-voltage converter circuits, are compared to each other via the current mirror circuits made up of the p-channel transistors M5-M8 and the p-channel transistors M9-M12, in the current mirror circuit made up of the n-channel transistors M3 and M4. The common gate voltage of the n-channel transistors M1 and M2 is controlled so that the currents I1 and I2 flowing through the n-channel transistors M1 and M2 will be equal to each other. The first current-to-voltage converter circuit is made up of the resistors R2, R4 and the diode D1, whereas the second current-to-voltage converter circuit is made up of the resistors R3, R5, R1 and the diodes D2, as described above.

Thus, the gate source voltages of the n-channel transistors M1 and M2 are equal to each other, and hence the voltage VA applied to the π-type first current-to-voltage converter circuit (I-V1) becomes equal to the voltage VB applied to the π-type second current-to-voltage converter circuit to achieve the operating condition equivalent to that with the OP amp described above. That is, the characteristic similar to that FIG. 30 may be achieved to implement the reference voltage generating circuit. The two first current-to-voltage converter circuit (I-V1) (D4, R7, R9), (D3, R6, R8) are inserted so that the channel voltages of the n-channel transistors M3 and M4 will be equal to each other. The first current-to-voltage converter circuit is made up of the resistors R2, R4 and the diode D1, whereas the second current-to-voltage converter circuit is made up of the resistors R3, R5, R1 and the diodes D2, as described above.

### Other Embodiment of the Invention

In FIG. 58, a resistor R8 is connected between the source of the p-channel transistor M4 and the power supply VDD. Since the p-channel transistor M4 has the gate voltage in common with the p-channel transistor M5, the transistor size of the n-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M9, the gate of which is connected to the drain of the p-channel transistor M5. This decreases the current flowing through the p-channel transistor M3 having the common drain current.

The n-channel transistors M3 and M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M3 and the p-channel transistors M4-M9, constitutes a negative feedback circuit, and controls the common gate voltage of the n-channel transistors M1 and M2 so that the currents through the n-channel transistors M1 and M2 will become of a preset value, herein equal to each other.

Since the gate source voltages of the n-channel transistors M1 and M2 become equal to each other, the voltage applied to the first current-to-voltage converter circuit, made up of the diodes D2 and the resistors R3, R5 becomes equal to that applied to the second current-to-voltage converter circuit, made up of the resistor R1, diodes D2 and the resistors R3, R5, thus achieving the same operating condition as that of using the OP amp as described above. That is, the characteristic equivalent to that of FIG. 30 may be achieved, thus implementing the reference voltage generating circuit. It is noted that the two current-to-voltage converter circuits (I-V1) (D1, R2, R4) and (D3, R6, R7) are inserted so that the drain currents of the n-channel transistors M3 and M1 will be equal to each other.

### Other Embodiment of the Invention

In the embodiment (claim 10) of the present invention (FIG. 31), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

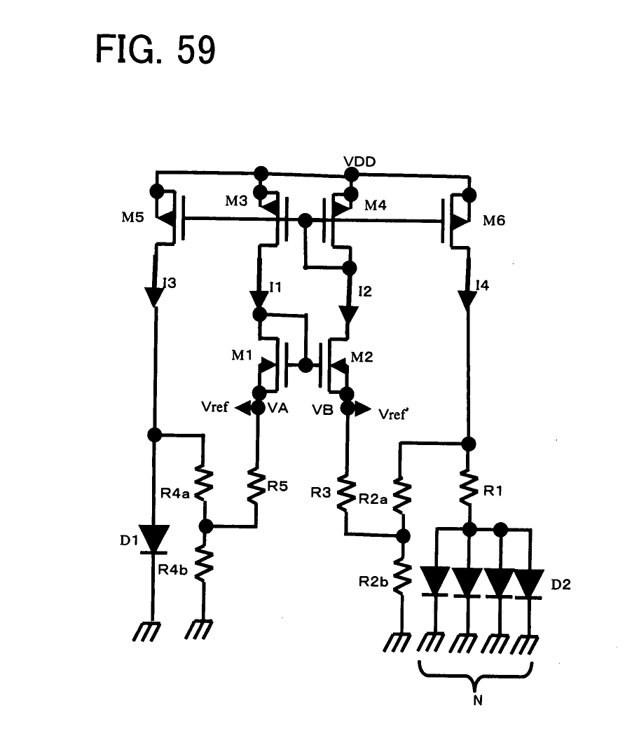

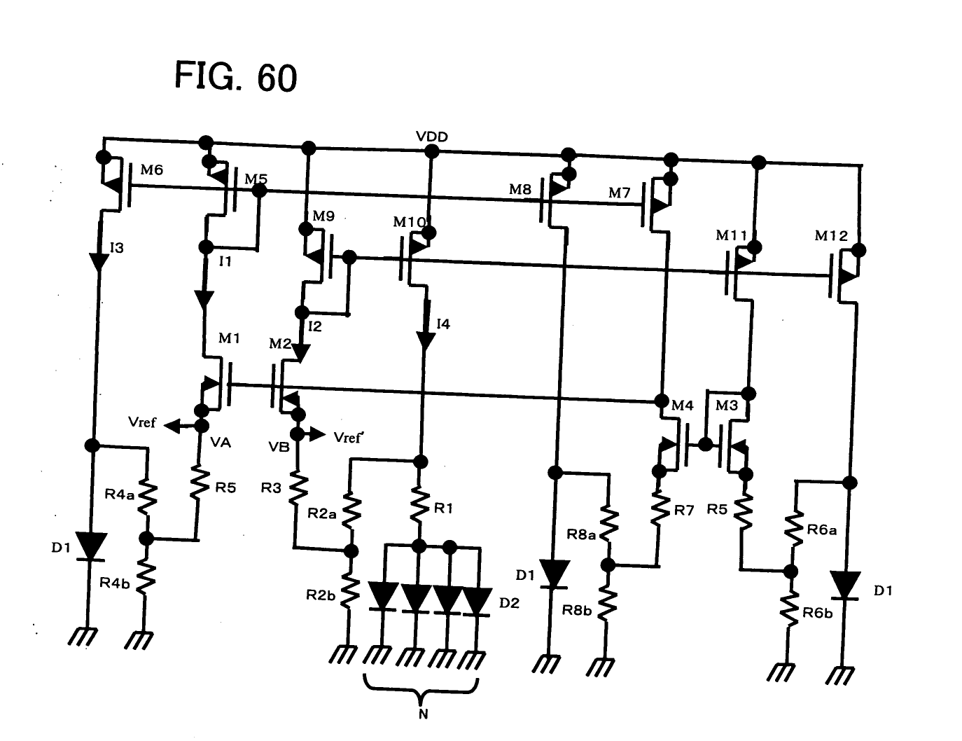

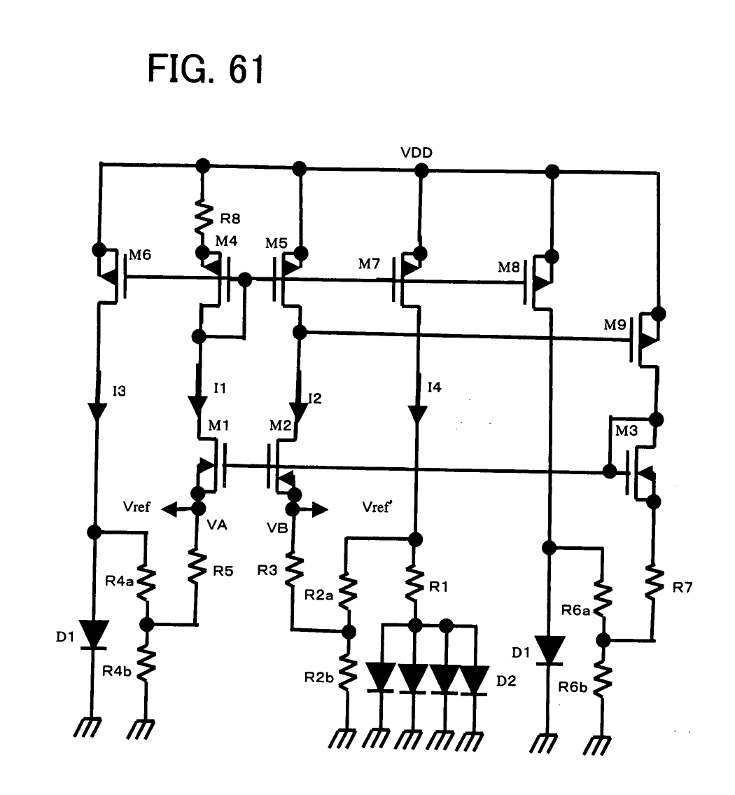

Specifically, the reference voltage generating circuit of FIG. 31 is developed as shown in FIGS. 59 to 61. For reducing the chip size, it is preferred to select, as the I-V converter in a control circuit, the first current-to-voltage converter circuit I-V1 with a smaller number of diodes, as shown in FIGS. 60 and 61. However, the second current-to-voltage converter circuit (I-V2), with a larger number of diodes, may give the same meritorious effect insofar as the circuit operation is concerned.

In FIG. 59, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2 and the p-channel transistors M3, M4, M5 and M6 each constitute a current mirror circuit. The current mirror circuit of the p-channel transistors M3 and M4 self-biases the current mirror circuit of the n-channel transistors M1 and M2.

Hence, the current I1 flows through transistors M1 and M3 to drive a first current-to-voltage converter circuit (I-V1) via resistor R5, while the current I3 flows through the transistor M5 to drive the parallel connection of a diode D1 and voltage-dividing resistors R4a, R4b. Hence, an output voltage Vref is derived from the terminal voltage of a resistor R3 in the first current-to-voltage converter circuit (I-V1), made up of parallel connection of the diode D1 and the voltage-dividing resistors R4a and R4b and a resistor R5 connected to a mid-point terminal thereof.

Similarly, the current I2 flows through transistors M2 and M4 to drive the second current-to-voltage converter circuit (I-V2), via resistor R3, while the current I4 flows through the transistor M6, thus driving the resistor R1, diode D2 and the voltage-dividing resistors R2a and R2b connected in parallel with R1-D2. Thus, with the second current-to-voltage converter circuit (I-V2), made up of the resistor R1, diodes D2, voltage-dividing resistors R2a, R2b connected in parallel with R1-D2, and the resistor R3, connected to a mid-point terminal of the resistor path, an output voltage Vref′ is generated from the terminal voltage of the resistor R3. The second current-to-voltage converter circuit (I-V2) includes N parallel-connected diodes D2.

The operation of the present embodiment is now described. By self-biasing, the OP amp in the configuration of FIG. 31 may be dispensed with, as shown in FIG. 59. In this figure, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2 and the p-channel transistors M3, M4, M5 and M6 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 are equal to each other. Hence, the terminal voltage VA at the resistor R5 of the first current-to-voltage converter circuit (I-V1), made up of the parallel connection of the diode D1 and the voltage-dividing resistors R4a, R4b, and the resistor R5, connected to a mid-point terminal thereof, is equal to the terminal voltage VB at the resistor R3 of the second current-to-voltage converter circuit (I-V2), made up of the resistor R1, diodes D2, voltage-dividing resistors R2a, R2b connected in parallel with R1-D2, and the resistor R3, connected to a mid-point terminal thereof, thus achieving the same operating conditions as those with the use of the OP amp as described above. That is, the characteristic equivalent to that of FIG. 30 may be achieved, thus implementing a reference voltage generating circuit.

However, the above-described reference voltage generating circuit, shown in FIG. 59, may be affected by transistor channel length modulation. For simplicity, the startup circuit is dispensed with.

### Other Embodiment of the Invention

In FIG. 60, n-channel transistors M1 and M2, p-channel transistors M5, M9 and n-channel transistors M3 and M4 each constitute a current mirror circuit. The n-channel transistors M1 and M2 have sources connected to the terminal of a resistor R5 of the first current-to-voltage converter circuit (I-V1), made up of parallel connection of a diode D1 and voltage-dividing resistors R4a, R4b, and the resistor R5, connected to a mid-point terminal thereof, and to the terminal of a resistor R3 of the second current-to-voltage converter circuit (I-V2), made up of a resistor R1, diodes D2, voltage-dividing resistors R2a, R2b, connected in parallel therewith, and the resistor R3, connected to a mid-point terminal thereof. The p-channel transistors M5 and M9 are connected between the drains of the n-channel transistors M1 and M2 and the power supply VDD and have drains and gates connected together. The n-channel transistors M3 and M4 have sources connected to two first current-to-voltage converter circuits (I-V1) and have gates connected together. There are n-channel transistors M8 and M6, connected between the drains of the n-channel transistors M3 and M4 and the power supply VDD. The gates of the n-channel transistors M1 and M2, are connected in common and connected to the drain of the n-channel transistor M4. The p-channel transistors M5 to M8 have gates coupled together to form a current mirror circuit, while the p-channel transistors M9 to M12 have gates coupled together to form a current mirror circuit.

Hence, the current I1 flows through the transistors M1, M5, while the current I3 flows through the transistor M6 to drive the first current-to-voltage converter circuit (I-V1) to produce the output voltage Vref from the terminal voltage of the resistor R5. The first current-to-voltage converter circuit is made up of parallel connection of a diode D1 and voltage-dividing resistors R4a, R4b, and the resistor R5 connected to the mid-point terminal thereof, as described above. Similarly, the current I2 flows through the transistors M2 and M9, while the current I4 flows through the transistor M10 to drive the second current-to-voltage converter circuit (I-V2) to produce the output voltage Vref from the terminal voltage of the resistor R3. The second current-to-voltage converter circuit is made up of the resistor R1, diodes D2, voltage-dividing resistors R2a, R2b, connected in parallel with R1-D2, and the resistor R3 connected to the mid-point terminal thereof, as described above. The second current-to-voltage converter circuit includes N parallel-connected diodes D2.

The operation of the present embodiment is now described. In FIG. 60, the currents flowing through the n-channel transistors M1 and M2, connected to the first and second current-to-voltage converter circuits, are compared to each other via the current mirror circuits made up of the p-channel transistors M5-M8 and the p-channel transistors M9-M12, in the current mirror circuit made up of the n-channel transistors M3 and M4. The common gate voltage of the n-channel transistors M1 and M2 is controlled so that the currents I1 and I2 flowing through the n-channel transistors M1 and M2 will be equal to each other. The first current-to-voltage converter circuit is made up of parallel connection of the diode D1 and the voltage-dividing resistors R4a, R4b, and the resistor R5, connected to the mid-point terminal thereof, whereas the second current-to-voltage converter circuit is made up of the resistor R1 and the diodes D2, voltage-dividing resistors R2a, R2b, connected in parallel with R1-D2, and the resistor R3, connected to the mid-point terminal thereof, as described above.

Thus, the gate source voltages of the n-channel transistors M1 and M2 are equal to each other, and hence the voltage VA applied to the first current-to-voltage converter circuit (I-V1) becomes equal to the voltage VB applied to the second current-to-voltage converter circuit to achieve the operating condition equivalent to that with the OP amp described above. The first current-to-voltage converter circuit is made up of parallel connection of the diode D1 and the voltage-dividing resistors R4a, R4b, and the resistor R5, connected to the mid-point terminal thereof, whereas the second current-to-voltage converter circuit is made up of the resistor R1, diodes D2, voltage-dividing resistors R2a, R2b, connected in parallel with R1-D2, and the resistor R3, connected to the mid-point terminal thereof, as described above. That is, the characteristic equivalent to that of FIG. 31 may be achieved, thus implementing a reference voltage generating circuit. The two first current-to-voltage converter circuits (I-V1) is inserted so that the drain voltages of the n-channel transistors M3 and M4 will be equal to each other.

### Other Embodiment of the Invention

In FIG. 61, a resistor R8 is connected between the source of the p-channel transistor M4 and the power supply VDD. Since the p-channel transistor M5 has the gate voltage common to that of the p-channel transistor M5, the transistor size of the n-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M9, the gate of which is connected to the drain of the p-channel transistor M5.

This decreases the current flowing through the p-channel transistor M3 having the common drain current. The n-channel transistors M3 and M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M3 and the p-channel transistors M4-M9, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Since the gate source voltages of the n-channel transistors M1 and M2 become equal to each other, the voltage applied to the first current-to-voltage converter circuit becomes equal to that applied to the second current-to-voltage converter circuit, thus achieving the same operating condition as that of using the OP amp as described above. That is, the characteristic equivalent to that of FIG. 31 may be achieved, thus implementing the reference voltage generating circuit. The first current-to-voltage converter circuit is made up of a parallel connection of the diode D1 and the voltage-dividing resistors R4a, R4b, and the resistor R5, connected to the mid-point terminal thereof, whereas the second current-to-voltage converter circuit is made up of the resistor R1, diodes D2, voltage-dividing resistors R2a, R2b, connected in parallel with R1-D2, and the resistor R3, connected to the mid-point terminal thereof, as described above.

It is noted that the two current-to-voltage converter circuits are inserted so that the drain currents of the n-channel transistors M3 and M1 will be equal to each other.

### Other Embodiment of the Invention

In the embodiment of claim 11 of the present invention (FIG. 32), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

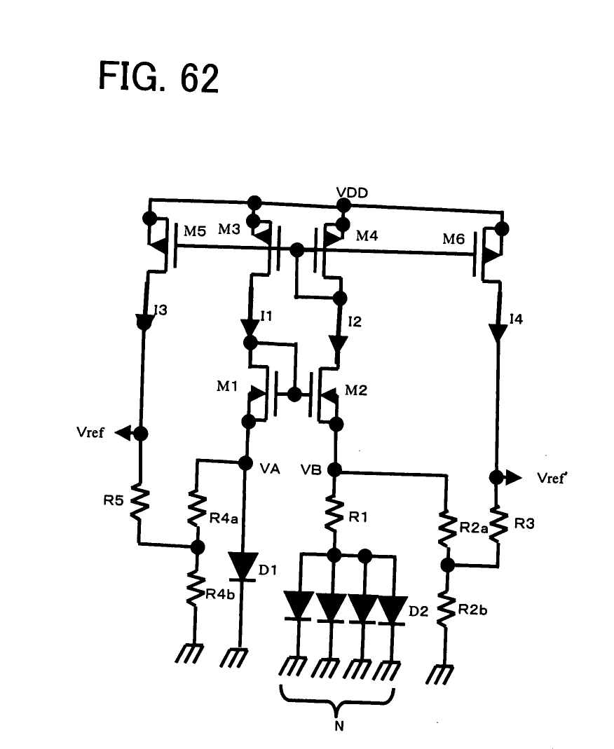

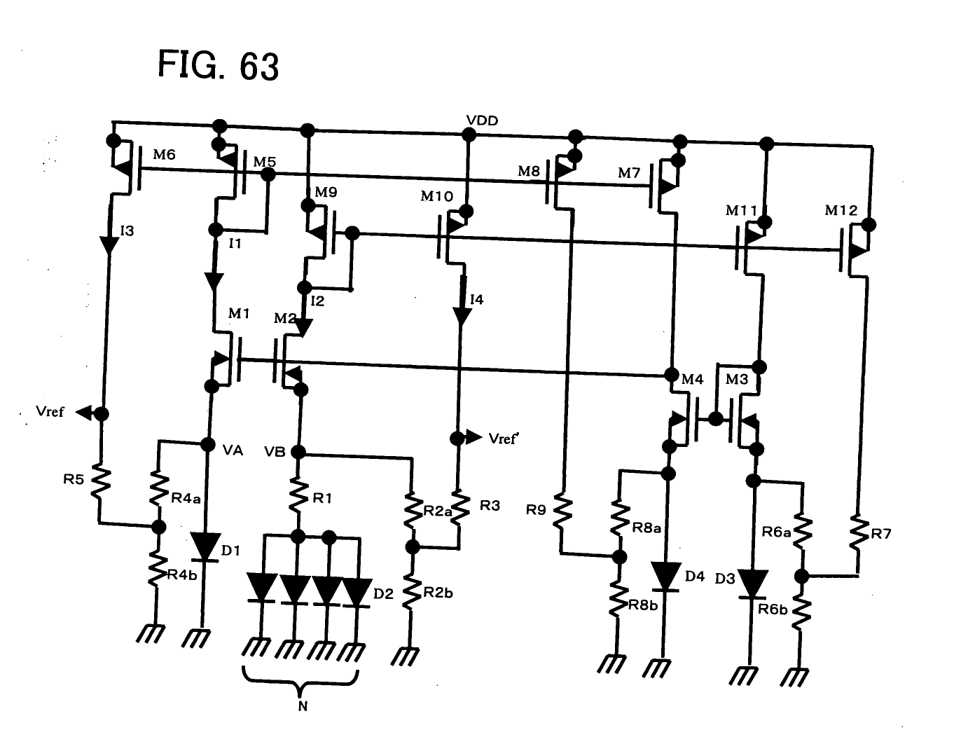

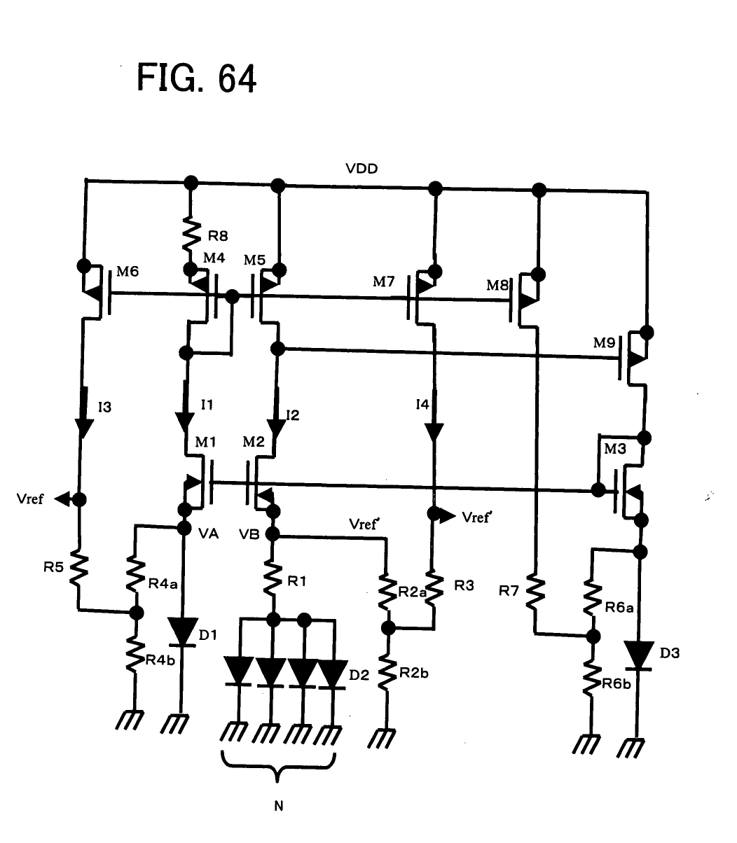

Specifically, the reference voltage generating circuit of FIG. 32 is developed as shown in FIGS. 62 to 64. For reducing the chip size, it is preferred to select, as the I-V converter in a control circuit, the first current-to-voltage converter circuit I-V1 with a smaller number of diodes, as shown in FIGS. 63 and 64. However, the second current-to-voltage converter circuit (I-V2), with a larger number of diodes, may give the same meritorious effect insofar as the circuit operation is concerned.

In FIG. 62, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2, M3 to M6 each constitute a current mirror circuit. The current mirror circuit of the p-channel transistors M3 and M4 self-biases the current mirror circuit of the n-channel transistors M1 and M2. Hence, the current I1 flows through transistors M1 and M3 to drive the first current-to-voltage converter circuit (I-V1), while the current I3 flows through the transistor M5 to drive the parallel connection of the diode D1 and voltage-dividing resistors R4a and R4b. Hence, an output voltage Vref is derived from the terminal voltage of the resistor R3 in the first current-to-voltage converter circuit (I-V1), made up of the parallel connection of the diode D1 and the voltage-dividing resistors R4a, R4b and the resistor R5 connected to a mid-point terminal thereof.

Similarly, the current I2 flows through transistors M2, M4, while the current I4 flows through the transistor M6, thus driving the resistor R1, diode D2 and the voltage-dividing resistors R2a, R2b connected in parallel with R1-D2. Thus, with the second current-to-voltage converter circuit (I-V2), made up of the resistor R1, diodes D2, voltage-dividing resistors R2a, R2b connected in parallel with R1-D2, and the resistor R3, connected to the mid-point terminal thereof, an output voltage Vref is generated from the terminal voltage of the resistor R3. The second current-to-voltage converter circuit (I-V2) includes N parallel-connected diodes D2.

The operation of the present embodiment is now described. By self-biasing, the OP amp in the configuration of FIG. 31 may be dispensed with, as shown in FIG. 62. In this figure, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2, the p-channel transistors M3, M4 and M5, M6 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 are equal to each other. Hence, the terminal voltage VA at the resistor R3 and the diode D1 of the first current-to-voltage converter circuit (I-V1) is equal to the terminal voltage VB at the resistors R1, R2 of the second current-to-voltage converter circuit (I-V2). The first current-to-voltage converter circuit is made up of the diode D1, voltage-dividing resistors R4a, R4b connected in parallel with D1, and the resistor R5, connected to a mid-point terminal thereof, whereas the second current-to-voltage converter circuit is made up of the resistor R1, diodes D2, the voltage-dividing resistors R2a, R2b connected in parallel with R1-D2 and the resistor R3 connected to the mid-point terminal thereof. Thus, the same operating conditions as those with the use of the OP amp as described above may be achieved. That is, the characteristic equivalent to that of FIG. 32 may be obtained, thus implementing a reference voltage generating circuit.

However, the above-described reference voltage generating circuit, shown in FIG. 62, may be affected by transistor channel length modulation. For simplicity, the startup circuit is dispensed with.

### Other Embodiment of the Invention

In FIG. 63, n-channel transistors M1 and M2, p-channel transistors M5 and M9 and n-channel transistors M3 and M4 each constitute a current mirror circuit. The n-channel transistors M1 and M2 have sources connected to the terminals of a resistor Ra and a diode D1 of the first current-to-voltage converter circuit (I-V1), and to the terminals of resistors R1 and R2a of the second current-to-voltage converter circuit (I-V2). The first current-to-voltage converter circuit is made up of parallel connection of the diode D1 and voltage-dividing resistors R4a, R4b, and a resistor R5, connected to a mid-point terminal thereof, whereas the second current-to-voltage converter circuit is made up of parallel connection of the resistor R1 and diodes D2, voltage-dividing resistors R2a, R2b, connected in parallel with the parallel connection, and a resistor R3, connected to a mid-point terminal thereof. The p-channel transistors M5, M9 are connected between the drains of the n-channel transistors M1 and M2 and the power supply VDD, and have drains and gates connected together. The n-channel transistors M3 and M4 have sources connected to two first current-to-voltage converter circuits (I-V1) and have gates connected together.

There are n-channel transistors M8 and M6, connected between the drains of the n-channel transistors M3 and M4 and the power supply VDD, and the gates of the n-channel transistors M1 and M2, are connected in common and connected to the drain of the n-channel transistor M4. The p-channel transistors M5 to M8 have gates coupled together to form a current mirror circuit, while the p-channel transistors M9 to M12 have gates coupled together to form a current mirror circuit.

Hence, the current I1 flows through the transistors M1, M5, while the current I3 flows through the transistor M6 to drive the first current-to-voltage converter circuit (I-V1) to produce the output voltage Vref from the terminal voltage of the resistor R5. The first current-to-voltage converter circuit is made up of parallel connection of the diode D1 and voltage-dividing resistors R4a, R4b, and the resistor R5 connected to the mid-point terminal thereof, as described above. Similarly, the current I2 flows through the transistors M2 and M9, while the current I4 flows through the transistor M10 to drive the second current-to-voltage converter circuit (I-V2) to produce the output voltage Vref′ from the terminal voltage of the resistor R3. The second current-to-voltage converter circuit is made up of series connection of the resistor R1 and diodes D2, voltage-dividing resistors R2a, R2b, connected in parallel with the series connection, and the resistor R3 connected to the mid-point terminal thereof, as described above. The second current-to-voltage converter circuit includes N parallel-connected diodes D2.

The operation of the present embodiment is now described. In FIG. 63, the currents flowing through the n-channel transistors M1 and M2, connected to the first and second current-to-voltage converter circuits, are compared to each other via the current mirror circuits made up of the p-channel transistors M5-M8 and the current mirror circuit made up of the p-channel transistors M9-M12, in the current mirror circuit made up of the n-channel transistors M3 and M4. The common gate voltage of the n-channel transistors M1 and M2 is controlled so that the currents I1 and I2 flowing through the n-channel transistors M1 and M2 will be equal to each other. The first current-to-voltage converter circuit is made up of parallel connection of the diode D1 and the voltage-dividing resistors R4a, R4b, and the resistor R5 connected to the mid-point terminal thereof, whereas the second current-to-voltage converter circuit is made up of series connection of the resistor R1 and the diodes D2, voltage-dividing resistors R2a and R2b connected in parallel with the series connection, and the resistor R3, connected to the mid-point terminal thereof, as described above.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of parallel connection of the diode D1 and the voltage-dividing resistors R4a, R4b, and the resistor R5 connected to the mid-point terminal thereof, whereas the second current-to-voltage converter circuit is made up of series connection of the resistor R1 and the diodes D2, voltage-dividing resistors R2a, R2b connected in parallel with the series connection, and the resistor R3, connected to the mid-point terminal thereof, as described above.

That is, the characteristic equivalent to that of FIG. 32 may be achieved, thus implementing the reference voltage generating circuit. It is noted that the two current-to-voltage converter circuits (I-V1) are inserted so that the drain currents of the n-channel transistors M3 and M4 will be equal to each other.

### Other Embodiment of the Invention

In FIG. 64, a resistor R8 is connected between the source of the p-channel transistor M4 and the power supply VDD. Since the p-channel transistor M5 has the gate voltage common to that of the p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. However, the so increased current cannot flow through the n-channel transistor M2, thus increasing the drain voltage of the p-channel transistor M5 and decreasing the current through the p-channel transistor M9, the gate of which is connected to the drain of the p-channel transistor M5. This decreases the current flowing through the p-channel transistor M3 having the common drain current.

The n-channel transistors M3 and M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M3 and the p-channel transistors M4-M9, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Since the gate source voltages of the n-channel transistors M1 and M2 become equal to each other, the voltage applied to the first current-to-voltage converter circuit becomes equal to that applied to the second current-to-voltage converter circuit, thus achieving the same operating condition as that of using the OP amp as described above. The first current-to-voltage converter circuit is made up of parallel connection of the diode D1 and the voltage-dividing resistors R4a, R4b, and the resistor R5, connected to the mid-point terminal thereof, whereas the second current-to-voltage converter circuit is made up of series connection of the resistor R1 and diodes D2, voltage-dividing resistors R2a, R2b, connected in parallel with the series connection, and the resistor R3 connected to the mid-point terminal thereof, as described above.

That is, the characteristic equivalent to that of FIG. 32 may be achieved, thus implementing the reference voltage generating circuit. It is noted that the two current-to-voltage converter circuits (I-V1) are inserted so that the drain currents of the n-channel transistors M3 and M1 will be equal to each other.

### Other Embodiment of the Invention

In the embodiment (FIG. 34) of the present invention (claim 13), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

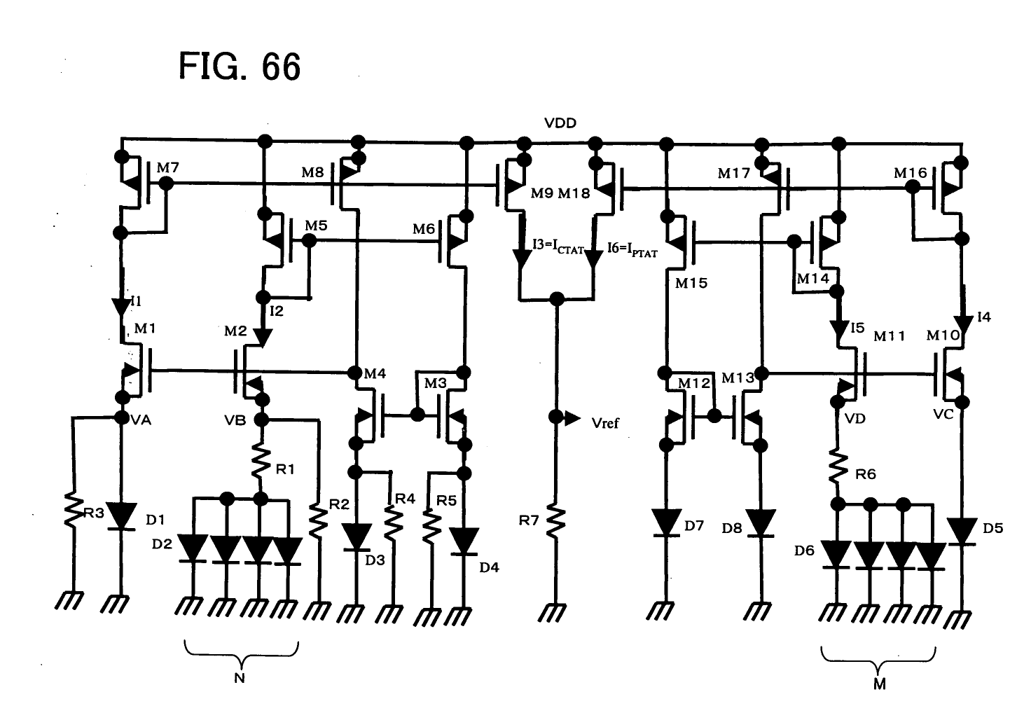

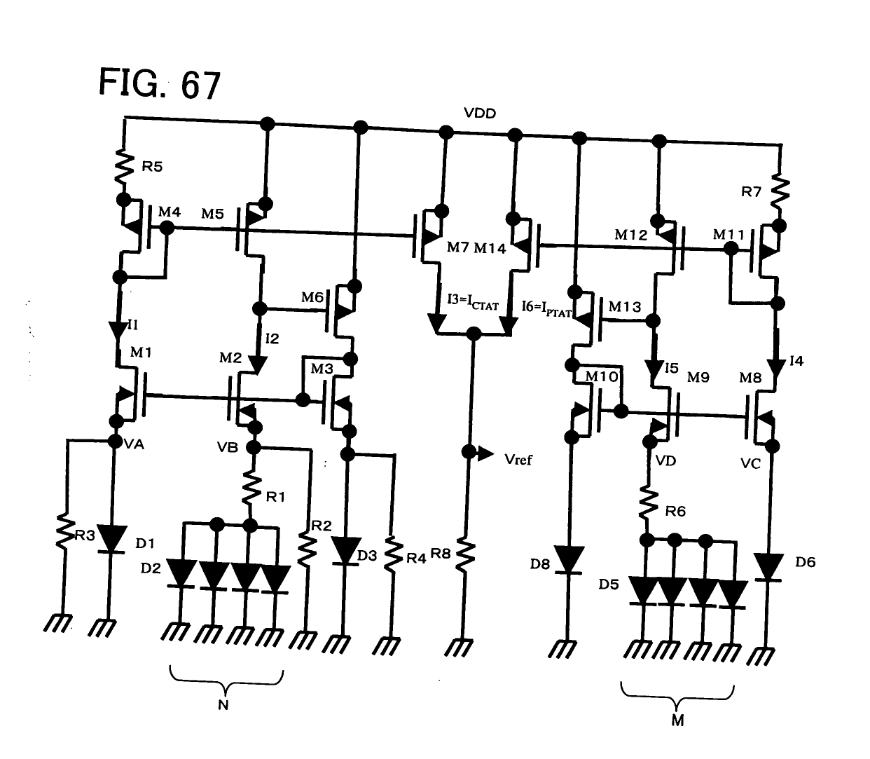

Specifically, the reference voltage generating circuit of FIG. 34 is developed as shown in FIGS. 65 to 67. For reducing the chip size, it is preferred to use the first current-to-voltage converter circuit I-V1 with a smaller number of diodes, as each of the two I-V converters in a control circuit as shown in FIGS. 66 and 67. However, the second current-to-voltage converter circuit (I-V2), with a larger number of diodes, may give the same meritorious effect insofar as the circuit operation is concerned.

In FIG. 65, the gates of n-channel transistors M1 and M2 are connected in common, and M1 has a gate and a drain connected together. The gates of p-channel transistors M3, M4 and M5 are connected in common, and M4 has a gate and a drain connected together. Hence, the n-channel transistors M1 and M2 and the p-channel transistors M3, M4 and M5 each constitute a current mirror circuit. The current mirror circuit of the p-channel transistors M3, M4 self-biases the current mirror circuit of the n-channel transistors M1 and M2. Hence, the current I1 flows through transistors M1, M3 to drive the first current-to-voltage converter circuit (I-V1) via resistor R5, thus driving the first current-to-voltage converter circuit (I-V1) made up of the diode D1 and the resistor R4 connected in parallel therewith, and the second current-to-voltage converter circuit (I-V2) made up of series connection of the resistor R1 and diodes D2 and a resistor R2 connected in parallel with the series connection.

Similarly, n-channel transistors M6 and M7 have gates coupled together, while M6 has its gate and drain coupled together. The p-channel transistors M8 to M10 have gates coupled together, while M8 has its gate and drain coupled together. Hence, the n-channel transistors M6 and M7 and the p-channel transistors M8 to M10 each constitute a current mirror circuit, with the current mirror circuit of the p-channel transistors M8 and M9 self-biasing the current mirror circuit of the n-channel transistors M6 and M7. Hence, a current I4 flows through the transistors M6 and M8 to drive a third current-to-voltage converter circuit (I-V3), made up of a diode D3, and a fourth current-to-voltage converter circuit (I-V4), made up of a series connection of a resistor R5 and diodes D4.

It is noted that N diodes of the second current-to-voltage converter circuit (I-V2) are connected in parallel and M diodes of the fourth current-to-voltage converter circuit (I-V4) are also connected in parallel.

The current from the transistors M5, M10 drives the resistor R3 to generate an output voltage Vref from the terminal voltage of the resistor R3.

The operation of the present embodiment is now described. By self-biasing, the OP amp in the configuration of FIG. 34 may be dispensed with, as shown in FIG. 65. In this figure, the gates of n-channel transistors M1 and M2 are connected in common, and M1 has a gate and a drain connected together. The gates of p-channel transistors M3, M4 and M5 are connected in common, and M4 has a gate and a drain connected together. Hence, the n-channel transistors M1 and M2 and the p-channel transistors M3, M4 and M5 have gates coupled together, and M1 has its gate and drain coupled together. Thus, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors MI and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 are equal to each other. Hence, the terminal voltage VA at the resistor R3 and the diode D1 of the first current-to-voltage converter circuit (I-V1) is equal to the terminal voltage VB at the resistors R1, R2 of the second current-to-voltage converter circuit (I-V2). The first current-to-voltage converter circuit (I-V1) is made up of parallel connection of the diode D1 and the resistor R4, whereas the second current-to-voltage converter circuit is made up of series connection of the resistor R1 and the diodes D2 and the diode D2 connected in parallel with the series connection. Hence, the operating condition equivalent to that with the use of the OP amp, described above, may be achieved.

In similar manner, the gates of n-channel transistors M6 and M7 are connected in common, and M7 has a gate and a drain connected together. The gates of p-channel transistors M8, M9 and M10 are connected in common, and M8 has a gate and a drain connected together. Hence, the n-channel transistors M6 and M7 and the p-channel transistors M8, M9 and M10 each constitute a current mirror circuit. The current mirror circuit of the p-channel transistors M8, M9 self-biases the current mirror circuit of the n-channel transistors M6 and M7.

The currents flowing through the n-channel transistors M6 and M7 are proportional to each other. If the n-channel transistors M6 and M7 are of the same size and the p-channel transistors M8, M9 are of the same size, the currents through the n-channel transistors M6 and M7 are equal to each other. With self-biasing, the gate source voltages of the n-channel transistors M6 and M7 are equal to each other. Hence, a terminal voltage VC of the third current-to-voltage converter circuit (I-V3), made up of the diode D3, is equal to a terminal voltage VD of the fourth current-to-voltage converter circuit (I-V4), made up of a series connection of diodes D4 and the resistor R5, thus achieving the same operating conditions as those with the use of the OP amp as described above. That is, the characteristic equivalent to that of FIG. 34 may be achieved, thus implementing a reference voltage generating circuit.

However, the above-described reference voltage generating circuit, shown in FIG. 65, may be affected by transistor channel length modulation. For simplicity, the startup circuit is dispensed with.

### Other Embodiment of the Invention

Referring to FIG. 66, n-channel transistors M1 and M2, p-channel transistors M5 and M7 and n-channel transistors M3 and M4 each constitute a current mirror circuit. The sources of the n-channel transistors M1 and M2 are connected to a terminal of the first current-to-voltage converter circuit (I-V1), made up of parallel connection of a diode D1 and a resistor R3, and to a terminal of the second current-to-voltage converter circuit (I-V2), made up of a series connection of a resistor R1 and parallel-connected diodes D2 and a resistor R2 connected in parallel with the series connection. The p-channel transistors M5 and M7 are connected between the drains of the n-channel transistors M1 and M2 and the power supply VDD and have drains and gates connected together. The n-channel transistors M3 and M4 have sources connected to two first current-to-voltage converter circuits (I-V1), while having gates connected in common.

There are p-channel transistors M6 and M8, connected between the drains of the n-channel transistors M3 and M4 and the power supply VDD, and the gates of n-channel transistors M1 and M2 are connected in common and connected to the drain of the n-channel transistor M4. The p-channel transistors M5 and M6 have gates coupled together to constitute a current mirror circuit, whereas the p-channel transistors M7-M9 have gates coupled together to constitute a current mirror circuit.

Thus, the currents I1 flows through transistors M1, M7 to drive the first current-to-voltage converter circuit (I-V1) made up of parallel connection of a diode D1 and a resistor R3. Similarly, the current I2 flows through transistors M2, M5 to drive the second current-to-voltage converter circuit (I-V2) made up of a series connection of a resistor R1 and parallel-connected diodes D2 and a resistor R2 connected in parallel with the series connection. The number of the parallel-connected diodes D2 is N.

In similar manner, n-channel transistors M10 and M11, p-channel transistors M14, M16, and n-channel transistors M12 and M13 each constitute a current mirror circuit. The sources of the n-channel transistors M10 and M11 are connected to a terminal of a third current-to-voltage converter circuit (I-V3), made up of a diode D5, and to a terminal of a fourth current-to-voltage converter circuit (I-V4), made up of a series connection of a resistor R6 and diodes D6. The p-channel transistors M14, M16 are connected between the drains of the n-channel transistors M10 and M11 and the power supply VDD, while having drains and gates connected together. The n-channel transistors M12 and M13 have sources connected to two third current-to-voltage converter circuits (I-V3) and have gates connected together. There are p-channel transistors M15 and M17, connected between the drains of the n-channel transistors M12 and M13 and the power supply VDD, and the n-channel transistors M10 and M11 have gates coupled together and are connected to the drain of the n-channel transistor M13. The p-channel transistors M14, M15 have gates coupled together to constitute a current mirror circuit, whereas the p-channel transistors M16-M18 have gates coupled together to constitute a current mirror circuit.

Thus, the current I4 flows through transistors M10, M16 to drive the third current-to-voltage converter circuit (I-V3) made up of the diode D5. Similarly, the current I5 flows through transistors M11, M15 to drive the fourth current-to-voltage converter circuit (I-V4) made up of the series connection of the resistor R6 and the parallel-connected diodes D6. The number of the parallel-connected diodes D6 is M.

The current I3 flows through the transistor M9, whereas the current I6 flows through the transistor M18. A sum current of the currents I3 and I4 flows through resistor R7 to generate an output voltage Vref from a terminal of the resistor R7.

In FIG. 66, the currents flowing through the n-channel transistors M1 and M2, connected to the first and second current-to-voltage converter circuits, are compared to each other via the current mirror circuit made up of the p-channel transistors M5-M6 and the current mirror circuit made up of the p-channel transistors M7-M9, in the current mirror circuit made up of the n-channel transistors M3 and M4. The common gate voltage of the n-channel transistors M1 and M2 is controlled so that the currents flowing through the n-channel transistors M1 and M2 will be equal to each other. The first current-to-voltage converter circuit is made up of parallel connection of the diode D1 and the resistor R2, whereas the second current-to-voltage converter circuit is made up of series connection of the resistor R1 and the diodes D2, and resistor R2 connected in parallel with the series connection, as described above.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of parallel connection of the diode D1 and the resistor R3, whereas the second current-to-voltage converter circuit is made up of series connection of the resistor R1 and the diodes D2, and the resistor R2 connected in parallel with the series connection, as described above. That is, the characteristic equivalent to that of FIG. 34 may be achieved, thus implementing the reference voltage generating circuit.

It is noted that the two first current-to-voltage converter circuits (I-V1) are inserted so that the drain currents of the n-channel transistors M3 and M4 will be equal to each other.

In similar manner, the currents flowing through the n-channel transistors M10 and M11, connected to the third and fourth current-to-voltage converter circuits, are compared to each other via the current mirror circuit made up of the p-channel transistors M14-M15 and the current mirror circuit made up of the p-channel transistors M16-M18, in the current mirror circuit made up of the n-channel transistors M12 and M13. The common gate voltage of the n-channel transistors M10 and M11 is controlled so that the currents I1 and I2 flowing through the n-channel transistors M10 and M11 will be equal to each other. The fourth current-to-voltage converter circuit is made up of a diode D5, whereas the second current-to-voltage converter circuit is made up of a series connection of a resistor R6 and a diode D6. The common gate voltage of the n-channel transistors M10 and M11 is controlled so that the currents flowing through the n-channel transistors M11 and M12 will be equal to each other.

Since the gate source voltages of the n-channel transistors M10 and M11 become equal to each other, the voltage VC applied to the third current-to-voltage converter circuit becomes equal to the voltage VD applied to the fourth current-to-voltage converter circuit, thus achieving the same operating condition as that of using the OP amp as described above. The third current-to-voltage converter circuit is made up of the diode D5, whereas the fourth current-to-voltage converter circuit is made up of the series connection of the resistor R6 and diodes D6, as described above. That is, the characteristic equivalent to that of FIG. 34 may be achieved, thus implementing a reference voltage generating circuit. The two third current-to-voltage converter circuits (I-V3) are inserted so that the drain voltages of the n-channel transistors M12 and M13 will be equal to each other.

The current I3 flows through the transistor M9, whereas the current I6 flows through the transistor M18. A sum current of the currents I3 and I4 flows through resistor R7 to generate an output voltage Vref from a terminal of the resistor R7.

### Other Embodiment of the Invention

In FIG. 67, a resistor R5 is connected between the source of the p-channel transistor M4 and the power supply VDD. Since the p-channel transistor M4 has the gate voltage in common with the p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

Similarly, a resistor R7 is connected between the source of the p-channel transistor 11 and the power supply VDD. Since the p-channel transistor M11 has the gate voltage in common with the p-channel transistor M12, the transistor size of the p-channel transistor M11 is selected to be larger than that of the p-channel transistor M12 so that the currents through the two transistors will be equal to each other. The current mirror circuit made up of the p-channel transistors M11 and M12 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3 and M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M4 and the p-channel transistors M4-M9, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit is equal to that applied to the second current-to-voltage converter circuit, thus achieving the same operating condition as that with the use of the OP amp as described above. The first current-to-voltage converter circuit is made up of parallel connection of the diode D1 and the resistor R3, whereas the second current-to-voltage converter circuit is made up of series connection of the resistor R1 and diodes D2 and the resistor R2 connected in parallel with the series connection.

When the current through the n-channel transistor M8 is increased, the current flowing through the p-channel transistor M11 is correspondingly increased. However, the current flowing through the p-channel transistor M12 becomes larger than the increased current through the p-channel transistor M8. Hence, the so increased current cannot flow through the n-channel transistor M9, thus increasing the drain voltage of the p-channel transistor M12 and decreasing the current through the p-channel transistor M13, the gate of which is connected to the drain of the p-channel transistor M12.

This decreases the current flowing through the p-channel transistor M10 having the common drain current. The n-channel transistors M10 and M9 constitute a current mirror circuit, and the n-channel transistors M8 and M9 have the gate voltage in common. Hence, the common gate voltage of M8-M10 is decreased, with the result that the current flowing through the n-channel transistor M1 decreases.

That is, the current loop, composed of the n-channel transistors M8-M10 and the p-channel transistors M11-M13, constitutes a negative feedback circuit, and controls the common gate voltage of the n-channel transistors M8 and M9, via inverse-Widlar current mirror circuit, so that the currents through the n-channel transistors M8, M9 will become of a preset value, herein equal to each other.

Since the gate source voltages of the n-channel transistors M8, M9 become equal to each other, the voltage applied to the third current-to-voltage converter circuit, made up of the diode D6, becomes equal to that applied to the fourth current-to-voltage converter circuit, made up of series connection of the resistor R6 and the diodes D6, thus achieving the same operating condition as that of using the OP amp as described above.

The current I3 flows through the transistor M7, whereas the current I6 flows through the transistor M14. A sum current of the currents I3 and I6 flows through resistor R8 to generate an output voltage Vref from a terminal of the resistor R7. That is, the characteristic equivalent to that of FIG. 34 may be achieved, thus implementing a reference voltage generating circuit. The two third current-to-voltage converter circuits (I-V3) are inserted so that the drain voltages of the n-channel transistors M10, M8 will be equal to each other.

### Other Embodiment of the Invention

In the embodiment (FIG. 35) of the present invention (claim 14), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

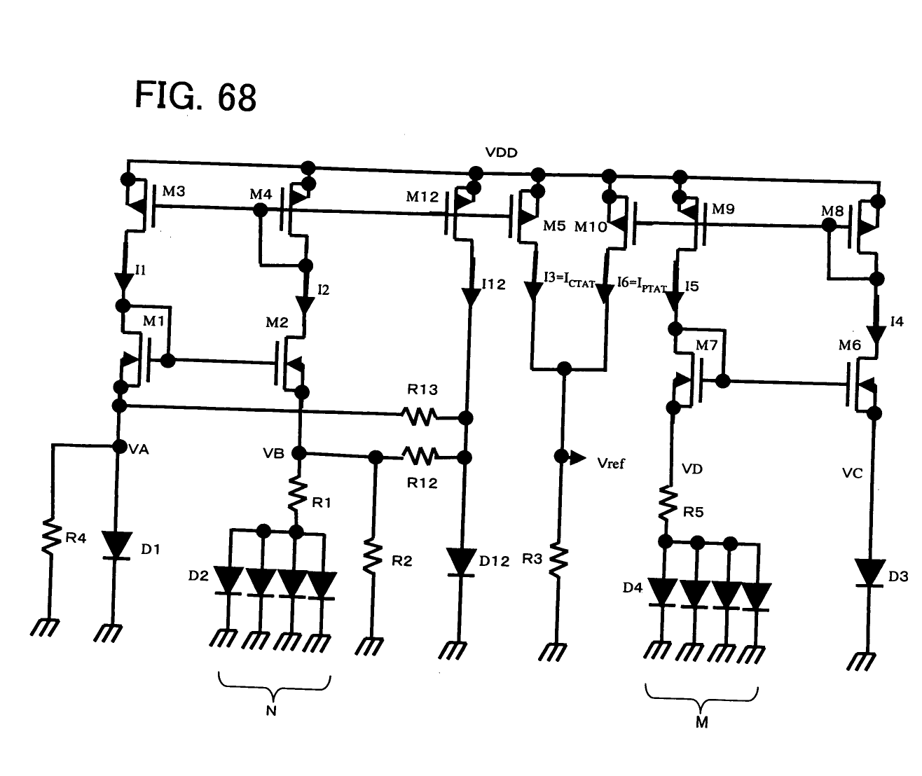

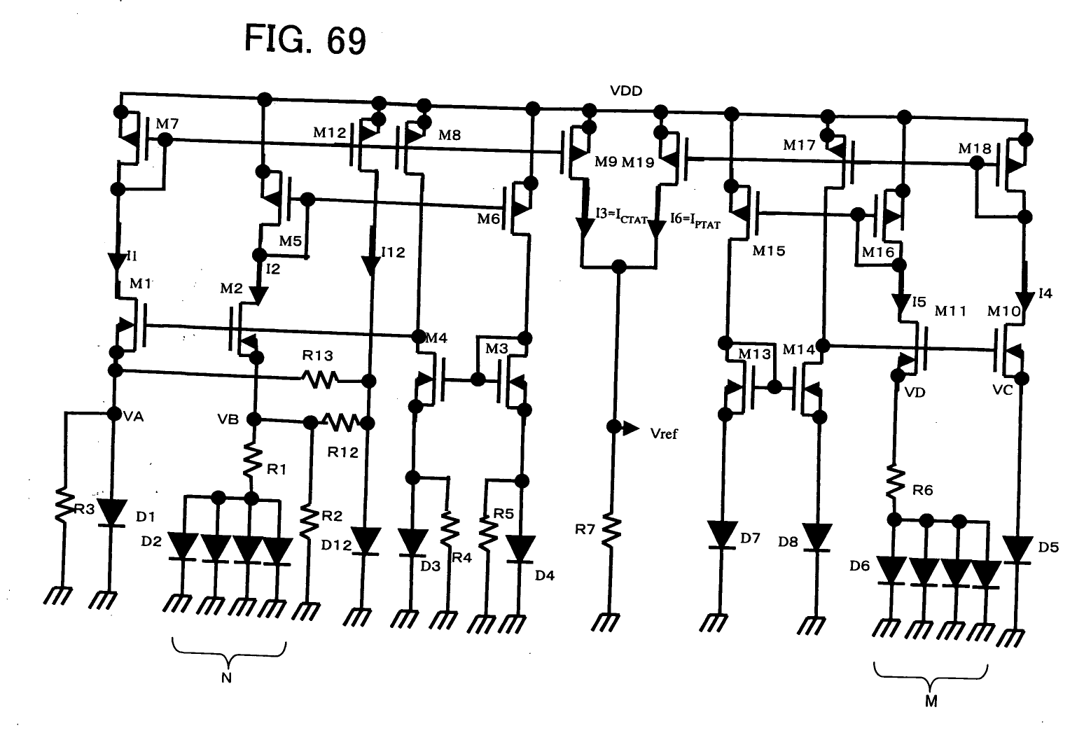

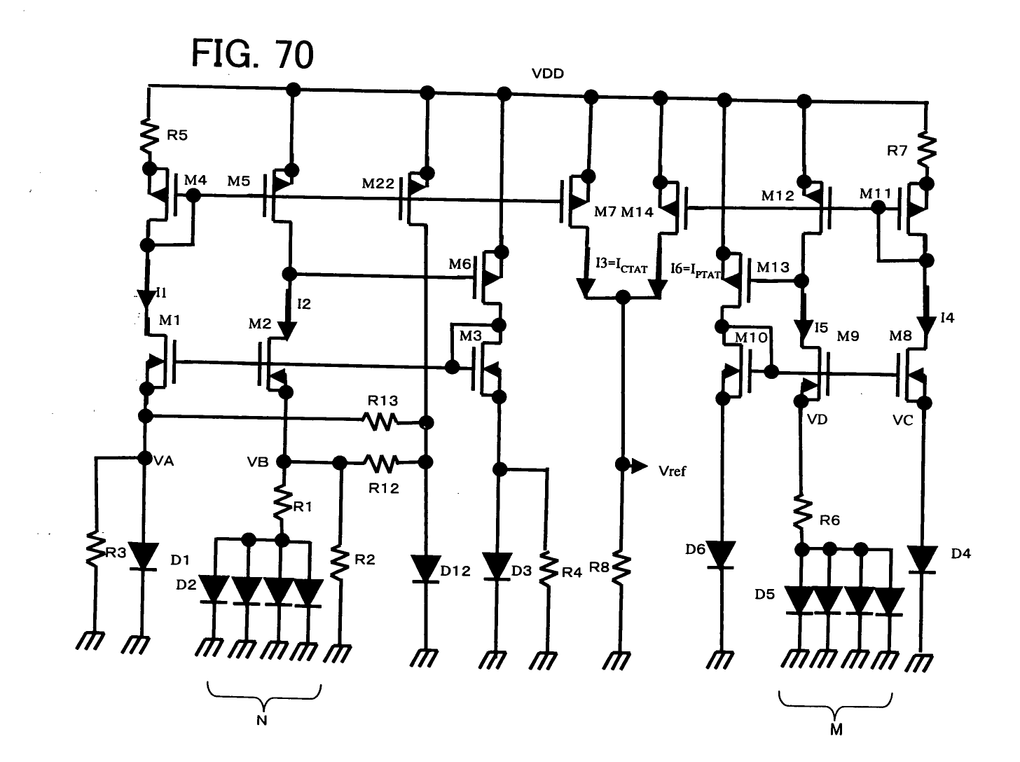

Specifically, the reference voltage generating circuit of FIG. 35 is developed as shown in FIGS. 68 to 70. For reducing the chip size, it is preferred to use the first current-to-voltage converter circuit I-V1 with a smaller number of diodes, as each of the two I-V converters in a control circuit as shown in FIGS. 69 and 70. However, the second current-to-voltage converter circuit (I-V2), with a larger number of diodes, may give the same meritorious effect insofar as the circuit operation is concerned.

In FIG. 68, the gates of n-channel transistors M1 and M2 are connected in common, and M1 has a gate and a drain connected together. The gates of p-channel transistors M3, M4, M5 and M12 are connected in common, and M4 has a gate and a drain connected together. Hence, the n-channel transistors M1 and M2 and the p-channel transistors M3, M4, M5 and M12 each constitute a current mirror circuit. The current mirror circuit of the p-channel transistors M3 and M4 self-biases the current mirror circuit of the n-channel transistors M1 and M2.

Hence, the current I1 flows through transistors M1, M3 to drive the first current-to-voltage converter circuit (I-V1), made up of parallel connection of the diode D1 and the resistor R4, while driving the second current-to-voltage converter circuit (I-V2), made up of series connection of the resistor R1 and the diodes D2 and the resistor R2 connected in parallel with the series connection.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

Similarly, n-channel transistors M6 and M7 have gates coupled together, while M7 has its gate and drain coupled together. The p-channel transistors M8 to M10 have gates coupled together, while M8 has its gate and drain coupled together. Hence, the n-channel transistors M6 and M7 and the p-channel transistors M8 to M10 each constitute a current mirror circuit, with the current mirror circuit of the p-channel transistors M8, M9 self-biasing the current mirror circuit of the n-channel transistors M6 and M7.

Hence, a current I4 flows through the transistors M6 and M8 to drive a third current-to-voltage converter circuit (I-V3), made up of a diode D3, while driving a fourth current-to-voltage converter circuit (I-V4), made up of a series connection of a resistor R5 and diodes D4.

It is noted that N diodes D2 of the second current-to-voltage converter circuit (I-V2) are connected in parallel and M diodes D2 of the fourth current-to-voltage converter circuit (I-V4) are also connected in parallel.

The current from the transistors M5, M10 drives the resistor R3 to generate an output voltage Vref from the terminal voltage of the resistor R3.

The operation of the present embodiment is now described. By self-biasing, the OP amp in the configuration of FIG. 35 may be dispensed with, as shown in FIG. 68. In this figure, the gates of n-channel transistors M1 and M2 are connected in common, and M1 has a gate and a drain connected together. The gates of p-channel transistors M3, M4, M5 and M12 are connected in common, and M4 has a gate and a drain connected together. Hence, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors M1 and M2.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other, and hence the terminal voltage VA at the diode D1 and the resistor R4 of the first current-to-voltage converter circuit (I-V1) is equal to the terminal voltage VB at the resistor R1 and the resistor R2 of the second current-to-voltage converter circuit (I-V2). Hence, the operating condition equivalent to that with the use of the OP amp, described above, may be achieved.

In similar manner, the gates of n-channel transistors M6 and M7 are connected in common, and M6 has a gate and a drain connected together. The gates of p-channel transistors M8, M9 and M10 are connected in common, and M8 has a gate and a drain connected together. Hence, the n-channel transistors M6 and M7 and the p-channel transistors M8, M9 and M10 have gates coupled together, and M8 has its gate and drain coupled together. Hence, the n-channel transistors M6 and M7 and the p-channel transistors M8, M9 and M10 each constitute a current mirror circuit. The current mirror circuit of the p-channel transistors M8, M9 self-biases the current mirror circuit of the n-channel transistors M6 and M7.

The currents flowing through the n-channel transistors M6 and M7 are proportional to each other. If the n-channel transistors M6 and M7 are of the same size and the p-channel transistors M8, M9 are of the same size, the currents through the n-channel transistors M6 and M7 are equal to each other.

With self-biasing, the gate source voltages of the n-channel transistors M6 and M7 are equal to each other. Hence, the terminal voltage VC of the third current-to-voltage converter circuit (I-V3), made up of the diode D3, is equal to the terminal voltage VD of the fourth current-to-voltage converter circuit (I-V4), made up of a series connection of diodes D4 and the resistor R5, thus achieving the same operating conditions as those with the use of the OP amp as described above. That is, the characteristic equivalent to that of FIG. 35 may be achieved, thus implementing a reference voltage generating circuit.

However, the above-described reference voltage generating circuit, shown in FIG. 68, may be affected by transistor channel length modulation. For simplicity, the startup circuit is dispensed with.

### Other Embodiment of the Invention

Referring to FIG. 69, n-channel transistors M1 and M2, p-channel transistors M5 and M7 and n-channel transistors M3 and M4 each constitute a current mirror circuit. The sources of the n-channel transistors M1 and M2 are connected to a terminal of the first current-to-voltage converter circuit (I-V1), made up of parallel connection of a diode D1 and a resistor R3, and to a terminal of the second current-to-voltage converter circuit (I-V2), made up of a series connection of a resistor R1 and parallel-connected diodes D1 and a resistor R2 connected in parallel with the series connection. The p-channel transistors M5 and M7 are connected between the drains of the n-channel transistors M1 and M2 and the power supply VDD and have drains and gates connected together. The n-channel transistors M3 and M4 have sources connected to two first current-to-voltage converter circuits (I-V1), while having gates connected in common.

There are p-channel transistors M6 and M8, connected between the drains of the n-channel transistors M3 and M4 and the power supply VDD, and the gates of the n-channel transistors M1 and M2, are connected in common and are connected to the drain of the n-channel transistor M4. The p-channel transistors M5 and M6 have gates coupled together to constitute a current mirror circuit, whereas the p-channel transistors M7-M9 also have gates coupled together to constitute a current mirror circuit.

Thus, the current I1 flows through transistors M1, M7 to drive the first current-to-voltage converter circuit (I-V1) made up of parallel connection of the diode D1 and the resistor R3. Similarly, the current I2 flows through transistors M2, M5 to drive the second current-to-voltage converter circuit (I-V2) made up of series connection of the resistor R1 and parallel-connected diodes D2 and the resistor R2 connected in parallel with the series connection.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

The number of the parallel-connected diodes D2 of the second current-to-voltage converter circuit (I-V2) is N. In similar manner, n-channel transistors M10 and M11, p-channel transistors M16, M18, and n-channel transistors M13, M14 each constitute a current mirror circuit. The sources of the n-channel transistors M10 and M11 are connected to a terminal of a third current-to-voltage converter circuit (I-V3), made up of a diode D5, and to a terminal of a fourth current-to-voltage converter circuit (I-V4), made up of a series connection of a resistor R6 and diodes D6. The p-channel transistors M16 and M18 are connected between the drains of the n-channel transistors M10 and M11 and the power supply VDD and have drains and gates connected together. The n-channel transistors M13, M14 have sources connected to two third current-to-voltage converter circuits (I-V3) and have gates connected together. There are p-channel transistors M15 and M17, connected between the drains of the n-channel transistors M13, M14 and the power supply VDD, and the gates of the n-channel transistors M10 and M11, are connected in common and connected to the drain of the n-channel transistor M14. The p-channel transistors M15, M16 have gates coupled together to constitute a current mirror circuit, whereas the p-channel transistors M17-M19 have gates coupled together to constitute a current mirror circuit.

Thus, the currents I4 flows through transistors M10, M18 to drive the third current-to-voltage converter circuit (I-V3) made up of a diode D5. Similarly, the current I5 flows through transistors M11, M16 to drive the fourth current-to-voltage converter circuit (I-V4) made up of a series connection of the resistor R6 and the parallel-connected diodes D6. The number of the parallel-connected diodes D6 of the fourth current-to-voltage converter circuit (I-V4) is M.

The current I3 flows through the transistor M9, whereas the current I6 flows through the transistor M19. A sum current of the currents I3 and I4 flows through resistor R7 to generate an output voltage Vref from a terminal of the resistor R7.

The operation of the present embodiment is now described. In FIG. 69, the currents flowing through the n-channel transistors M1 and M2, connected to the first and second current-to-voltage converter circuits, respectively, are compared to each other via the current mirror circuit made up of the p-channel transistors M5-M6 and the current mirror circuit made up of the p-channel transistors M7-M9, in the current mirror circuit made up of the n-channel transistors M3 and M4. The common gate voltage of the n-channel transistors M1 and M2 is controlled so that the currents flowing through the n-channel transistors M1 and M2 will be equal to each other. The first current-to-voltage converter circuit is made up of parallel connection of the diode D1 and the resistor R2, whereas the second current-to-voltage converter circuit is made up of series connection of the resistor R1 and the diodes D2, and the resistor R2, connected in parallel with the series connection, as described above.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

Since the gate source voltages of the n-channel transistors M1 and M2 become equal to each other, the voltage VA applied to the first current-to-voltage converter circuit becomes equal to that applied to the second current-to-voltage converter circuit, thus achieving the same operating condition as that of using the OP amp as described above. The first current-to-voltage converter circuit is made up of parallel connection of the diode D1 and the resistor R3, whereas the second current-to-voltage converter circuit is made up of series connection of the resistor R1 and the diodes D2, and the resistor R2 connected in parallel with the series connection, as described above. That is, the characteristic equivalent to that of FIG. 34 may be achieved, thus implementing the reference voltage generating circuit.

It is noted that the two first current-to-voltage converter circuits (I-V1) are inserted so that the drain currents of the n-channel transistors M3 and M4 will be equal to each other.

In similar manner, the currents flowing through the n-channel transistors M10 and M11, connected to the first and second current-to-voltage converter circuits, are compared to each other via the current mirror circuit made up of the p-channel transistors M15 and M16 and the current mirror circuit made up of the p-channel transistors M17-M19, in the current mirror circuit made up of the n-channel transistors M13 and M14. The common gate voltage of the n-channel transistors M10 and M11 is controlled so that the currents I1 and I2 flowing through the n-channel transistors M10 and M11 will be equal to each other. The first current-to-voltage converter circuit is made up of the diode D5, whereas the second current-to-voltage converter circuit is made up of series connection of the resistor R6 and the diode D6, as described above.

Since the gate source voltages of the n-channel transistors M10 and M11 become equal to each other, the voltage VC applied to the third current-to-voltage converter circuit becomes equal to the voltage VD applied to the fourth current-to-voltage converter circuit, thus achieving the same operating condition as that of using the OP amp as described above. The third current-to-voltage converter circuit is made up of the diode D3, whereas the fourth current-to-voltage converter circuit is made up of series connection of the resistor R6 and diodes D6, as described above. That is, the characteristic equivalent to that of FIG. 35 may be achieved, thus implementing a reference voltage generating circuit. The two third current-to-voltage converter circuits (I-V3) are inserted so that the drain voltages of the n-channel transistors M12 and M13 will be equal to each other.

The current I3 flows through the transistor M9, whereas the current I6 flows through the transistor M18. A sum current of the currents I3 and I6 flows through resistor R3 to generate an output voltage Vref from a terminal of the resistor R3.

### Other Embodiment of the Invention

In FIG. 70, a resistor R5 is connected between the source of a p-channel transistor M4 and the power supply VDD. Since the p-channel transistor M4 has the gate voltage in common with a p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

Similarly, a resistor R7 is connected between the source of a p-channel transistor M11 and the power supply VDD. Since the p-channel transistor M11 has the gate voltage in common with a p-channel transistor M12, the transistor size of the p-channel transistor M11 is selected to be larger than that of the p-channel transistor M12 so that the currents through the two transistors will be equal to each other. The current mirror circuit made up of the p-channel transistors M11 and M12 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3 and M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit is equal to that applied to the second current-to-voltage converter circuit, thus achieving the same operating condition as that with the use of the OP amp as described above. The first current-to-voltage converter circuit is made up of parallel connection of the diode D1 and the resistor R3, whereas the second current-to-voltage converter circuit is made up of series connection of the resistor R1 and the diodes D2 and the resistor R2 connected in parallel with the series connection.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

When the current through the n-channel transistor M8 is increased, the current flowing through the p-channel transistor M11 is correspondingly increased. However, the current flowing through the p-channel transistor M12 becomes larger than the increased current through the p-channel transistor M8. Hence, the so increased current cannot flow through the n-channel transistor M9, thus increasing the drain voltage of the p-channel transistor M12 and decreasing the current through the p-channel transistor M13, the gate of which is connected to the drain of the p-channel transistor M12. Thus, the current flowing through the n-channel transistor M10, having the common drain current.

The n-channel transistors M10 and M9 constitute a current mirror circuit and, since the n-channel transistors M8 and M9 have the gate voltage in common, the common gate voltage of M8-M10 decreases, so that the current flowing through the n-channel transistor M1 decreases.

That is, the current loop, composed of the n-channel transistors M8-M10 and the p-channel transistors M11-M13, constitutes a negative feedback circuit and controls the common gate voltage of the n-channel transistors M8 and M9, via inverse-Widlar current mirror circuit, so that the currents through the n-channel transistors M8, M9 will become of a preset value, herein equal to each other.

Since the gate source voltages of the n-channel transistors M8, M9 become equal to each other, the voltage applied to the third current-to-voltage converter circuit becomes equal to that applied to the fourth current-to-voltage converter circuit, thus achieving the same operating condition as that of using the OP amp as described above. The third current-to-voltage converter circuit is made up of the diode D6, whereas the fourth current-to-voltage converter circuit is made up of a series connection of the resistor R6 and diodes D6, as described above.

The current I3 flows through the transistor M7, whereas the current I6 flows through the transistor M14. A sum current of the currents I3 and I6 flows through resistor R8 to generate an output voltage Vref from a terminal of the resistor R8.

That is, the characteristic equivalent to that of FIG. 35 may be achieved, thus implementing a reference voltage generating circuit. The two third current-to-voltage converter circuits (I-V3) are inserted so that the drain voltages of the n-channel transistors M10, M8 will be equal to each other.

### Other Embodiment of the Invention

In the embodiment (FIG. 36) of the present invention (claim 15), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

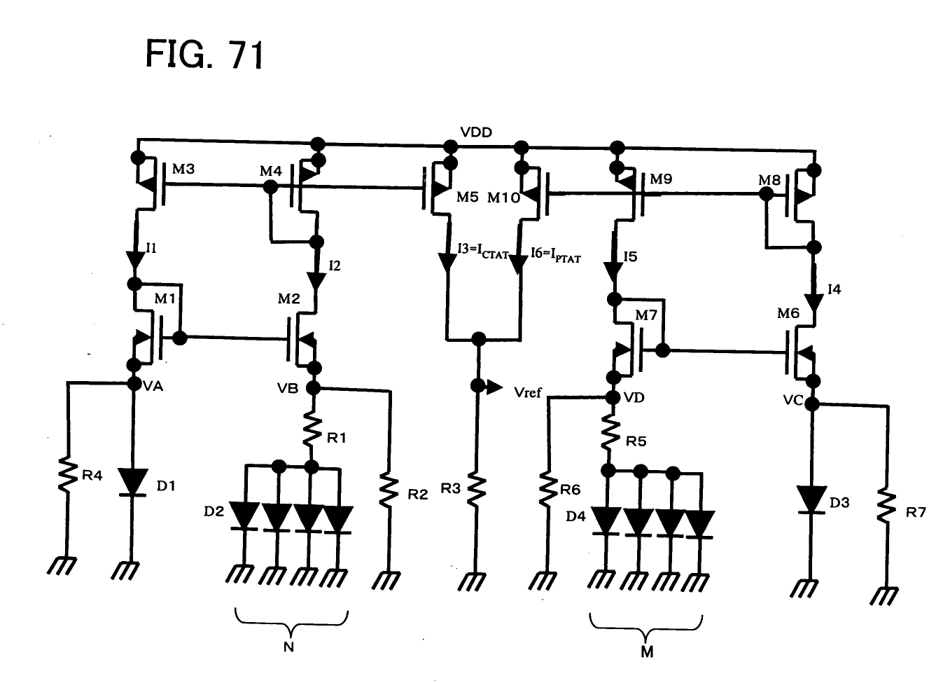

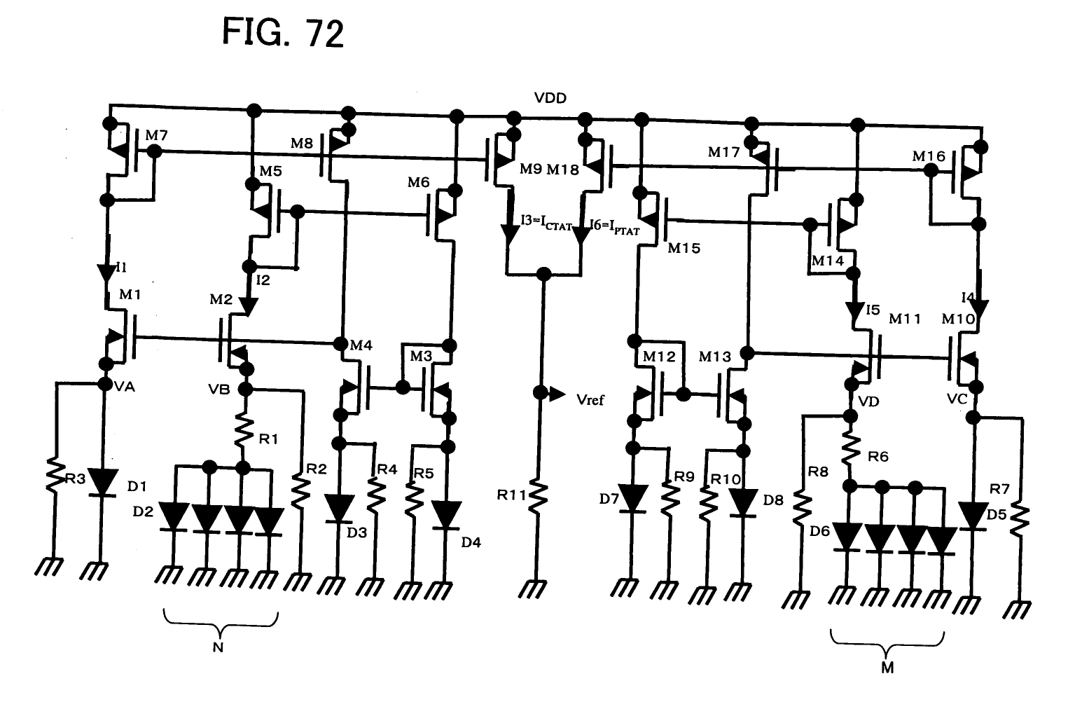

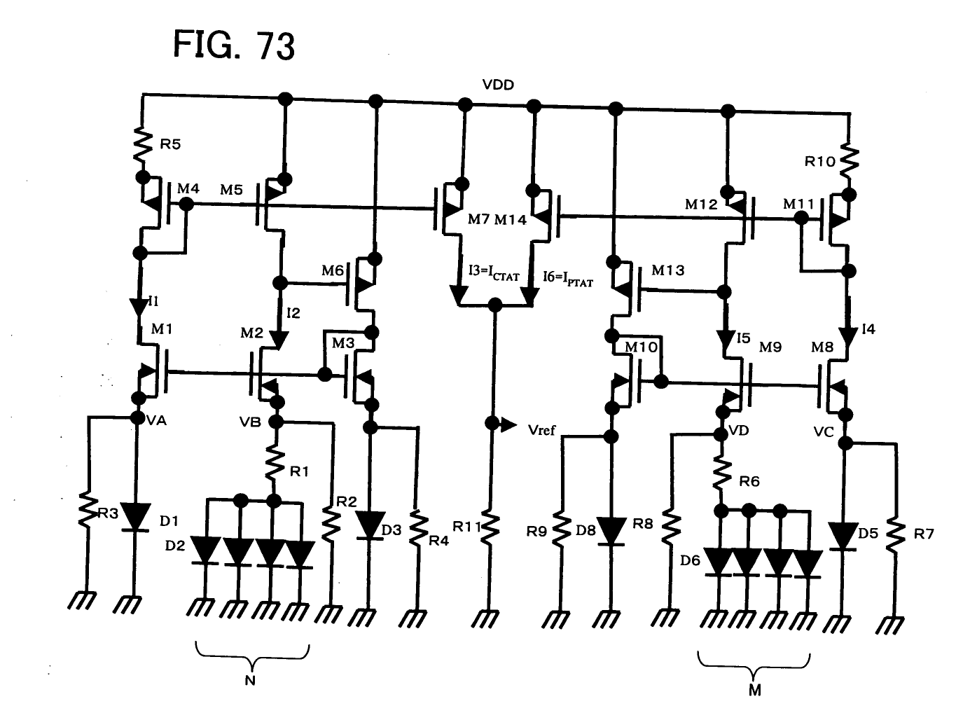

Specifically, the reference voltage generating circuit of FIG. 36 is developed as shown in FIGS. 71 to 73. For reducing the chip size, it is preferred to use the first current-to-voltage converter circuit I-V1 with a smaller number of diodes, as each of the two I-V converters in a control circuit as shown in FIGS. 72 and 73. However, the second current-to-voltage converter circuit (I-V2), with a larger number of diodes, may give the same meritorious effect insofar as the circuit operation is concerned.

In FIG. 71, the gates of n-channel transistors M1 and M2 are connected in common, and M1 has a gate and a drain connected together. The gates of p-channel transistors M3, M4 and M5 are connected in common, and M4 has a gate and a drain connected together. Hence, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors M1 and M2.

Hence, the current I1 flows through transistors M1, M3 to drive the first current-to-voltage converter circuit (I-V1), made up of the diode D1 and the resistor R4 connected in parallel therewith, as well as to drive the second current-to-voltage converter circuit (I-V2), made up of series connection of a resistor R1 and diodes D2 and a resistor R2 connected in parallel with the series connection.

Similarly, n-channel transistors M6 and M7 have gates coupled together, while M7 has its gate and drain coupled together. The p-channel transistors M8 to M10 have gates coupled together, while M8 has its gate and drain coupled together. Hence, the n-channel transistors M6 and M7 and the p-channel transistors M8 to M10 each constitute a current mirror circuit, with the current mirror circuit of the p-channel transistors M8, M9 self-biasing the current mirror circuit of the n-channel transistors M6 and M7.

Hence, a current I4 flows through the transistors M6 and M8 to drive a third current-to-voltage converter circuit (I-V3), made up of parallel connection of a diode D3 and a resistor R7, as well as to drive a fourth current-to-voltage converter circuit (I-V4), made up of a series connection of a resistor R5 and diodes D4 and a resistor R6 connected in parallel with the series connection.

It is noted that N diodes D2 of the second current-to-voltage converter circuit (I-V2) are connected in parallel and M diodes D4 of the fourth current-to-voltage converter circuit (I-V4) are also connected in parallel.

The current from the transistors M5, M10 drives the resistor R3 to generate an output voltage Vref from the terminal voltage of the resistor R3.

The operation of the present embodiment is now described. By self-biasing, the OP amp in the configuration of FIG. 36 may be dispensed with. In FIG. 71, the gates of n-channel transistors M1 and M2 are connected in common, and M1 has a gate and a drain connected together. The gates of p-channel transistors M3, M4 and M5 are connected in common, and M4 has a gate and a drain connected together.

Hence, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other, and hence the terminal voltage VA at the resistor R4 and the diode D1 of the first current-to-voltage converter circuit (I-V1) is equal to the terminal voltage VB at the resistors R1, R2 of the second current-to-voltage converter circuit (I-V2). The first current-to-voltage converter circuit is made up of parallel connection of the diode D1 and the resistor R4, whereas the second current-to-voltage converter circuit is made up of series connection of the resistor R1 and the diodes D2, and the resistor R2 connected in parallel with the series connection. Hence, the operating condition equivalent to that with the use of the OP amp, described above, may be achieved.

In similar manner, the gates of n-channel transistors M6 and M7 are connected in common, and M6 has a gate and a drain connected together. The gates of p-channel transistors M8, M9 and M10 are connected in common, and M8 has a gate and a drain connected together. Hence, the n-channel transistors M6 and M7 and the p-channel transistors M8, M9 and M10 each constitute a current mirror circuit. The current mirror circuit of the p-channel transistors M8, M9 self-biases the current mirror circuit of the n-channel transistors M6 and M7.

The currents flowing through the n-channel transistors M6 and M7 are proportional to each other. If the n-channel transistors M6 and M7 are of the same size and the p-channel transistors M8, M9 are of the same size, the currents through the n-channel transistors M6 and M7 are equal to each other.

With self-biasing, the gate source voltages of the n-channel transistors M6 and M7 are equal to each other. Hence, the terminal voltage VC of the third current-to-voltage converter circuit (I-V3) is equal to the terminal voltage VD of the fourth current-to-voltage converter circuit (I-V4), thus achieving the same operating conditions as those with the use of the OP amp as described above. The third current-to-voltage converter circuit is made up of parallel connection of the diode D3 and the resistor R7, whereas the fourth current-to-voltage converter circuit is made up of series connection of the resistor R5 and diodes D4, and the resistor R6, connected in parallel with the series connection. That is, the characteristic equivalent to that of FIG. 34 may be achieved, thus implementing a reference voltage generating circuit.

However, the above-described reference voltage generating circuit, shown in FIG. 71, may be affected by transistor channel length modulation. For simplicity, the startup circuit is dispensed with.

### Other Embodiment of the Invention

Referring to FIG. 72, n-channel transistors M1 and M2, p-channel transistors M5 and M7 and n-channel transistors M3 and M4 each constitute a current mirror circuit. The sources of the n-channel transistors M1 and M2 are connected to a terminal of the first current-to-voltage converter circuit (I-V1) and to a terminal of the second current-to-voltage converter circuit (I-V2). The first current-to-voltage converter circuit is made up of parallel connection of a diode D1 and a resistor R3, whereas the second current-to-voltage converter circuit is made up of a series connection of a resistor R1 and parallel-connected diodes D2 and a resistor R2 connected in parallel with the series connection. The p-channel transistors M5 and M7 are connected between the drains of the n-channel transistors M1 and M2 and the power supply VDD and have drains and gates connected together. The n-channel transistors M3 and M4 have sources connected to two first current-to-voltage converter circuits (I-V1), while having gates connected in common.

There are p-channel transistors M6 and M8, connected between the drains of the n-channel transistors M3 and M4 and the power supply VDD, and the gates of the n-channel transistors M1 and M2, are connected in common and connected to the drain of the n-channel transistor M4. The p-channel transistors M5 and M6 have gates coupled together to constitute a current mirror circuit, whereas the p-channel transistors M7-M9 also have gates coupled together to constitute a current mirror circuit.

Thus, the currents I1 flows through transistors M1, M7 to drive the first current-to-voltage converter circuit (I-V1), made up of parallel connection of the diode D1 and the resistor R3. Similarly, the current I2 flows through transistors M2, M5 to drive the second current-to-voltage converter circuit (I-V2), made up of series connection of the resistor R1 and the parallel-connected diodes D2 and the resistor R2 connected in parallel with the series connection. The number of the parallel-connected diodes D2 of the second current-to-voltage converter circuit (I-V2) is N.

In similar manner, n-channel transistors M10 and M11, p-channel transistors M14, M16, and n-channel transistors M12 and M13 each constitute a current mirror circuit. The sources of the n-channel transistors M10 and M11 are connected to a terminal of a third current-to-voltage converter circuit (I-V3), made up of parallel connection of a diode D5 and a resistor R7, and to a terminal of a fourth current-to-voltage converter circuit (I-V4), made up of series connection of a resistor R6 and diodes D6 and a resistor R8 connected in parallel with the series connection. The p-channel transistors M14, M16 are connected between the drains of the n-channel transistors M10 and M11 and the power supply VDD and have drains and gates connected together. The n-channel transistors M12 and M13 have sources connected to two third current-to-voltage converter circuits (I-V3) and have gates connected together.

There are p-channel transistors M15 and M17, connected between the drains of the n-channel transistors M12 and M13 and the power supply VDD, and the gates of the n-channel transistors M10 and M11 are connected in common and connected to the drain of the n-channel transistor M13. The p-channel transistors M14, M15 have gates coupled together to constitute a current mirror circuit, whereas the p-channel transistors M16-M18 have gates coupled together to constitute a current mirror circuit.

Thus, the current I4 flows through transistors M10, M16 to drive the third current-to-voltage converter circuit (I-V3) made up of parallel connection of the diode D5 and the resistor R7. Similarly, the current I5 flows through transistors M11, M15 to drive the fourth current-to-voltage converter circuit (I-V4) made up of series connection of the resistor R6 and parallel-connected diodes D6 and the resistor R8 connected in parallel with the series connection. The number of the parallel-connected diodes D6 of the fourth current-to-voltage converter circuit (I-V4) is M.

The current I3 flows through the transistor M9, whereas the current I6 flows through the transistor M18. A sum current of the currents I3 and I6 flows through resistor R11 to generate an output voltage Vref from a terminal voltage of the resistor R7.

The operation of the present embodiment is now described. In FIG. 72, the currents flowing through the n-channel transistors M1 and M2, connected to the first and second current-to-voltage converter circuits, respectively, are compared to each other via the current mirror circuit made up of the p-channel transistors M5-M6 and the current mirror circuit made up of the p-channel transistors M7-M9, in the current mirror circuit made up of the n-channel transistors M3-M4. The common gate voltage of the n-channel transistors M1 and M2 is controlled so that equal currents will flow through the n-channel transistors M1 and M2. The first current-to-voltage converter circuit is made up of parallel connection of the diode D1 and the resistor R3, whereas the second current-to-voltage converter circuit is made up of series connection of the resistor R1 and diodes D2, and the resistor R2, connected in parallel with the series connection, as described above.

Since the gate source voltages of the n-channel transistors M1 and M2 become equal to each other, the voltage VA applied to the first current-to-voltage converter circuit becomes equal to that applied to the second current-to-voltage converter circuit, thus achieving the same operating condition as that of using the OP amp as described above. The first current-to-voltage converter circuit is made up of the parallel connection of the diode D1 and the resistor R3, whereas the second current-to-voltage converter circuit is made up of series connection of the resistor R1 and diodes D2 and the resistor R2 connected in parallel with the series connection, as described above. That is, the characteristic equivalent to that of FIG. 36 may be achieved, thus implementing the reference voltage generating circuit. It is noted that the two first current-to-voltage converter circuits (I-V1) are inserted so that the drain voltages of the n-channel transistors M3 and M4 will be equal to each other.

In similar manner, the currents flowing through the n-channel transistors M10 and M11, connected to the third and fourth current-to-voltage converter circuits, are compared to each other via the current mirror circuit made up of the p-channel transistors M14-M15 and the current mirror circuit made up of the p-channel transistors M16-M18, in the current mirror circuit made up of the n-channel transistors M12 and M13. The common gate voltage of the n-channel transistors M10 and M11 is controlled so that equal currents I1 and I2 will flow through the n-channel transistors M10 and M11, respectively. The third current-to-voltage converter circuit is made up of parallel connection of the diode D5 and the resistor R7, whereas the fourth current-to-voltage converter circuit is made up of series connection of the resistor R6 and the diode D6 and the resistor R8 connected in parallel with the series connection, as described above.

Since the gate source voltages of the n-channel transistors M10 and M11 become equal to each other, the voltage VC applied to the third current-to-voltage converter circuit becomes equal to the voltage VD applied to the fourth current-to-voltage converter circuit, thus achieving the same operating condition as that of using the OP amp as described above. The third current-to-voltage converter circuit is made up of parallel connection of the diode D5 and the resistor R7, whereas the fourth current-to-voltage converter circuit is made up of a series connection of the resistor R6 and diodes D6, and the resistor R8, connected in parallel with the series connection, as described above. That is, the characteristic equivalent to that of FIG. 36 may be achieved, thus implementing a reference voltage generating circuit. The two third current-to-voltage converter circuits (I-V3) are inserted so that the drain voltages of the n-channel transistors M12 and M13 will be equal to each other.

The current I3 flows through the transistor M9, whereas the current I6 flows through the transistor M18. A sum current of the currents I3 and I6 flows through resistor R11 to generate an output voltage Vref from a terminal of the resistor R11.

### Other Embodiment of the Invention

In FIG. 73, a resistor R5 is connected between the source of the p-channel transistor M4 and the power supply VDD. Since the p-channel transistor M4 has the gate voltage in common with the p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

Similarly, a resistor R10 is connected between the source of the p-channel transistor M11 and the power supply VDD. Since the p-channel transistor M11 has the gate voltage in common with the p-channel transistor M12, the transistor size of the p-channel transistor M11 is selected to be larger than that of the p-channel transistor M12 so that the currents through the two transistors will be equal to each other. The current mirror circuit made up of the p-channel transistors M11 and M12 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3 and M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M4 and the p-channel transistors M4-M6, constitutes a negative feedback circuit that controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit is equal to that applied to the second current-to-voltage converter circuit, thus achieving the same operating condition as that with the use of the OP amp as described above. The first current-to-voltage converter circuit is made up of a parallel connection of the diode D1 and the resistor R3, whereas the second current-to-voltage converter circuit is made up of a series connection of the resistor R1 and diodes D2 and the resistor R2 connected in parallel with the series connection.

In similar manner, when the current through the n-channel transistor M8 is increased, the current flowing through the p-channel transistor M11 is correspondingly increased. However, the current flowing through the p-channel transistor M12 becomes larger than the increased current through the p-channel transistor M8. Hence, the so increased current cannot flow through the n-channel transistor M9, thus increasing the drain voltage of the p-channel transistor M12 and decreasing the current through the p-channel transistor M13, the gate of which is connected to the drain of the p-channel transistor M12.

Hence, the current flowing through the p-channel transistor M10, having the common drain current, also decreases. The n-channel transistors M10, M9 constitute a current mirror circuit and, since the n-channel transistors M8, M9 have the gate voltage in common, the common gate voltage of M8-M10 decreases, so that the current flowing through the n-channel transistor M1 decreases.

That is, the current loop, composed of the n-channel transistors M8-M10 and the p-channel transistors M11-M13, constitutes a negative feedback circuit and controls the common gate voltage of the n-channel transistors M8, M9, via inverse-Widlar current mirror circuit, so that the currents through the n-channel transistors M8, M9 will become of a preset value, herein equal to each other.

Since the gate source voltages of the n-channel transistors M8, M9 become equal to each other, the voltage applied to the third current-to-voltage converter circuit becomes equal to that applied to the fourth current-to-voltage converter circuit, thus achieving the same operating condition as that of using the OP amp as described above. The third current-to-voltage converter circuit is made up of the diode D6, whereas the fourth current-to-voltage converter circuit is made up of series connection of the resistor R6 and diodes D6, as described above.

The current I3 flows through the transistor M7, whereas the current I6 flows through the transistor M14. A sum current of the currents I3 and I6 flows through resistor R11 to generate an output voltage Vref from a terminal of the resistor R11.

That is, the characteristic equivalent to that of FIG. 36 may be achieved, thus implementing a reference voltage generating circuit. The two third current-to-voltage converter circuits (I-V3) are inserted so that the drain voltages of the n-channel transistors M10, M8 will be equal to each other.

### Other Embodiment of the Invention

In the embodiment (FIG. 38) of the present invention (claim 17), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

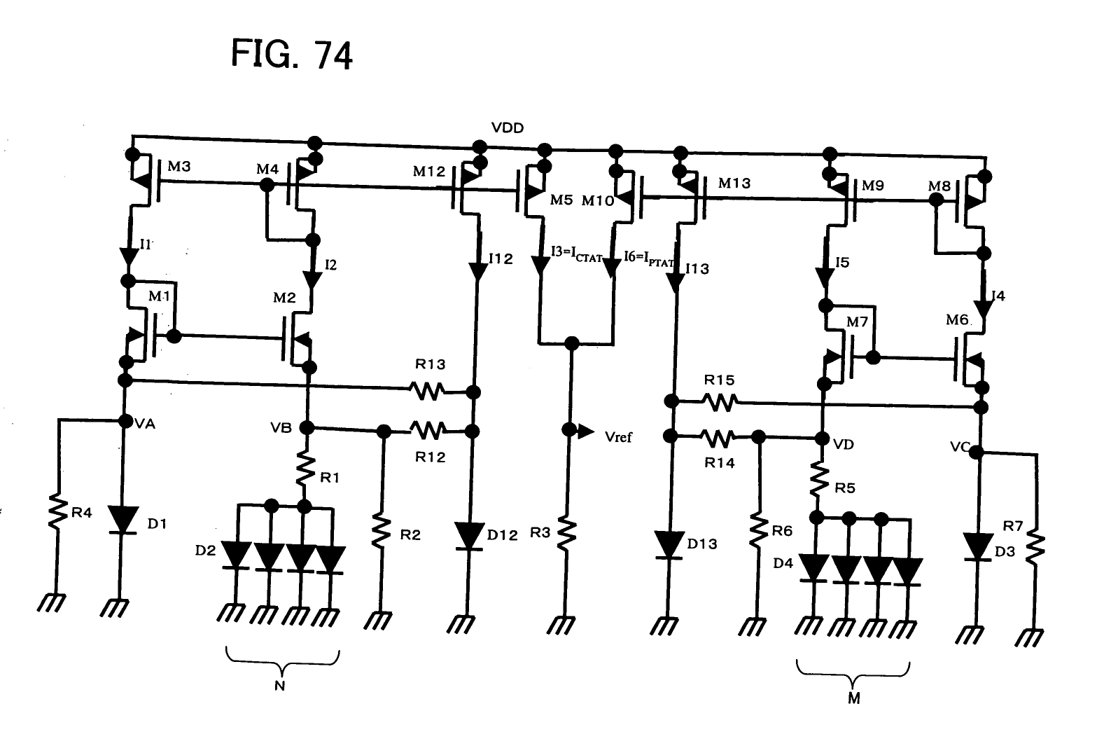

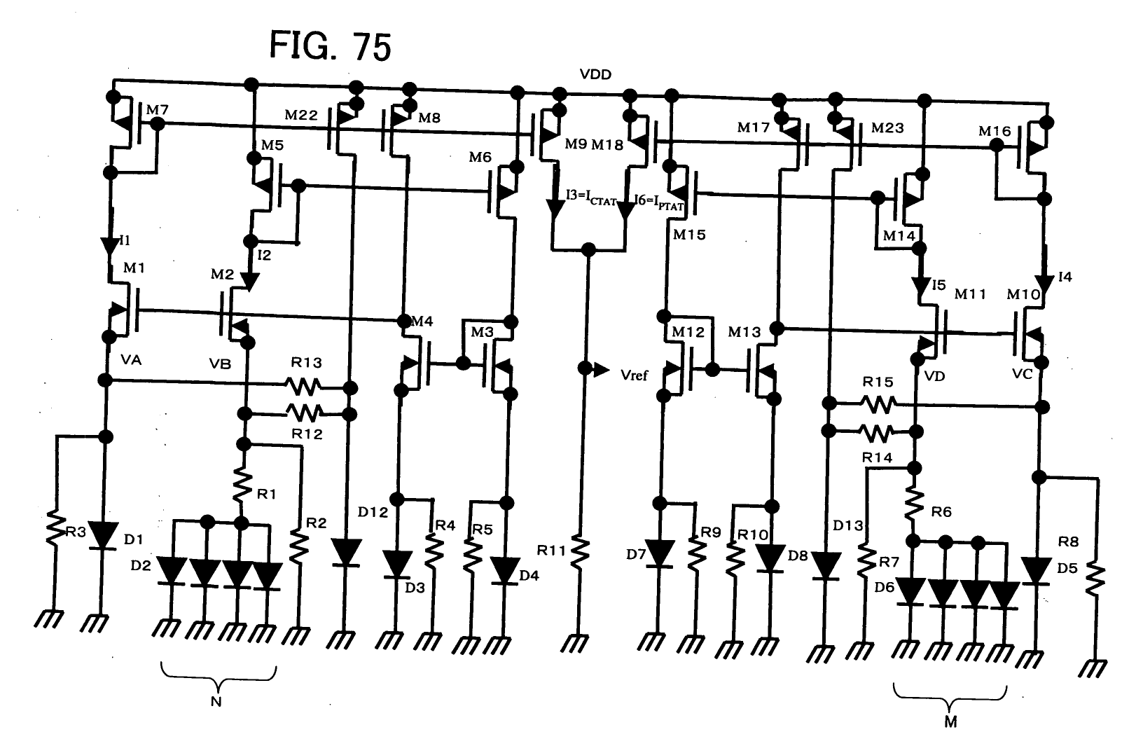

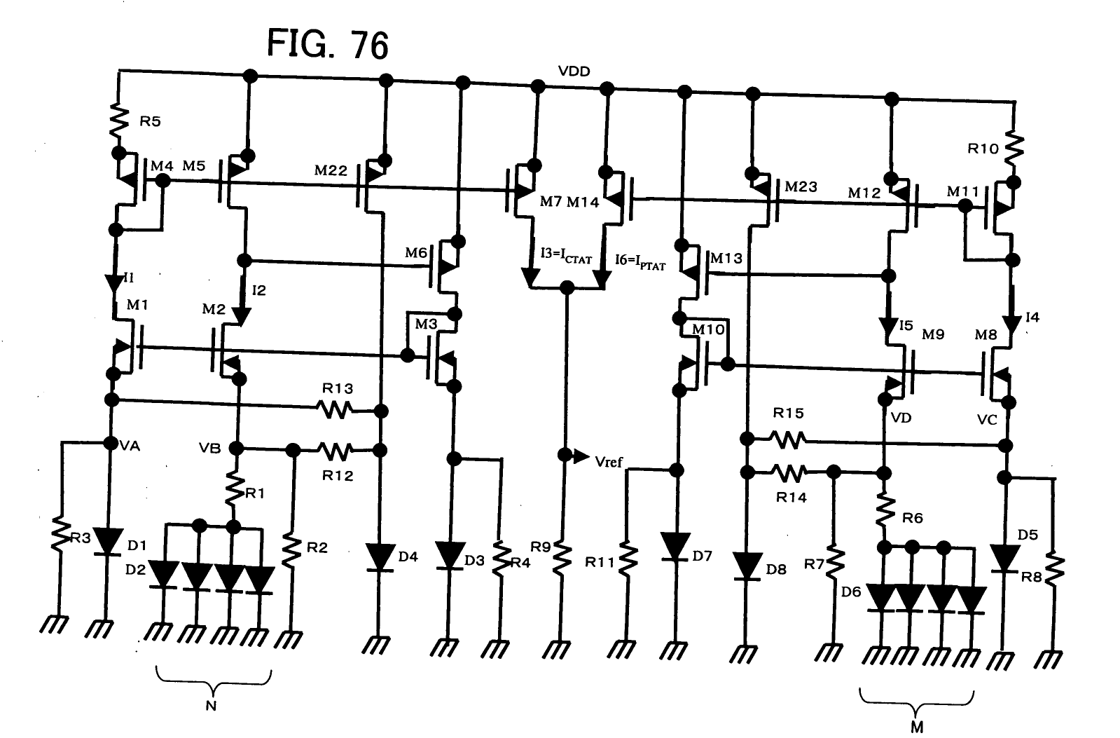

Specifically, the reference voltage generating circuit of FIG. 38 is developed as shown in FIGS. 74 to 76. For reducing the chip size, it is preferred to use the first current-to-voltage converter circuit I-V1 with a smaller number of diodes, as each of the two I-V converters in a control circuit as shown in FIGS. 75 and 76. However, the second current-to-voltage converter circuit (I-V2), with a larger number of diodes, may give the same meritorious effect insofar as the circuit operation is concerned.

In FIG. 74, the gates of n-channel transistors M1 and M2 are connected in common, and M1 has a gate and a drain connected in common. The gates of p-channel transistors M3, M4, M5 and M12 are connected in common, and M4 has a gate and a drain connected in common. Hence, the n-channel transistors M1 and M2 and the p-channel transistors M3, M4, M5 and M6 each constitute a current mirror circuit. The current mirror circuit of the p-channel transistors M3 and M4 self-biases the current mirror circuit of the n-channel transistors M1 and M2.

Hence, the current I1 flows through transistors M1, M3 to drive a first current-to-voltage converter circuit (I-V1), made up of parallel connection of a diode D1 and a resistor R4, as well as to drive a second current-to-voltage converter circuit (I-V2), made up of series connection of a resistor R1 and diodes D2 and a resistor R2 connected in parallel with the series connection.

The p-channel MOS transistor M12 is added to compensate for non-linearity of diodes, in order to drive a diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

Similarly, n-channel transistors M6 and M7 have gates coupled together, while M6 has its gate and drain coupled together. The p-channel transistors M8 to M10 have gates coupled together, while M8 has its gate and drain coupled together. Hence, the n-channel transistors M6 and M7 and the p-channel transistors M8 to M10 each constitute a current mirror circuit, with the current mirror circuit of the p-channel transistors M8, M9 self-biasing the current mirror circuit of the n-channel transistors M6 and M7.

Hence, a current I4 flows through the transistors M6 and M8 to drive the third current-to-voltage converter circuit (I-V3), made up of parallel connection of a diode D3 and a resistor R7, as well as to drive the fourth current-to-voltage converter circuit (I-V4), made up of series connection of the resistor R5 and diodes D4 and the resistor R6 connected in parallel with the series connection.

The p-channel MOS transistor M13 is added to compensate for non-linearity of diodes, in order to drive a diode D13 and in order to supply the compensating currents between the terminal voltage of the diode D13 and the first current-to-voltage converter circuit (I-V1) and between the terminal voltage of the diode D13 and the second current-to-voltage converter circuit (I-V2), via resistors R15 and R14, respectively.

It is noted that N diodes D2 of the second current-to-voltage converter circuit (I-V2) are connected in parallel and M diodes D4 of the fourth current-to-voltage converter circuit (I-V4) are also connected in parallel.

The current from the transistors M5, M10 drives the resistor R3 to generate an output voltage Vref from the terminal voltage of the resistor R3.

The operation of the present embodiment is now described. By self-biasing, the OP amp in the configuration of FIG. 38 may be dispensed with, as shown in FIG. 74. In this figure, the gates of n-channel transistors M1 and M2 are connected in common, and M1 has a gate and a drain connected together. The gates of p-channel transistors M3, M4, M5 and M12 are connected in common, and M4 has a gate and a drain connected together. Hence, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors M1 and M2.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other, and hence the terminal voltage VA at the diode D1 and the resistor R4 of the first current-to-voltage converter circuit (I-V1) is equal to the terminal voltage VB at the resistor R1 and the resistor R2 of the second current-to-voltage converter circuit (I-V2). The first current-to-voltage converter circuit is made up of parallel connection of the diode D1 and the resistor R4, whereas the second current-to-voltage converter circuit is made up of series connection of the resistor R1 and the diodes D2 and the resistor R2 connected in parallel with the series connection. Hence, the operating condition equivalent to that with the use of the OP amp, described above, may be achieved.

In similar manner, the gates of n-channel transistors M6 and M7 are connected in common, and M6 has a gate and a drain connected together. The gates of p-channel transistors M8, M9 and M10 are connected in common, and M8 has a gate and a drain connected together. Hence, the n-channel transistors M6 and M7 and the p-channel transistors M8, M9 and M10 each constitute a current mirror circuit. The current mirror circuit of the p-channel transistors M8, M9 self-biases the current mirror circuit of the n-channel transistors M6 and M7.

The p-channel MOS transistor M13 is added to compensate for non-linearity of diodes, in order to drive the diode D13 and in order to supply the compensating currents between the terminal voltage of the diode D13 and the third current-to-voltage converter circuit (I-V3) and between the terminal voltage of the diode D13 and the fourth current-to-voltage converter circuit (I-V4), via resistors R15 and R14, respectively.

The currents flowing through the n-channel transistors M6 and M7 are proportional to each other. If the n-channel transistors M6 and M7 are of the same size and the p-channel transistors M8, M9 are of the same size, the currents through the n-channel transistors M6 and M7 are equal to each other.

With self-biasing, the gate source voltages of the n-channel transistors M6 and M7 are equal to each other. Hence, the terminal voltage VC of the third current-to-voltage converter circuit (I-V3) is equal to the terminal voltage VD of the fourth current-to-voltage converter circuit (I-V4), thus achieving the same operating conditions as those with the use of the OP amp as described above. The third current-to-voltage converter circuit is made up of parallel connection of the diode D3 and the resistor R7, whereas the fourth current-to-voltage converter circuit is made up of a series connection of a resistor R5 and diodes D4, and a resistor R6, connected in parallel with the series connection. That is, the characteristic equivalent to that of FIG. 38 may be achieved, thus implementing a reference voltage generating circuit.

However, the above-described reference voltage generating circuit, shown in FIG. 74, may be affected by transistor channel length modulation. For simplicity, the startup circuit is dispensed with.

### Other Embodiment of the Invention

Referring to FIG. 75, n-channel transistors M1 and M2, p-channel transistors M5 and M7 and n-channel transistors M3 and M4 each constitute a current mirror circuit. The sources of the n-channel transistors M1 and M2 are connected to a terminal of the first current-to-voltage converter circuit (I-V1) and to a terminal of the second current-to-voltage converter circuit (I-V2). The first current-to-voltage converter circuit is made up of parallel connection of a diode D1 and a resistor R3, whereas the second current-to-voltage converter circuit is made up of a series connection of a resistor R1 and parallel-connected diodes D2 and a resistor R2 connected in parallel with the series connection. The p-channel transistors M5 and M7 are connected between the drains of the n-channel transistors M1 and M2 and the power supply VDD and have drains and gates connected together. The n-channel transistors M3 and M4 have sources connected to two first current-to-voltage converter circuits (I-V1: first current-to-voltage converter circuit made up of D4 and R5 and first current-to-voltage converter circuit made up of D3 and R4), while having gates connected in common.

There are p-channel transistors M6 and M8, connected between the drains of the n-channel transistors M3 and M4 and the power supply VDD, and the gates of the n-channel transistors M1 and M2, are connected in common and connected to the drain of the n-channel transistor M4. The p-channel transistors M5 and M6 have gates coupled together to constitute a current mirror circuit, whereas the p-channel transistors M7-M9 also have gates coupled together to constitute a current mirror circuit.

Thus, the currents I1 flows through transistors M1, M7 to drive the first current-to-voltage converter circuit (I-V1), made up of parallel connection of a diode D1 and a resistor R3. Similarly, the current 12 flows through transistors M2, M5 to drive the second current-to-voltage converter circuit (I-V2), made up of a series connection of a resistor R1 and parallel-connected diodes D2 and a resistor R2 connected in parallel with the series connection.

The p-channel MOS transistor M22 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

The number of the parallel-connected diodes D2 of the second current-to-voltage converter circuit (I-V2) is N.

In similar manner, n-channel transistors M10 and M11, p-channel transistors M14, M16, and n-channel transistors M12 and M13 each constitute a current mirror circuit. The sources of the n-channel transistors M10 and M11 are connected to a terminal of the third current-to-voltage converter circuit (I-V3), made up of a parallel connection of a diode D5 and a resistor R8, and to a terminal of the fourth current-to-voltage converter circuit (I-V4), made up of a series connection of a resistor R6 and diodes D6 and a resistor R7 connected in parallel with the series connection. The p-channel transistors M14, M16 are connected between the drains of the n-channel transistors M10 and M11 and the power supply VDD and have drains and gates connected together. The n-channel transistors M12 and M13 have sources connected to two third current-to-voltage converter circuits (I-V3: third current-to-voltage converter circuit made up of D7 and R9 and third current-to-voltage converter circuit made up of D8 and R10) and have gates connected together. There are p-channel transistors M15 and M17, connected between the drains of the n-channel transistors M12 and M13 and the power supply VDD, and the gates of the n-channel transistors M10 and M11 are connected in common and connected to the drain of the n-channel transistor M13. The p-channel transistors M14, M15 have gates coupled together to constitute a current mirror circuit, whereas the p-channel transistors M16-M18 have gates coupled together to constitute a current mirror circuit.

The p-channel MOS transistor M23 is added to compensate for non-linearity of diodes, in order to drive the diode D13 and in order to supply the compensating currents between the terminal voltage of the diode D13 and the third current-to-voltage converter circuit (I-V3) (R5 and R8) and between the terminal voltage of the diode D13 and the fourth current-to-voltage converter circuit (I-V4) (R5, D6 and R7), via resistors R15 and R14, respectively.

Thus, the currents I4 flows through transistors M10, M16 to drive the third current-to-voltage converter circuit (I-V3) made up of the diode D5. Similarly, the current I5 flows through transistors M11, M15 to drive the fourth current-to-voltage converter circuit (I-V4) made up of series connection of the resistor R6 and parallel-connected diodes D6. The number of the parallel-connected diodes D6 of the fourth current-to-voltage converter circuit (I-V4) is M.

The current I3 flows through the transistor M9, whereas the current I6 flows through the transistor M18. A sum current of the currents I3 and I6 flows through resistor R11 to generate an output voltage Vref from a terminal voltage of the resistor R11.

The operation of the present embodiment is now described. In FIG. 75, the currents flowing through the n-channel transistors M1 and M2, connected to the first and second current-to-voltage converter circuits, respectively, are compared to each other via the current mirror circuit made up of the p-channel transistors M5-M6 and the current mirror circuit made up of the p-channel transistors M7-M9, in the current mirror circuit made up of the n-channel transistors M3-M4. The common gate voltage of the n-channel transistors M1 and M2 is controlled so that the currents flowing through the n-channel transistors M1 and M2 will be equal to each other. The first current-to-voltage converter circuit is made up of parallel connection of the diode D1 and resistors R3, whereas the second current-to-voltage converter circuit is made up of series connection of the resistor R1 and diodes D2 and the resistor R2 connected in parallel with the series connection, as described above.

The p-channel MOS transistor M22 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2) via resistors R13 and R12, respectively.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of parallel connection of the diode D1 and the resistor R3, whereas the second current-to-voltage converter circuit is made up of series connection of the resistor R1 and diodes D2 and the resistor R2 connected in parallel with the serial connection, as described above. That is, the characteristic equivalent to that of FIG. 38 may be achieved, thus implementing the reference voltage generating circuit. It is noted that two first current-to-voltage converter circuits (I-V1: D3-R4 and D4-R5) are inserted so that the drain voltages of the n-channel transistors M3 and M4 will be equal to each other.

In similar manner, the currents flowing through the n-channel transistors M10 and M11, connected to the first and second current-to-voltage converter circuits, are compared to each other via the current mirror circuit made up of the p-channel transistors M14-M15 and the current mirror circuit made up of the p-channel transistors M16-M18, in the current mirror circuit made up of the n-channel transistors M12-M13. The common gate voltage of the n-channel transistors M10 and M11 is controlled so that the currents flowing through the n-channel transistors M10 and M11, respectively, will be equal to each other. The first current-to-voltage converter circuit is made up of parallel connection of the diode D5 and the resistor R8, whereas the second current-to-voltage converter circuit is made up of series connection of the resistor R6 and diodes D6 and the resistor R7 connected in parallel with the series connection, as described above.

The p-channel MOS transistor M23 is added to compensate for non-linearity of diodes, in order to drive the diode D13 and in order to supply the compensating currents between the terminal voltage of the diode D13 and the third current-to-voltage converter circuit (I-V3) and between the terminal voltage of the diode D13 and the fourth current-to-voltage converter circuit (I-V4) via resistors R15 and R14, respectively.

Since the gate source voltages of the n-channel transistors M10 and M11 become equal to each other, the voltage VC applied to the third current-to-voltage converter circuit becomes equal to the voltage VD applied to the fourth current-to-voltage converter circuit, thus achieving the same operating condition as that of using the OP amp as described above. The third current-to-voltage converter circuit is made up of parallel connection of the diode D5 and resistor R8, whereas the fourth current-to-voltage converter circuit is made up of series connection of the resistor R6 and diodes D6 and the resistor R7 connected in parallel with the serial connection, as described above. That is, the characteristic equivalent to that of FIG. 38 may be achieved, thus implementing a reference voltage generating circuit. The two third current-to-voltage converter circuits (I-V3:D7-R9 and D8-R10) are inserted so that the drain voltages of the n-channel transistors M12 and M13 will be equal to each other.

The current I3 flows through the transistor. M9, whereas the current I6 flows through the transistor M18. A sum current of the currents I3 and I6 flows through resistor R11 to generate an output voltage Vref from a terminal of the resistor R11.

### Other Embodiment of the Invention

In FIG. 76, a resistor R5 is connected between the source of the p-channel transistor M4 and the power supply VDD. Since the p-channel transistor M4 has the gate voltage in common with the p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

Similarly, a resistor R10 is connected between the source of the p-channel transistor M11 and the power supply VDD. Since the p-channel transistor M11 has the gate voltage in common with the p-channel transistor M12, the transistor size of the p-channel transistor M11 is selected to be larger than that of the p-channel transistor M12 so that the currents through the two transistors will be equal to each other. The current mirror circuit made up of the p-channel transistors M11 and M12 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3 and M2 constitute a current mirror circuit, and the n-channel transistors M1 and M2 have the gate voltage in common. Hence, the common gate voltage of M1-M3 is decreased, thus decreasing the current flowing through the n-channel transistor M1.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit I-V1 is equal to that applied to the second current-to-voltage converter circuit I-V2, thus achieving the same operating condition as that with the use of the OP amp as described above. The first current-to-voltage converter circuit is made up of parallel connection of the diode D1 and the resistor R3, whereas the second current-to-voltage converter circuit is made up of a series connection of the resistor R1 and diodes D2 and the resistor R2 connected in parallel with the series connection.

The p-channel MOS transistor M22 is added to compensate for non-linearity of diodes, in order to drive the diode D4 and in order to supply the compensating currents between the terminal voltage of the diode D4 and the first current-to-voltage converter circuit (I-V1) (D1, R3) and between the terminal voltage of the diode D4 and the second current-to-voltage converter circuit (I-V2) (R1, D2, R3) via resistors R13 and R12, respectively.

In similar manner, when the current through the n-channel transistor M8 is increased, the current flowing through the p-channel transistor M11 is correspondingly increased. However, the current flowing through the p-channel transistor M12 becomes larger than the increased current through the p-channel transistor M11. Hence, the so increased current cannot flow through the n-channel transistor M9, thus increasing the drain voltage of the p-channel transistor M12 and decreasing the current through the p-channel transistor M13, the gate of which is connected to the drain of the p-channel transistor M12.

Hence, the current flowing through the p-channel transistor M10, having the common drain current, also decreases. The n-channel transistors M10 and M9 constitute a current mirror circuit and, since the n-channel transistors M8 and M9 have the gate voltage in common, the common gate voltage of M8-M10 decreases, so that the current flowing through the n-channel transistor M1 decreases.

The p-channel MOS transistor M23 is added to compensate for non-linearity of diodes, in order to drive the diode D8 and in order to supply the compensating currents between the terminal voltage of the diode D8 and the third current-to-voltage converter circuit (I-V3) and between the terminal voltage of the diode D8 and the fourth current-to-voltage converter circuit (I-V4) via resistors R15 and R14, respectively.

That is, the current loop, composed of the n-channel transistors M8-M10 and the p-channel transistors M11-M13, constitutes a negative feedback circuit and controls the common gate voltage of the n-channel transistors M8, M9, via inverse-Widlar current mirror circuit, so that the currents through the n-channel transistors M8, M9 will become of a preset value, herein equal to each other.

Since the gate source voltages of the n-channel transistors M8 and M9 become equal to each other, the voltage applied to the third current-to-voltage converter circuit becomes equal to that applied to the fourth current-to-voltage converter circuit, thus achieving the same operating condition as that of using the OP amp as described above. The third current-to-voltage converter circuit is made up of parallel connection of the diode D5 and the resistor R8, whereas the fourth current-to-voltage converter circuit is made up of series connection of the resistor R6 and diodes D6 and a resistor R7, connected in parallel with the series connection, as described above.

The current I3 flows through the transistor M7, whereas the current I6 flows through the transistor M14. A sum current of the currents I3 and I6 flows through resistor R9 to generate an output voltage Vref from a terminal voltage of the resistor R9. That is, the characteristic equivalent to that of FIG. 38 may be achieved, thus implementing a reference voltage generating circuit. The two third current-to-voltage converter circuits (I-V3) are inserted so that the drain voltages of the n-channel transistors M10, M8 will be equal to each other.

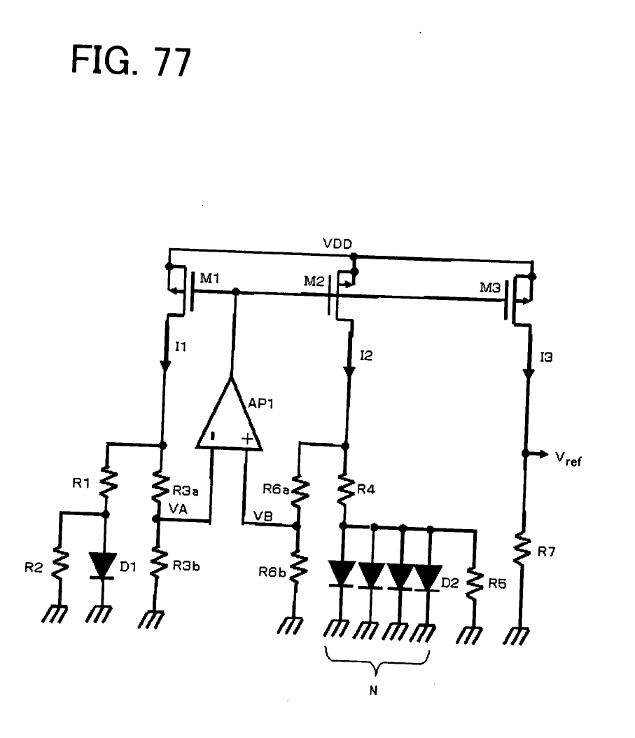

FIG. 77 shows the circuit configuration of an embodiment of a CMOS reference voltage generating circuit according to the present invention (claim 21). The circuit includes first, second and third current-voltage converter circuits, current mirror circuits for supplying currents I1, I2 and I3 to the first to third current-voltage converter circuits, and control means (OP amp AP1). The control means exercises control so that a preset mid-point terminal voltage VA of the first current-voltage converter circuit will be equal to a preset mid-point terminal voltage VB of the second current-voltage converter circuit. A preset voltage of the third current-voltage converter circuit is used as a reference voltage Vref. The first current-voltage converter circuit is made up of the diode D1, the resistor R2, connected in parallel with the diode, the resistor R1 connected in series with the parallel connection of the diode D1 and the resistor R2, and resistors R3a and R3b, connected in parallel with D1-R2-R1. The aforementioned mid-point terminal voltage VA of the first current-voltage converter circuit is output from the resistors R3a and R3b of the parallel path. The second current-voltage converter circuit is made up of a plural number of parallel-connected diodes D2, the resistor R5 connected in parallel with the diodes D2, the resistor R4, connected in series with (D2, R5), and resistors (R6a, R6b) connected in parallel with (R4, D2, R4). The aforementioned preset mid-point terminal voltage VB of the second current-voltage converter circuit is output from the resistors R6a and R6b of the parallel path. The third current-voltage converter circuit is the resistor R7. The diodes (D1, D2) may be bipolar junction transistors, connected as diodes. The constitution of FIG. 77 corresponds to the configuration of FIG. 48 which two parallel-connected resistors R3 and R6 are changed to voltage-dividing resistors (R3a, R3b) and (R6a, R6b) and preset mid-point terminals of the voltage-dividing resistors are connected to preset input terminals of the OP amp (AP1) to lower the input voltages to the OP amp (AP1).

If, with

R3a+R3b=R3 (184)

and

R6a+R6b=R6 (185)

the voltage-dividing voltage ratio is set by resistors so that

R3a/R3b=R6a/R6b (186)

will be valid, there is substantially no change in the circuit operation, and hence the reference voltage similar to that of FIG. 48 may be obtained.

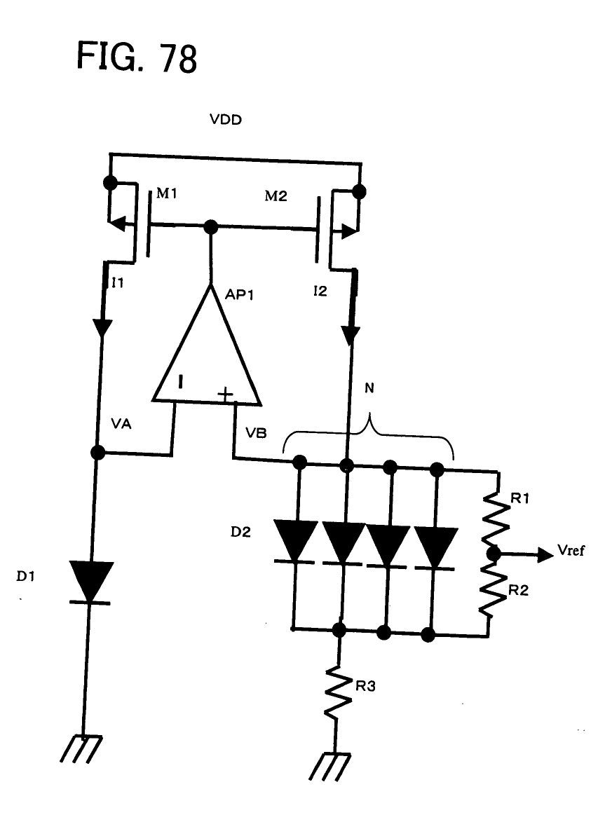

In FIG. 78, assuming that the midpoint terminal voltage of the dividing registers R1 and R2 is Vref′, since control is performed by the OP amp (AP1) such that VA=VB, the following equation holds

$$\begin{matrix}{Vref}^{′} = {V}_{F 1} - {V}_{F 2} + \frac{{R}_{2}}{{R}_{1} + {R}_{2}} {V}_{F 2} \\ = Δ {V}_{F} + \frac{{R}_{2}}{{R}_{1} + {R}_{2}} {V}_{F 2} = α {V}_{F 2} + Δ {V}_{F} ( α < 1 )\end{matrix} \qquad ( 187 )$$

### Since I1=I2, we have

$$Δ {V}_{F} = {V}_{T} ln ( \frac{N}{1 - \frac{{V}_{F 2}}{{I}_{1} ( {R}_{1} + {R}_{2} )}} ) \qquad ( 188 )$$

### From (188), we see that the reference voltage generating circuit shown in FIG. 78 is able to improve the non-linear temperature characteristic of the diode, as the reference voltage generating circuit shown in FIG. 47.

The reference voltage of the equation (187) is a low voltage, such as several times as large as 50 mV, as with ones of FIGS. 42, 43, 44, 45 and FIG. 46. In case of the number N of diodes D2 connected in parallel being set to 148, the reference voltage is about 250 mV. In general, the target value of the reference voltage is set to 200 mV. With the reference voltage generating circuit shown in FIG. 46, the reference voltage is speculated by the number N (log) of diodes D2 connected in parallel, for example,

100 mV@N≈3, 150 mV@N≈20, 200 mV@N≈55, 250 mV@N≈148.

The voltage obtained is far from the band-gap voltage of Si. The reason why the present inventor doesn't call it the band-gap reference but call it voltage reference would be understood.

The values of simulation result are shown below. If, with VDD=1.3V, N and R1 to R5 are set so that N=8, R1=100 kΩ, R2=5.703 kΩ, R3=5 kΩ, the reference voltage are

101.71 mV at −53° C.,

101.797 mV at −20° C.,

101.88 mVm at 27° C.,

101.882 mV, at 40° C., and

101.702 mV at 103° C.

so that the characteristic with a mountain type shape has been obtained. The temperature variation range is suppressed to 0.18%.

As described above, other than the conventional voltage Vref=VBE1+KΔVBE≈1.2V (K>>1), the temperature compensated reference voltage or the reference voltage having the temperature non-linearity of VBE of a bipolar transistor or diode compensated is able to be obtained by Vref′=αVBE+ΔVBE (α<1).

The difference between the reference voltage generation circuits shown in FIG. 78 and FIG. 47 will be explained. The reference voltage generation circuits shown in FIG. 78 and FIG. 47 are equivalent in the circuit configuration. However, in the circuit operation, the temperature characteristic of the driving currents (I1, I2) in the reference voltage generation circuit shown in FIG. 78 is positive, while in the reference voltage generation circuit shown in FIG. 47, the temperature characteristic of the driving currents (I1, I2) is compensated. In the reference voltage generation circuit, the current or voltage having a positive temperature characteristic and the current or voltage having a negative temperature characteristic is summed to cancel the temperature characteristic so that for the different starting point, another compensation method is present.

This difference results in the difference of the output node of the reference voltage. In FIG. 47, the second current-to-voltage conversion circuit includes a parallel circuit including a plurality of diodes D2 and a resistor R2 connected in parallel; and a resistor (R1) connected in series with the parallel circuit. The position of the parallel circuit (D1/R2) and the resistor (R1) are mutually exchanged and the resistor (R1) is connected to GND. With this configuration, the reference voltage Vref can be obtained from the terminal voltage of the resistor (R1), as a result of which the second current-to-voltage conversion circuit is dispensed. In this case, the reference voltage Vref cannot be set to an arbitrary value.

### INDUSTRIAL UTILIZABILITY

Among the examples of practical application of the present invention, there are various reference voltage generating circuits integrated on an LSI. In particular, in keeping with recent progress in the ultra-miniaturization of the integrated circuit process, the effect of MOS transistor channel length modulation is apparent. Further, there is a demand for a lower supply power voltage for the LSI and for stabilized reference voltage generating circuits, free from temperature variations and which may be operated even with the power supply voltage on the order of IV. The present invention is configured to meet such demand.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A reference voltage generating circuit comprising:
a first current-to-voltage conversion circuit;
a second current-to-voltage conversion circuit;
a current mirror circuit that supplies currents to the first and second current-to-voltage conversion circuits, respectively; and
a control circuit that exercises control so that a preset output voltage of the first current-to-voltage conversion circuit is made equal to a preset output voltage of the second current-to-voltage conversion circuit;
wherein at least one of a preset output voltage of the first current-to-voltage conversion circuit and a preset output voltage of the second current-to-voltage conversion circuit is used as the reference voltage.

2. The reference voltage generating circuit according to claim 1, wherein the first and second current-to-voltage conversion circuits each comprise a resistor and a diode connected in series.

3. The reference voltage generating circuit according to claim 1, further comprising first and second resistors connected in parallel with the first and second current-to-voltage conversion circuits, respectively;
wherein each of respective mid-point voltages of said first and second resistors is used as each of the preset output voltages of the first and second current-to-voltage conversion circuits.

4. The reference voltage generating circuit according to claim 1, wherein the first and second current-to-voltage conversion circuits each comprise a series circuit including a resistor and a diode connected in series; and a resistor connected in parallel with said series circuit;
a mid-point voltage of each of said resistors being used as each of the preset output voltages of the first and second current-to-voltage conversion circuits.

5. The reference voltage generating circuit according to claim 1, further comprising first and second resistors connected in parallel with the first and second current-to-voltage conversion circuits, respectively.

6. The reference voltage generating circuit according to claim 5, wherein said first and second resistors output divided voltages of the preset output voltages, respectively.

7. A reference voltage generating circuit comprising:
first, second, third and fourth current-to-voltage conversion circuits;
a current mirror circuit that supplies currents to the first, second, third, and fourth current-to-voltage conversion circuits, respectively; and
a control circuit that exercises control so that a preset output voltage of the first current-to-voltage conversion circuit is made equal to a preset output voltage of the second current-to-voltage conversion circuit;
wherein at least one of a preset output voltage of the first current-to-voltage conversion circuit and a preset output voltage of the second current-to-voltage conversion circuit is used as a reference voltage;
the first and second current-to-voltage conversion circuits each including a resistor, whereas the third current-to-voltage conversion circuit includes a diode; and the fourth current-to-voltage conversion circuit includes a resistor and a diode connected in series;
said reference voltage generating circuit further comprising a resistor connected between the first and third current-to-voltage conversion circuits and a resistor connected between the second and fourth current-to-voltage conversion circuits

8. The reference voltage generating circuit according to claim 7, wherein said control circuit exercises control so that a divided voltage of the preset output voltage of the first current-to-voltage conversion circuit is made equal to a divided voltage of the preset output voltage of the second current-to-voltage conversion circuit.

9. The reference voltage generating circuit according to claim 7, wherein the first current-to-voltage conversion circuit is composed of a diode;
the second current-to-voltage conversion circuit includes a diode and a resistor connected in series; and
the third and fourth current-to-voltage conversion circuits each are composed of a resistor;
said reference voltage generating circuit further comprising a resistor connected between the first and third current-to-voltage conversion circuits, and a resistor connected between the second and fourth current-to-voltage conversion circuits; and
at least one of a preset output voltage of the third current-to-voltage conversion circuit and a preset output voltage of the fourth current-to-voltage conversion circuit is used as a reference voltage.

10. The reference voltage generating circuit according to claim 7, wherein the first and second current-to-voltage conversion circuits are each composed of a resistor;
the third current-to-voltage conversion circuit includes a diode and a resistor that is connected in parallel with the diode and has a mid-point terminal; and
the fourth current-to-voltage conversion circuit includes a series circuit including a diode and a resistor connected in series; and parallel-connected resistor that is connected in parallel with the series circuit and has a mid-point terminal;
the first current-to-voltage conversion circuit being connected to the mid-point terminal of the third current-to-voltage conversion circuit;
the second current-to-voltage conversion circuit being connected to the mid-point terminal of the fourth current-to-voltage conversion circuit; and wherein
at least one of a preset output voltage of the third current-to-voltage conversion circuit and a preset output voltage of the fourth current-to-voltage conversion circuit being used as a reference voltage.

11. The reference voltage generating circuit according to claim 7, wherein the first and second current-to-voltage conversion circuits are each composed of a resistor;
the third current-to-voltage conversion circuit is composed of a diode and a resistor that is connected in parallel with the diode and has a mid-point terminal; and
the fourth current-to-voltage conversion circuit includes a series connection of a diode and a resistor and a further resistor that is connected in parallel with the series connection and has a a mid-point terminal;
the first current-to-voltage conversion circuit being connected to the mid-point terminal of the third current-to-voltage conversion circuit;
the second current-to-voltage conversion circuit being connected to the mid-point terminal of the fourth current-to-voltage conversion circuit;
at least one of a preset output voltage of the third current-to-voltage conversion circuit and a preset output voltage of the fourth current-to-voltage conversion circuit being used as a reference voltage; and
wherein said control circuit exercises control so that a preset output voltage of the third current-to-voltage conversion circuit is made equal to a preset output voltage of the fourth current-to-voltage conversion circuit.

12. The reference voltage generating circuit according to claim 7, wherein said control circuit exercises control so that so that a voltage at the mid-point terminal of the first current-to-voltage conversion circuit is made equal to a voltage at the mid-point terminal of the second current-to-voltage conversion circuit.

13. A reference voltage generating circuit comprising:
first, second, third and fourth current-to-voltage conversion circuits;
a first current mirror circuit that supplies currents to the first and second current-to-voltage conversion circuits, respectively;
a second current mirror circuit that supplies currents to the third and fourth current-to-voltage conversion circuits, respectively;
a first control circuit that exercises control so that a preset output voltage of the first current-to-voltage conversion circuit is made equal to a preset output voltage of the second current-to-voltage conversion circuit;
a second control circuit that exercises control so that a preset output voltage of the third current-to-voltage conversion circuit is made equal to a preset output voltage of the fourth current-to-voltage conversion circuit; and
a circuit that performs weighted summation of respective currents flowing through the first and second current mirror circuits; wherein
the first current-to-voltage conversion circuit includes a parallel circuit including a diode and a resistor connected in parallel;
the second current-to-voltage conversion circuit includes: a series circuit including a resistor and a diode connected in series; and a resistor connected in parallel with the series circuit;
the third current-to-voltage conversion circuit is composed of a diode; and
the fourth current-to-voltage conversion circuit is composed of a series connection of a resistor and a diode

14. The reference voltage generating circuit according to claim 13, further comprising:
a first diode driven by a current from the first current mirror circuit;
a first resistor connected between said first diode and the first current-to-voltage conversion circuit; and
a second resistor connected between said first diode and the second current-to-voltage conversion circuit.

15. The reference voltage generating circuit according to claim 13, further comprising:
a first resistor connected in parallel with the third current-to-voltage conversion circuit; and
a second resistor connected in parallel with the fourth current-to-voltage conversion circuit.

16. The reference voltage generating circuit according to claim 15, wherein the preset voltages of the first, second, third and fourth conversion circuits are divided voltages of the resistors connected in parallel with the first, second, third and fourth conversion circuits, respectively.

17. The reference voltage generating circuit according to claim 15, further comprising:
a first diode driven by a current from the first current mirror circuit;
a second diode driven by a current from the second current mirror circuit;
a first resistor connected between said first diode and the first current-to-voltage conversion circuit;
a second resistor connected between said first diode and the second current-to-voltage conversion circuit;
a third resistor connected between said second diode and the third current-to-voltage conversion circuit; and
a fourth resistor connected between said second diode and the fourth current-to-voltage conversion circuit.

18. A reference voltage generating circuit comprising: first, second, third current-to-voltage conversion circuits;
a current mirror circuit that supplies currents to the first, second and third current-to-voltage conversion circuits, respectively; and
a control circuit that exercises control so that a preset midpoint terminal voltage of the first current-to-voltage conversion circuit is made equal to a preset midpoint terminal voltage of the second current-to-voltage conversion circuit; wherein
a preset output voltage of the third current-to-voltage conversion circuit is used as a reference voltage;
the first and second current-to-voltage conversion circuit each include of a series circuit including a diode and a resistor connected in series; and further a register connected in parallel with the series circuit; the respective midpoint terminal voltages of the first and second current-to-voltage conversion circuit being delivered from the parallel connected resistor;
the third current-to-voltage conversion circuit includes a diode and a resistor connected in series.

19. A reference voltage generating circuit comprising:
first and second current-to-voltage conversion circuits driven by constant currents, respectively;
a circuit that divide an output voltage of the second current-to-voltage conversion circuit; and
a control circuit that exercises control so that a preset terminal voltage of the first current-to-voltage conversion circuit is made equal to a preset terminal voltage of the second current-to-voltage conversion circuit; wherein
the first current-to-voltage conversion circuit is composed of a diode; and
the second current-to-voltage conversion circuit includes a plurality of diodes connected in parallel;
the divided voltage of the output voltage of the second current-to-voltage conversion circuit being used as a reference voltage.

20. The reference voltage generating circuit according to claim 19, wherein said control circuit exercises control so that a preset terminal voltage of the first current-to-voltage conversion circuit is made equal to the divided voltage of the second current-to-voltage conversion circuit; and
a preset voltage of the second current-to-voltage conversion circuit being used as a reference voltage.

21. The reference voltage generating circuit according to claim 17, wherein the preset voltages of the first, second, third and fourth current-to-voltage conversion circuits are divided voltages of the parallel connected resistors of the first, second, third and fourth current-to-voltage conversion circuits, respectively.

22. The reference voltage generating circuit according to claim 1, wherein the control circuit includes an operational amplifier that has non-inverting and inverting input terminals for receiving two input voltages and an output terminal connected to the coupled gates of the current mirror circuit.

23. The reference voltage generating circuit according to claim 1, wherein the control circuit includes another current mirror circuit connected between said current mirror circuit and the current-to-voltage conversion circuits.

24. The reference voltage generating circuit according to claim 1, wherein the diode is composed by a diode-connected bipolar junction transistor.
